(19) United States
(12) Patent Application Publication
(10) Pub. No.: US 2026/0127554 A1
(43) Pub. Date: May 7, 2026

(54) SYSTEM FOR MEETING USING ARTIFICIAL INTELLIGENCE CAPABLE OF AUTOMATIC MEETING SCHEDULING, RECOGNITION OF ACTUAL MEETING PARTICIPANTS AND EVALUATION OF MEETING PARTICIPANTS' BEHAVIORS AND METHOD IMPLEMENTING THE SAME

(71) Applicant: SK Planet Co., Ltd., Seongnam-si (KR)

(72) Inventor: Sunghyun YOON, Seoul (KR)

(21) Appl. No.: 19/376,886

(22) Filed: Oct. 31, 2025

(30) Foreign Application Priority Data
Nov. 7, 2024 (KR) 10-2024-0156934
Nov. 7, 2024 (KR) 10-2024-0156963
Nov. 7, 2024 (KR) 10-2024-0157084

(51) Int. Cl. G06Q 10/109; G06V 10/70; G06V 10/776; G06V 40/16; G06V 40/18; G06V 40/20; G10L 15/25; G10L 17/06

(52) U.S. Cl. CPC G06Q 10/109; G06V 40/172; G10L 17/06; G06V 10/776; G06V 10/87; G06V 40/18; G06V 40/20; G10L 15/25

(57) ABSTRACT

The present invention relates to automatically and optimally setting a meeting schedule using the AI. The present invention further relates to recognizing actual meeting attendees and evaluating the attendance and behavior of meeting participants. A first step involves accessing a candidate database (DB) server that includes at least one of a list of a potential meeting's group participants or personal contact, address, current location, work schedule, team information or expertise of an individual potential meeting participant. A second step involves accessing a meeting information DB server that includes a potential meeting information including at least one of the potential meeting's expected agenda, expected number of participants, expected meeting time or expected meeting location for the potential meeting. A third step involves calculating a match rate between a first data from the candidate DB server and a second data from the meeting information DB server.

### CROSS REFERENCE TO RELATED APPLICATIONS

This application claims priority to Republic of Korea Patent Application No. 10-2024-0156934, filed on Nov. 7, 2024, Republic of Korea Patent Application No. 10-2024-0156963, filed on Nov. 7, 2024, and Republic of Korea Patent Application No. 10-2024-0157084, filed on Nov. 7, 2024, which are hereby incorporated by reference in their entirety.

### BACKGROUND

### 1. Field of the Invention

The present invention relates to an AI (Artificial Intelligence) meeting system and a method related thereto which can automatically set a meeting schedule using the AI and can further recognize and evaluate the attendance and behavior of meeting participants. The AI meeting system and method according to the present invention may be further subdivided into several aspects: including a first aspect of the AI scheduler system and method, a second aspect of system and method for determining actual meeting attendees, and a third aspect of system and method for analyzing behaviors of meeting participants and evaluating the participation or attitude of each participant in the meeting based on such AI behavior analysis.

### 2. Description of the Related Art

Thanks to recent advances in IT (Information Technology), ICT (Information and Communications Technology), and wired and wireless network technologies, various devices that support meetings have been developed and commercialized. As one example, so-called speakerphones can now be easily found in many conference rooms at various companies. When multiple employees working at the company have an identical meeting with a third party, all meeting participants can listen to what the third party is saying through the speakerphone. Of course, and if any one of the meeting participants speaks, the other meeting participants in the meeting room and the third party remotely participating in the meeting would be able to hear the content of his or her speech altogether.

In recent years, in order to support video conferencing, as another example, large screens that can transmit and play multimedia data, which can be the content of the meeting can be found in the conference room. There are many cases where the meeting participants are seated with a microphone that allows each participant to speak by means of an on/off button on the microphone. In addition, there may be audio recording devices to record the voice and sounds generated inside the conference room, cameras to film the meeting situation, and reading machines for biometric information (face, iris, fingerprint, etc.) to allow or restrict people's access to the conference room.

In addition, with the recent activation of telecommuting, it has become possible for invited or even non-invited people to attend multilateral video conferences online by using their notebooks, personal computers (PC's), smart phones, and smart pads together with many software applications, or apps, specialized for remote conferencing to be held on these smart devices.

Now, the concept of “meeting” or “conference” is not limited to business meetings at companies. Rather, such concepts have evolved to include online university lectures, presentations and award ceremonies premised on a large audience, shareholders' meetings, or apartment resident meetings. Because of the aforementioned advancement of ICT technology and the popular expansion of smart devices and apps, it would be no longer meaningful to distinguish whether a conversation between two or more people is a “meeting” or not. Smart devices are available for online meetings regardless of meeting purposes, meeting participants, or meeting agendas. In short, it can be understood that the concept of meeting is greatly expanded in this era.

As the meeting environment has become more advanced and meetings are considered as more common and frequently-used tool in our life, there has been a need for some means to conveniently manage meeting schedules. However, in preparation for situations like where there are a large number of meeting attendees or where it is unclear regarding who should be selected as participants for a specific meeting, the meeting scheduling system must also be improved. Maybe the meeting system should be able to select meeting attendees and notify each one of them of the meeting schedule to get confirmations on the meeting time and place.

Meanwhile, for some meetings, the list of actual meeting attendees might be important or even crucial. In such cases, someone such as a meeting moderator may have to manually identify the online or offline attendees one by one.

For example, when a decision-making committee of a government agency conducts consideration of bills, matters such as who attended the committee's consideration meeting and who voted on a specific agenda might be very important. This would be true not only for government meetings, but also for private meetings such as shareholder meetings. In those meetings, important company decisions will be made, and such meetings may be held online or offline. If there exist regulations that restrict the participants of a particular meeting to a limited group of people, someone must verify who actually attended the meeting to determine whether such regulations are upheld properly or not.

In response to the above-mentioned situation, methods such as facial recognition, fingerprint recognition, and conference room access verification have recently been used to determine the identity of actual meeting participants. Similar technologies are sometimes applied to verify students' attendance at, for example, university lectures.

Here, the inventor of the present invention believes that there could be some opportunities to improve the current meeting management system by using the AI technology. Identification of actual meeting participants would be one of such opportunities.

On the other hand, as noted above, university lectures using online meeting platforms are also increasing. In this case, professors may want to evaluate each students' participation attitude in class. In fact, when only offline lectures existed, professors could check the attitudes of students in the classroom with their own eyes. Professors should call names of students registered for his or her class, and professors may want to remember some students who asked important questions during the lecture so that they can adjust the grade of some students.

In that sense, educational institutions may utilize the physical classroom equipped with devices such as webcams as an ICT tool for class evaluation. In case of online lectures, professors may utilize students' smartphone cameras to analyze each student's attitudes. That is, digitalized data to evaluate meeting attendance can now be easily gathered by virtue of offline or online devices.

The participation of meeting participants can be analyzed by parsing the video footage of a meeting or lecture, just as professors used to check the attitude of students at their onsite courses with their own eyes and ears in the past. The parsing results of such digital data can be useful to those who evaluate the meeting (e.g., professors, lecturers, internal team leaders or executives who organized the meeting, etc.). Now team leaders at companies may want to use such parsing results as a direct or indirect means of evaluation on the participation and enthusiasm of his or her team members.

It would be worth to note that the participation attitude of the meeting participants can be an indicator to reversely evaluate the success of the seminar or the professor's teaching skills. In other words, for example, even though the government held online or offline seminars for citizens free of charge, if the camera footage in that seminar shows that majority of citizens did something else other than concentrating on the seminar, someone can conclude that there is something wrong with the selection of the seminar's topic, lecturer, location, etc. It would be a good feedback for the meeting organizer so that they can have some insights into how to improve the meetings better in the future.

Based on the above-explained aspects, it is believed that the advanced AI and ICT technology should be able to improve the meeting management including optimized meeting scheduling function, identification of actual meeting attendees, and evaluation of meeting attendance.

### SUMMARY OF THE INVENTION

The present invention is intended to respond to all or at least part of the technical requirements or opportunities mentioned above. The present invention proposes an AI meeting system and related method that can automatically and optimally set a meeting schedule using the AI. The present invention further suggests technologies to recognize actual meeting attendees and to evaluate the attendance and behavior of meeting participants.

The first aspect of the present invention tries to optimize the technical AI tasks that enable a highly automated meeting scheduler function by selecting who would be the appropriate meeting attendees for specific meetings and further suggesting optimal meeting means and place to the potential meeting attendees. In particular, the first aspect of the present invention is to implement an AI meeting scheduler system and method that can solve the difficulty of scheduling a complex or large-scale meeting, assuming that even the organizer of the meeting might not know who should attend the meeting, when to have the meeting, or how to organize the meeting.

The second aspect of the present invention relates to a method and system for automatically recognizing actual meeting attendees using the AI technology. Specifically, in a meeting where it is particularly important to determine who the actual meeting attendees are, the main technical task of the present invention is to implement an automatic recognition method and system for meeting attendees so that the AI can accurately analyze who actually attended the meeting.

The third aspect of the present invention is to construct an AI evaluation platform that allows a person who evaluates meetings to easily and systematically evaluate the participation attitude of the meeting participants by utilizing the digital data such as video captured by cameras in a conference room or smartphone cameras with the help of the AI based on the present invention.

As mentioned above, the first aspect of the present invention is a technical task to present an artificial intelligence utilization technology that enables a highly automated meeting scheduler function by presenting the meeting attendees with an optimized meeting means and place and also helping the meeting organizer select appropriate meeting attendees.

According to the first aspect of the present invention, the present invention proposes a highly automated AI meeting scheduler system and method by allowing the server scheduling the meeting scheduling to select the optimized meeting attendees according to the AI learning and presenting the most suitable meeting method, place, and time for the selected meeting participants, based on the technical requirements for the sophistication of the meeting scheduler.

A computer-implemented method to manage meeting schedules for multiple meeting participants is provided for the first aspect of the present invention. The method comprises a first step of accessing a candidate DB server that includes at least one of a list of a potential meeting's group participants or personal contact, address, current location, work schedule, team information or expertise of an individual potential meeting participant, by an AI meeting scheduler server that is connected with personal meeting terminals of the multiple meeting participants via a network; a second step of accessing a meeting information DB server that includes a potential meeting information including at least one of the potential meeting's expected agenda, expected number of participants, expected meeting time or expected meeting location for the potential meeting, by the AI meeting scheduler server; a third step of calculating a match rate between a first data received from the candidate DB server and a second data received from the meeting information DB server based on at least one predetermined selection criteria, and creating a meeting candidate list based on the match rate and the predetermined selection criteria, by the AI meeting scheduler server; and a fourth step of deciding a meeting schedule for the potential meeting after acquiring an explicit or implicit consent from each candidate included in the meeting candidate list, by the AI meeting scheduler server.

Here, the third step may include a prediction process including at least one of a similarity prediction process based on at least one of the expected agenda, the team information or the expertise; an accessibility prediction process based on the address or the current location and the expected meeting location; or a conflict prediction process for a schedule conflict probability based on the expected meeting time and the work schedule of the individual potential meeting participant.

In addition, the prediction process may further include an obstacle resolution process where the AI meeting scheduler server determines whether there exists at least one obstacle ground in creating the meeting candidate list based on the similarity prediction process, the accessibility prediction process or the conflict prediction process; judges whether the obstacle ground is negotiable; and if the obstacle is judged to be negotiable, resolves the obstacle ground pursuant to a predetermined obstacle resolution procedure.

Moreover, the meeting candidate list may include as many candidates as a predetermined multiple of the expected number of participants, and when judging whether the obstacle ground is negotiable, priorities allocated to the obstacle ground respectively for the candidates are compared against each during the obstacle resolution process.

The computer-implemented according to the first aspect of the present invention may further comprise a fifth step of accessing a meeting room management DB server that includes a schedule availability of each meeting room, an available device information in each meeting room or a location information of each meeting room, by the AI meeting scheduler server, wherein the candidate DB server further includes a device type or a device performance information about each of the personal meeting terminals, and the meeting information DB server further includes an information on whether the potential meeting can be participated by online or not.

The first aspect of the present invention may be implemented as a computer system to manage meeting schedules for multiple meeting participants by using personal meeting terminals of the multiple meeting participants via a network. In this case, the computer system includes a candidate DB server that includes at least one of a list of a potential meeting's group participants or personal contact, address, current location, work schedule, team information or expertise of an individual potential meeting participant; a meeting information DB server that includes a potential meeting information including at least one of the potential meeting's expected agenda, expected number of participants, expected meeting time or expected meeting location for the potential meeting; and an AI meeting scheduler server that calculates a match rate between a first data received from the candidate DB server and a second data received from the meeting information DB server based on at least one predetermined selection criteria, and creates a meeting candidate list based on the match rate and the predetermined selection criteria, wherein the AI meeting scheduler server decides a meeting schedule for the potential meeting after acquiring an explicit or implicit consent from each candidate included in the meeting candidate list.

According to the computer system of the present invention, when the AI meeting scheduler server creates the meeting candidate list, the AI meeting scheduler server executes a prediction process including at least one of a similarity prediction process based on at least one of the expected agenda, the team information or the expertise; an accessibility prediction process based on the address or the current location and the expected meeting location; or a conflict prediction process for a schedule conflict probability based on the expected meeting time and the work schedule of the individual potential meeting participant.

According to the computer system of the present invention, the prediction process may further include an obstacle resolution process where the AI meeting scheduler server determines whether there exists at least one obstacle ground in creating the meeting candidate list based on the similarity prediction process, the accessibility prediction process or the conflict prediction process; judges whether the obstacle ground is negotiable; and if the obstacle is judged to be negotiable, resolves the obstacle ground pursuant to a predetermined obstacle resolution procedure.

According to the computer system of the present invention, the meeting candidate list may include as many candidates as a predetermined multiple of the expected number of participants, and when judging whether the obstacle ground is negotiable, priorities allocated to the obstacle ground respectively for the candidates are compared against each during the obstacle resolution process.

The computer system according to the first aspect of the present invention may further include a meeting room management DB server that includes a schedule availability of each meeting room, an available device information in each meeting room or a location information of each meeting room, wherein the candidate DB server further includes a device type or a device performance information about each of the personal meeting terminals, and the meeting information DB server further includes an information on whether the potential meeting can be participated by online or not.

As mentioned above, the second aspect of the present invention relates to a method and system for automatically recognizing actual meeting attendees using AI technology. Specifically, in meetings where it is particularly important to determine who the actual meeting attendees are, the technical task is to implement an automatic recognition method and system for meeting attendees that can accurately analyze who actually attended the meeting with AI.

To be more concrete, the second aspect of the present invention is a computer-implemented method to decide whether there exists an authority to participate in a specific meeting as for at least one meeting participant belonging to an organization having a predetermined size. The method comprises process of storing a facial fingerprint information and a vocal fingerprint information regarding entire members of the organization as an organization fingerprint information, acquiring a list of meeting participants having the authority, and identifying at least one of the facial fingerprint information or the vocal fingerprint information as for the acquired list to generate a participant fingerprint information, by an AI meeting management server; receiving facial image information and vocal audio information about at least one of the meeting participants through at least one conference camera and at least one conference microphone installed in a meeting room to be used for the specific meeting or through a smart device camera used by each of the meeting participants, respectively, for the specific meeting, by the AI meeting management server; and deciding whether each of the meeting participants has the authority by performing an analysis on the received facial image information and the received vocal audio information based on a facial recognition algorithm and a voice recognition algorithm by the AI meeting management server, wherein the facial recognition algorithm and the voice recognition algorithm are executed independently of each other, the analysis is performed against the entire members including the list of meeting participants having the authority, and the AI meeting management server aggregates a result of the analysis to make a final decision on whether each of the meeting participants has the authority.

According to the second aspect of the present invention, when aggregating the result of the analysis, the AI meeting management server may calculate a weighted average based on a first weight allocated to the facial recognition algorithm and a second weight allocated to the voice recognition algorithm to acquire an overall match rate in making the final decision on whether each of the meeting participants has the authority.

According to the second aspect of the present invention, the computer-implemented method may further include processes of self-evaluating an AI performance on whether the final decision corresponds to existence or non-existence of an actual participation authority for each of the meeting participants; and reviewing whether the first weight and the second weight should be adjusted to adjust the first weight and the second weight as necessary.

According to the second aspect of the present invention, the AI meeting management server may select one from a plurality of facial recognition algorithms and another one from a plurality of voice recognition algorithms to make an algorithm combination set to be used for the final decision, and may self-evaluate an AI performance on a basis of each of the algorithm combination set to adjust the algorithm combination set.

According to the second aspect of the present invention, both the organization fingerprint information and the participant fingerprint information may further include an extra fingerprint information including at least one of a name, a team, an email, a contact, or a behavioral pattern about each of the meeting participants, and the AI meeting management server may execute an extra recognition algorithm that decides existence of non-existence of the authority based on the extra fingerprint information, independently of the facial recognition algorithm and the voice recognition algorithm, to acquire an extra analysis result, and reflects the extra analysis result on the final decision.

The second aspect of the present invention may be implemented as a computer system to decide whether there exists an authority to participate in a specific meeting as for at least one meeting participant belonging to an organization having a predetermined size. In this case, the computer system includes an AI meeting management server that makes a final decision on whether each of meeting participants has the authority, wherein the AI meeting management server executes processes including (a) storing a facial fingerprint information and a vocal fingerprint information regarding entire members of the organization as an organization fingerprint information, acquiring a list of meeting participants having the authority, and identifying at least one of the facial fingerprint information or the vocal fingerprint information as for the acquired list to generate a participant fingerprint information; (b) receiving facial image information and vocal audio information about at least one of the meeting participants through at least one conference camera and at least one conference microphone installed in a meeting room to be used for the specific meeting or through a smart device camera used by each of the meeting participants, respectively, for the specific meeting; and (c) deciding whether each of the meeting participants has the authority by performing an analysis on the received facial image information and the received vocal audio information based on a facial recognition algorithm and a voice recognition algorithm, and wherein the facial recognition algorithm and the voice recognition algorithm are executed independently of each other, the analysis is performed against the entire members including the list of meeting participants having the authority, and the AI meeting management server aggregates a result of the analysis to make the final decision.

According to the second aspect of the computer system of the present invention, when aggregating the result of the analysis, the AI meeting management server may calculate a weighted average based on a first weight allocated to the facial recognition algorithm and a second weight allocated to the voice recognition algorithm to acquire an overall match rate in making the final decision on whether each of the meeting participants has the authority.

According to the second aspect of the computer system of the present invention, the AI meeting management server may further execute processes including self-evaluating an AI performance on whether the final decision corresponds to existence or non-existence of an actual participation authority for each of the meeting participants; and reviewing whether the first weight and the second weight should be adjusted to adjust the first weight and the second weight as necessary.

According to the second aspect of the computer system of the present invention, the AI meeting management server may select one from a plurality of facial recognition algorithms and another one from a plurality of voice recognition algorithms to make an algorithm combination set to be used for the final decision, and may self-evaluate an AI performance on a basis of each of the algorithm combination set to adjust the algorithm combination set.

According to the second aspect of the computer system of the present invention, both the organization fingerprint information and the participant fingerprint information may further include an extra fingerprint information including at least one of a name, a team, an email, a contact, or a behavioral pattern about each of the meeting participants, and the AI meeting management server may execute an extra recognition algorithm that decides existence of non-existence of the authority based on the extra fingerprint information, independently of the facial recognition algorithm and the voice recognition algorithm, to acquire an extra analysis result, and reflects the extra analysis result on the final decision.

As mentioned above, the third aspect of the present invention is to construct an AI evaluation platform that allows a person having the evaluation authority over the meeting participants to easily evaluate the participation attitude of the meeting participants by utilizing the video data recognized by the camera in the conference room or the camera of a user smartphone used to access an online meeting.

For this purpose, the third aspect of the present invention proposes a server-client application system for smartphones or PCs and a software algorithm used for such a system, which enables an evaluator authorized to evaluate a meeting to reasonably adjust the evaluation criteria for the participation of meeting participants based on the video data obtained during the meeting.

More specifically, the third aspect of the present invention is a computer-implemented method to evaluate one or more meeting participants based on a behavior analysis of an AI application based on video data obtained during a meeting. The method according to the third aspect of the present invention includes receiving, from an evaluator's device, a plurality of weighting values corresponding to a plurality of participation scores calculated by the AI application; and displaying, on the evaluator's device, a participation evaluation score for each of the meeting participants, on a real-time basis or after the meeting is over, wherein the plurality of participation scores includes at least two among (a) a first participation score based on a first gaze analysis result acquired by a face-based gaze analysis module included in the AI application; (b) a second participation score based on a second gaze analysis result acquired by an eye-based gaze analysis module included in the AI application; (c) a third participation score based on a silence speech analysis result acquired by a mouth-shape-based language analysis module included in the AI application; or (d) a fourth participation score based on a body-language analysis result acquired by a body-language analysis module included in the AI application, wherein the plurality of weighting values includes a first weighting value related to the first participation score, a second weighting value related to the second participation score, a third weighting value related to the third participation score and a fourth weighting value related to the fourth participation score, and wherein the participation evaluation score is periodically updated on the evaluator's device based on the participation scores and the weighting values.

The third aspect of the present invention may further include a process of receiving at least one change value on the participation scores or the weighting values, from the evaluator's device, if an authentication as the evaluator is successfully done on the AI application, wherein the participation evaluation score is periodically updated on the evaluator's device based on the change value and adjusted weighting values due to the change value.

According to the third aspect of the present invention, another processes may be included such as self-evaluating an AI performance based on a confusion matrix regarding the first weighting value, the first participation score, the second weighting value, the second participation score, the third weighting value, the third participation score, the fourth weighting value and the fourth participation score, and producing, based on the self-evaluating, at least one AI-proposed adjusting value with regard to at least one of the first weighting value, the first participation score, the second weighting value, the second participation score, the third weighting value, the third participation score, the fourth weighting value and the fourth participation score, wherein the AI-proposed adjusting value is periodically updated on the evaluator's device.

According to the third aspect of the present invention, yet another process may be included such as creating a non-identifiable meeting participant list when the video data does not meet a quantitative threshold or a qualitative threshold required to produce the participation evaluation score for a specific meeting participant, wherein the non-identifiable meeting participant list is periodically updated on the evaluator's device.

According to the third aspect of the present invention, if the video data starts meeting the quantitative threshold or the qualitative threshold to produce the participation evaluation score for the specific meeting participant, the AI application may periodically recover and update the participation evaluation score of the specific meeting participant on the evaluator's device.

The third aspect of the present invention may be implemented as a computer system to evaluate one or more meeting participants based on a behavior analysis of an AI application based on video data obtained during a meeting. The computer system includes an AI application server that can receive the video data through a wired or wireless network and is interoperable with an evaluator's device, which evaluates the one or more meeting participants by the AI application through the wired or wireless network, wherein the AI application executes processing including receiving, from an evaluator's device, a plurality of weighting values corresponding to a plurality of participation scores calculated by the AI application; and displaying, on the evaluator's device, a participation evaluation score for each of the meeting participants, on a real-time basis or after the meeting is over, wherein the plurality of participation scores includes at least two among (a) a first participation score based on a first gaze analysis result acquired by a face-based gaze analysis module included in the AI application; (b) a second participation score based on a second gaze analysis result acquired by an eye-based gaze analysis module included in the AI application; (c) a third participation score based on a silence speech analysis result acquired by a mouth-shape-based language analysis module included in the AI application; or (d) a fourth participation score based on a body-language analysis result acquired by a body-language analysis module included in the AI application, wherein the plurality of weighting values includes a first weighting value related to the first participation score, a second weighting value related to the second participation score, a third weighting value related to the third participation score and a fourth weighting value related to the fourth participation score, and wherein the participation evaluation score is periodically updated on the evaluator's device based on the participation scores and the weighting values.

According to the computer system pursuant to the third aspect of the present invention, the AI application may further execute a process of receiving at least one change value on the participation scores or the weighting values, from the evaluator's device, if an authentication as the evaluator is successfully done on the AI application, and the participation evaluation score is periodically updated on the evaluator's device based on the change value and adjusted weighting values due to the change value.

According to the computer system pursuant to the third aspect of the present invention, the AI application may further execute processes for self-evaluating an AI performance based on a confusion matrix regarding the first weighting value, the first participation score, the second weighting value, the second participation score, the third weighting value, the third participation score, the fourth weighting value and the fourth participation score; and producing, based on the self-evaluating, at least one AI-proposed adjusting value with regard to at least one of the first weighting value, the first participation score, the second weighting value, the second participation score, the third weighting value, the third participation score, the fourth weighting value and the fourth participation score, wherein the AI-proposed adjusting value is periodically updated on the evaluator's device.

According to the computer system pursuant to the third aspect of the present invention, the AI application may further execute a process of creating a non-identifiable meeting participant list when the video data does not meet a quantitative threshold or a qualitative threshold required to produce the participation evaluation score for a specific meeting participant, and the non-identifiable meeting participant list is periodically updated on the evaluator's device.

According to the computer system pursuant to the third aspect of the present invention, if the video data starts meeting the quantitative threshold or the qualitative threshold to produce the participation evaluation score for the specific meeting participant, the AI application may periodically recover and update the participation evaluation score of the specific meeting participant on the evaluator's device.

Overall, the present invention proposes the AI meeting system and method which can facilitate a meeting management. For example, the first aspect of the present invention focuses on automatically setting a meeting schedule using AI. The second and third aspects focus on the recognition and evaluation of the attendance and participation behavior of meeting participants. To be clear, the AI meeting system and method of the present invention may be further subdivided into the scheduler aspect (i.e., the first aspect), the aspect of determining the actual meeting attendees (i.e., the second aspect), and the aspect for the analysis of the behavior of meeting participants and evaluation of the participation or attitude for each participant in the meeting (i.e., the third aspect).

According to the first aspect of the present invention, a highly automated AI scheduling service can be implemented from the initial selection of participants for the scheduled meeting to the schedule confirmation stage based on the candidate selection process included in the AI scheduler module.

Even if even the meeting participant does not know who is better to attend, the most important effect of the present invention is that the AI scheduling processor according to the present invention selects the optimal meeting candidates and automatically determines whether the scheduling for the candidates is feasible.

In other words, the present invention allows the AI software to calculate the match rate for each candidate for the meeting to be held, even if the meeting organizer only knows about the meeting agenda related to the scheduled meeting. Even when the meeting organizer enters the least available meeting data, the AI itself can find an appropriate criteria for calculating the match rate and may select the attending candidates.

In particular, the present invention introduces the concept of place conflict and time conflict when selecting candidates to attend the meeting, and determines whether there is a schedule conflict by considering the case where the location conflict problem is intertwined with the time conflict problem. In addition, by means of a scheduling algorithm that compares the priority of each personal schedule or work schedule set in advance by a specific person who can attend the meeting with the priority set by another candidate person, such conflict related to meeting scheduling may be handled. The present invention also considers whether a schedule negotiation is impossible because the reason for the schedule conflict is fixed and unchangeable by his or her own interest. In a situation where multiple meetings are scheduled to be held, the AI meeting scheduling according to the first aspect of the present invention may efficiently select someone to join the meeting, from a large number of people.

Next, in the case of the second aspect of the present invention, the AI meeting management agent is able to accurately determine whether the person currently attending the meeting has the right, or the authority, to participate in the meeting through an identification process that includes at least facial fingerprint information and vocal fingerprint information.

Of course, in order to identify participants by AI, it is necessary to obtain video and audio data about meeting participants from the virtual or on-site conference room. And by comparing the obtained video and voice data with the stored fingerprint information with AI algorithms, it is possible to confirm the identity of the actual participant. The pre-stored fingerprint information includes at least identification information, which could be facial fingerprints and vocal fingerprints. It is also possible to use fingerprint information that includes at least one or more of the meeting participants' names, team information, email information, contact information, and information about behavior patterns to drive the participant identification algorithm. On the other hand, the stored fingerprint information is operated and managed by a certain organizational unit such as a company, government, or private organization. Thus, the stored fingerprint information includes the identification information of all members belonging to the organization.

Based on the fingerprint information and the video or voice data from the virtual or onsite conference room, the present invention independently drives an AI face recognition algorithm and an AI voice recognition algorithm to determine whether a person currently participating in the meeting has an appropriate authority to participate in the meeting. In this way, the results of independent judgments on faces and voices can be comprehensively reflected in the final judgment of the AI meeting management agent, and thus the present invention enables multifaceted and more accurate AI identification compared to identifying participants only by face or by voice. The AI identification will additionally reflect the aforementioned extra identifying information. In particular, in the present invention, the comparative analysis (i.e., the operation of comparing the audio/video data obtained from the virtual or real conference room and the database for identification) should be done not only for the limited list of people allegedly having the authority to participate in a specific meeting, but for all personnel belonging to a certain size organization to which the present invention applies, so as to eliminate bias in AI judgment as much as possible. If the organization has a total of 100 members, for example, even if only 5 people are scheduled to attend the current meeting, the identification data of all 100 people will be used as a comparison group to improve the accuracy of AI analysis. In order to reduce the amount of AI computational burden, the AI meeting management agent according to the present invention may be provided with a list of participants in this meeting, and the AI meeting management agent may be configured to perform the identity identification operation only within the given list. However, in this case, since the identity matching will not be applied to the person outside the list provided to the AI meeting management agent, the present invention considered the possibility that the AI assumes that the comparative analysis be done only for the people who are highly-likely the person who actually has the meeting participation authority, which might not be preferable bias for AI computations.

In addition, the present invention enables AI identification optimized for actual meeting situations by allowing weights (that is, weighting values) to be given to each of facial recognition, voice recognition, and other recognition processes. For example, in some meetings, the conference room camera and voice recorder may have to rely more on the voice recognition part due to poor conditions for reviewing participants visually. In other meetings, the performance of the conference room camera or the smartphone camera of the meeting participants might be superior, thus giving more confidence to the facial recognition results. In the latter case, obtaining the weighted average with more weighting values on the facial recognition results and less weighting values on the voice recognition results may be an optimized model for evaluating meeting participants.

If an identification process is adopted, which compares and contrasts the ID card image and the name of all members of the organization based on additional, or, extra identity information, such as the name of the meeting participant or, for example, the employee ID image (i.e., the name of the employee ID card holder) captured by the conference room camera, it is possible to give additional weight to this “other identification process”. Therefore, in the present invention, the weighted average is based on the premise that there are various criteria for identifying a person, such as negative test, face judgment, and other judgments (e.g., ID judgment of name, employee ID, personality, behavioral pattern, handwriting, etc.), and it is possible to increase the accuracy of participant identification by AI as much as possible by finally confirming the identity of an actual meeting participant with a value weighted by two or more judgment criteria without bias.

In short, the present invention executes a multifaceted and independent identity identification process in three aspects: namely, (a) facial recognition, (b) voice recognition, and (c) extra recognition, and then synthesizes all these results into appropriately adjusted weights to suit the meeting situation, so that the final AI participant identification can be precisely achieved.

Moreover, the second aspect of the present invention evaluates and learns by itself that the AI can analyze the meeting attendees with the highest accuracy when using a specific combination of technologies for a voice judgment module, a face judgment module, and extra judgment modules (e.g., name, employee ID card, personality or handwriting analysis, etc.) to identify meeting participants. It provides insights that allow you to change the combination of technologies for the voice detection module, face detection module, and other extra judgment modules as needed.

It is obvious that there exist not only two or three AI algorithms for voice/face/other ID identification, but also there exist so many commercially available speech recognition algorithms, face recognition algorithms, and other extra recognition algorithms. Therefore, in order to determine which combination of algorithms among the various algorithms produces the best performance, the present invention allows the AI meeting management agent to conduct the AI performance evaluation by itself, and at the same time, the present invention allows to change the combination of the set of voice/face/extra recognition algorithms or change the weight allocated for each algorithm based on the AI performance evaluation results.

In short, the process of identifying meeting participants according to the present invention is not limited to a specific face recognition algorithm, voice recognition algorithm, or other identification algorithm, and allows the AI meeting management agent to learn on its own various algorithms and weight combinations that can achieve better AI identification results through AI performance self-evaluation.

Finally, in the case of the third aspect of the present invention, an AI evaluation platform is proposed, which analyzes the participation of meeting participants from, particularly, video data recognized by a camera in a conference room or a camera of a smartphone used to access an online meeting, and enables a person with evaluation authority to use it as a real-time evaluation or post-evaluation index for the better operation of the meeting by evaluating the attitude of the meeting participants using the AI.

In particular, the present invention not only presents a technique for analyzing conference room video data in various aspects such as face-based gaze analysis, eye-based gaze analysis, mouth-shape-based language analysis, and body language analysis by AI, but also enables the share of the “participation evaluation score” (i.e., the weight for the present invention) to be reasonably set for each analysis technique.

On the premise that sometimes face-based gaze analysis and sometimes body language analysis can be more meaningful participation evaluation data for the evaluator according to the user using the system and method according to the present invention, the meeting evaluator can assign different weights to the analysis results to each of the AI analysis techniques mentioned above using his or her own smartphone, for example. In the case of the participation evaluation score that is summed in this way, the analysis results of AI analysis techniques with different importance or weight can be reflected in different proportions depending on the situation of the evaluator using the present invention, so that the evaluator can reasonably choose the participation evaluation method he or she wants the most.

The weighting technology may also reflect the evaluator's subjective trust or opinion on AI behavior analysis techniques such as face-based gaze analysis, eye-based gaze analysis, mouth-shape-based language analysis, and body language analysis. However, sometimes the above weight adjustment can be done when the performance of the camera in the conference room is not sufficient for eye-based eye analysis, and sometimes the weight adjustment is unavoidable due to the poor network environment of the participants participating in the online meeting where the video data of the participants cannot be acquired at all. The present invention enables such an unpredictable meeting environment to be reflected in AI calculations in the form of multifaceted weights.

In addition, not only can the behavior analysis of meeting participants, which was done directly at the meeting room site in the past, be automatically performed by AI technology, but the behavior analysis can be done based on various criteria such as gaze and mouth shape, making it possible to evaluate participation more multifaceted and comprehensively than the evaluation of meeting participants only with the eyes.

### BRIEF DESCRIPTION OF THE DRAWINGS

The present invention may be better understood with reference to the following drawings and descriptions. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is an illustrative drawing representing an AI meeting scheduler system according to the first embodiment of the present invention.

FIG. 2 is an illustrative drawing to illustrate in more detail the function of the AI meeting scheduler server according to the first embodiment of the present invention on a module-by-module basis.

FIG. 3 is an illustrative drawing showing an illustrative configuration of a candidate database (“DB”) server that can be adopted in an AI meeting scheduler system according to the first embodiment of the present invention.

FIG. 4 is an illustration showing an example of a meeting information DB server that can be adopted in an AI meeting scheduler system according to the first embodiment of the present invention by classifying meeting agendas by topics or team missions.

FIG. 5 is an illustrative drawing showing an illustrative configuration of an offline meeting system that can be linked with an AI meeting scheduler system according to the first embodiment of the present invention.

FIG. 6 is an illustrative drawing showing the user interface (UI) that can be provided to the client who is the meeting organizer, by an AI meeting scheduler service, according to the first embodiment of the present invention.

FIG. 7 is an illustrative drawing that illustrates the message that can be provided to the client who is a meeting participant, by an AI meeting scheduler service, according to the first embodiment of the present invention.

FIG. 8 is an illustrative drawing showing the overall configuration of the AI software for implementing an AI software applicable to all aspects of the present invention.

FIG. 9 is a flowchart for illustrating an illustrative AI meeting scheduler service algorithm implemented by AI software according to the first embodiment of the present invention.

FIG. 10 is an illustrative drawing showing an AI-based automatic participant recognition system and an AI meeting management agent according to the second embodiment of the present invention.

FIG. 11 is an illustrative drawing illustrating the process of identifying meeting participants in terms of speech recognition according to the second embodiment of the present invention.

FIG. 12 is an illustrative drawing showing the process of identifying meeting participants in terms of facial recognition according to the second embodiment of the present invention.

FIG. 13 is an illustrative drawing representing the process of identifying meeting participants in terms of personality and other perceptions according to the second embodiment of the present invention.

FIG. 14 is a drawing showing an example of identifying a meeting participant by a weighted multi-dimensional recognition process according to the second embodiment of the present invention.

FIG. 15 is an illustrative drawing showing a conference room applying a weighted multi-dimensional recognition process according to the second embodiment of the present invention.

FIG. 16 is a drawing for illustrating the process of analyzing the results of applying a weighted multi-dimensional recognition process according to the second embodiment of the present invention based on the type and a combined set of identification tools applied for the recognition, and reflecting the analysis results in AI evaluation and learning.

FIG. 17 is a flowchart showing the overall AI meeting participant automatic recognition algorithm according to the second embodiment of the present invention.

FIG. 18 is a drawing for illustrating some of the AI training processes for analyzing the meeting participation attitude or behavior of meeting participants through video according to the third embodiment of the present invention.

FIG. 19 is a drawing for the overall description of an AI algorithm that can be used for analyzing the behavior of meeting participants through a meeting video according to the third embodiment of the present invention.

FIG. 20 is an illustrative drawing representing the process of analyzing the face of a meeting participant captured in a meeting video according to the third embodiment of the present invention.

FIG. 21A and FIG. 21B are drawings for illustrating the process of analyzing the eyes of a meeting participant captured in a conference video according to the third embodiment of the present invention.

FIG. 22 is a drawing for illustrating the process of analyzing the shape of the mouth of a meeting participant captured in a meeting video according to the working embodiment of the present invention.

FIG. 23 is an illustrative drawing for illustrating a system and method for a meeting evaluator evaluating one or more meeting participants based on behavior analysis by an AI application based on video data obtained during a meeting, according to the third embodiment of the present invention.

FIG. 24 is a flowchart showing the whole AI meeting evaluation algorithm according to the third embodiment of the present invention.

### DETAILED DESCRIPTION

The various embodiments of the present invention will be explained in detail with reference to the attached drawings.

### First Embodiment

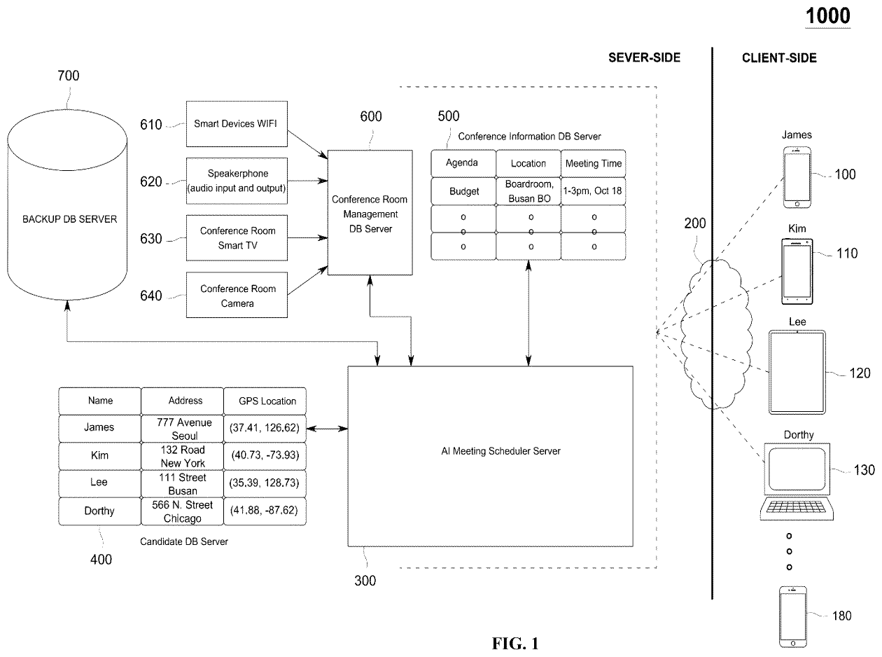

FIG. 1 is an illustrative drawing representing an AI meeting scheduler system 1000 according to the first embodiment of the present invention. For reference, in the following, the method implemented by the computer regarding the AI meeting scheduler system 1000 will be named as “AI meeting scheduler Method.”

As shown in FIG. 1, an AI meeting scheduler system 1000 according to the first embodiment of the present invention may include, for example, a cloud-based server/client system.

Among them, the client includes the meeting organizer's terminal 100, e.g., smartphone, which requests scheduling services to the AI meeting scheduler server 300 by entering the information of the upcoming meeting. Let's assume that the user device 100 is owned by a company employee named James, for convenience. In the client-server system 1000 of the present invention, the client may also include a user terminal 110 such as a smartphone of a candidate meeting participant Kim, a user terminal 120 of a candidate meeting participant Lee such as a smart pad, and a user terminal 130, such as a PC, of a candidate meeting participant Dorthy. Here, “candidate” means someone who may participate in a meeting to be held in the future. It should be noted that the role of the meeting “organizer” or meeting “participant” or “participant candidate” may change from meeting to meeting, and that if it is a device that requests scheduling services according to the present invention toward the AI meeting scheduler server 300, it will be likely to be the meeting organizer's smart device.

On the other hand, the AI meeting scheduler server 300, which provides the AI conference scheduler service according to the present invention toward these clients 100 to 130, can be connected to the clients 100 to 130 by a wired or wireless network 200 and can automatically handle various meeting-related services online or in a cloud system. For example, the network 200 shown in FIG. 1 200 supports wired communication between the AI meeting scheduler server 300 and the clients 100 to 130, and is equipped with a local area network (LAN) or WAN (Wide Area Network), broadband cable, or public switched telephone network (PSTN) which is an analog telephone network. Furthermore, the network 200 can be a digital cellular network called WIFI (Wireless Fidelity, or Wi-Fi™), Bluetooth™, or other so-called 4G or 5G. Although not shown in FIG. 1, it is more desirable to include a gateway in the network route that enables communication between various networks using different communication protocols, in case that the networks used by clients 100 to 130 are disparate networks, such as PSTN and digital cellular networks. In short, since the present invention also supports remote video conferencing services, it is important to build a conference network environment that can flexibly respond to the geographical location of the other party to the meeting as well as the performance of the device used by the meeting participants, and the networking protocol environment. Although not shown in FIG. 1, the path of the network 200 may include a firewall installed by a company or a government agency to block malware.

Continuing with FIG. 1, it is desirable that the AI meeting scheduler server 300 of the present invention be configured to be linked with multiple DB servers 400, 500, 600, 700 to provide highly automated meeting scheduling services. For example, the candidate DB server 400 shown in FIG. 1 is a DB server that manages the pool of participants of individuals or groups (e.g., in the case of participating in a meeting by a team) that is likely to participate in various meetings according to the AI scheduler service of the present invention. Here, the “details” about the participant pool, e.g., 100, 110, 120, 130, are organized and stored according to a certain criteria, as illustrated in FIG. 1, and updated from time to time as needed. As described earlier, participants in one meeting may later become the organizer of another meeting or vice versa, so the pool of participants managed by the candidate DB server 400 does not distinguish between the status of the meeting organizer or the meeting participant in the first aspect of the present invention.

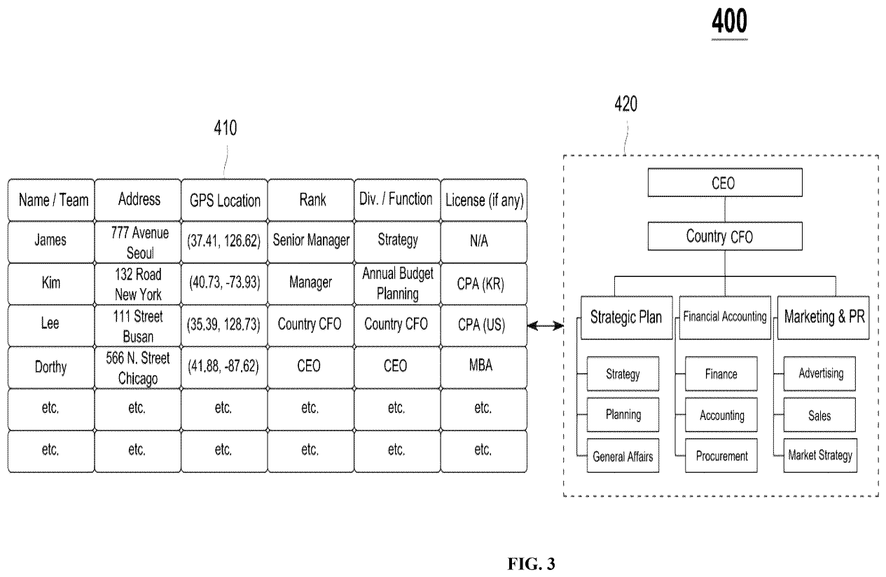

Since the AI meeting scheduler service of the present invention provides a function that automatically selects the best number of people to attend the meeting and automatically generates their meeting schedule even when only basic information such as the agenda of the meeting to be held is available, the information about the participant pool stored on the candidate DB server 400 is used in the first step for selecting a number of people to participate in the meeting in providing the AI meeting scheduler service according to the present invention. Regarding the candidate DB server 400, there will be more descriptions in detail with reference to FIG. 3.

For reference, as previously explained, for the purposes of the present invention, “candidate” comprehensively refers to an internal employee, an outside consultant, a conference organizer or manager who will host a meeting, a presenter, a speaker, and a participant (audience) of a lecture. In other words, if appropriate consent to provide his or her personal information is obtained, the “participant pool” managed by the candidate DB server 400 may include any number of different categories of individuals or groups/teams in accordance with the service requirements to which the present invention applies, and even information about bot participants participating in meetings in the form of AI bots may be managed by the candidate DB server 400.

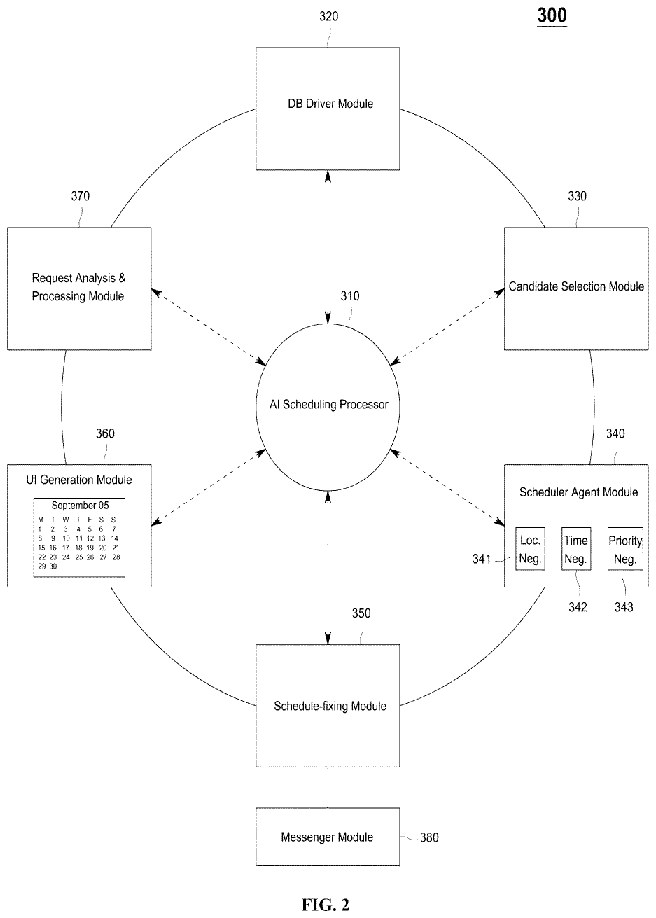

In addition to the present invention, the “details” of the participant pool include the name, position, department, age or experience/seniority of the individual candidate to participate in the meeting, history of project performance, certification information, residential address, real-time GPS location information of the user device being used, preferred conference room's device environment such as no surveillance cameras or large screen for teleconferencing, and scheduling information including personal and work schedules. This point will be explained in more detail in FIGS. 2 and 3.

On the other hand, the AI meeting scheduler server 300 according to the present invention is configured to link with the meeting information DB server 500. In other words, the AI scheduler service provided by the present invention may include, for example, scheduling services such as various internal meetings, lectures, and online training. Meeting information such as one or more organizers or presenters' names, the purpose of the meeting, the specific meeting agenda, and the expected number of participants in such meeting may be any information required by the AI meeting scheduler server 300. If scheduling is required to reflect information about one or more individuals or departments of an organization, the meeting content, or the individuals or departments responsible for disclosing the meeting content, such information will be recorded on the meeting information DB server 500 as well and will be updated from time to time. The recorded meeting information will be sent to the AI meeting scheduler server 300 as necessary.

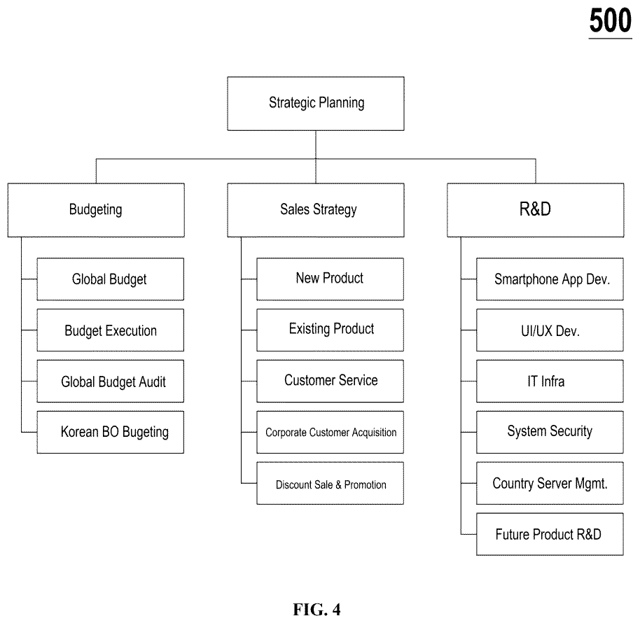

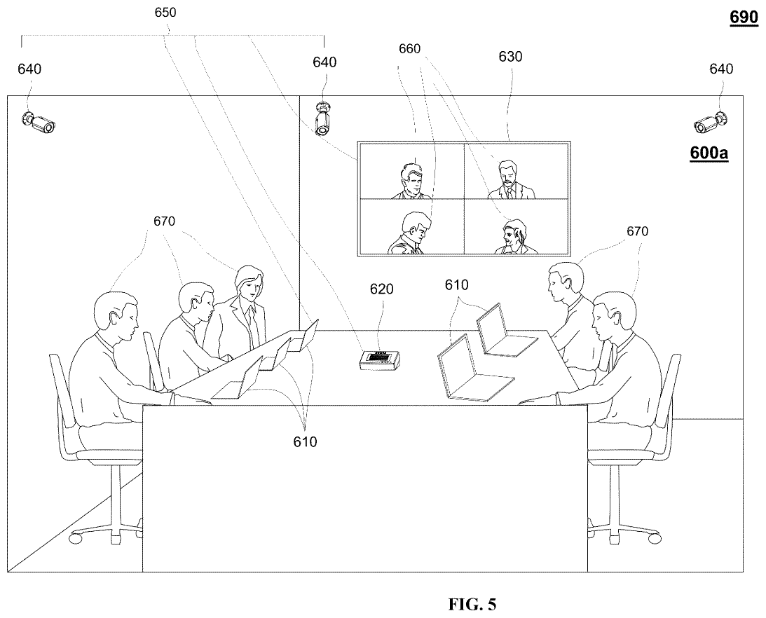

Basically, the meeting information DB server 500 manages the meeting agenda, that is, the meeting information scheduled to be held according to the topic, and this point will be described later by referring to FIG. 4. For reference, as illustrated in FIG. 1, it is desirable that the meeting information DB server 500 includes address information or GPS location information regarding the meeting so that the AI meeting scheduler server 300 can reflect the distance between the current location of meeting attendees and the scheduled meeting location during the selection of candidates to attend the meeting. Although not shown in FIG. 1, the meeting information DB server 500 may also contain information about conference equipment status in a conference room where the meeting will be held. (for example, see FIG. 5 below).

Continuing with FIG. 1, the AI meeting scheduler server 300 of the present invention can be linked with a meeting room management DB server 600 to implement an AI scheduler service according to the present invention. For example, if an AI scheduler service according to the present invention is implemented within a multinational enterprise, the present invention proposes a configuration to be able to access each conference room information scattered around the world. (e.g., the reservation information of the conference room, the available meeting device information provided in the conference room, etc.)

For example, conference rooms that can be used by multinational companies can be in various forms including virtual conference rooms and onsite meeting rooms. Sometimes some meeting rooms might be only accessible to specific external consulting or law firms dealing with important business matters with the company. And each conference room may have different information about the equipment it is equipped with. For example, a conference room installed in a branch office building in a foreign country may or may not have a SIP phone that supports multimedia conferencing according to the SIP (Session Initiation Protocol) standard.

The device installation information for the conference room, as exemplified in FIG. 5 below, is necessary to prevent a meeting with a completed schedule according to the present invention from suffering from the problem of not supporting the device requirements (for example, a video conference was scheduled, but a certain conference room does not support a video conference network or video display equipment). In this way, the meeting room management DB server 600 contains information about the meeting rooms that can be used in the meeting and updates the information from time to time as needed.

On the other hand, as shown in FIG. 1, it is desirable that the AI meeting scheduler server 300 of the present invention be configured to be linked to a backup DB server 700 that stores all relevant information necessary for the aforementioned meeting scheduling, including the service provision history related to the meeting scheduling service.

FIG. 2 is an illustrative drawing to illustrate in more detail the function of the AI meeting scheduler server 300 according to the first embodiment of the present invention on a module-by-module basis.

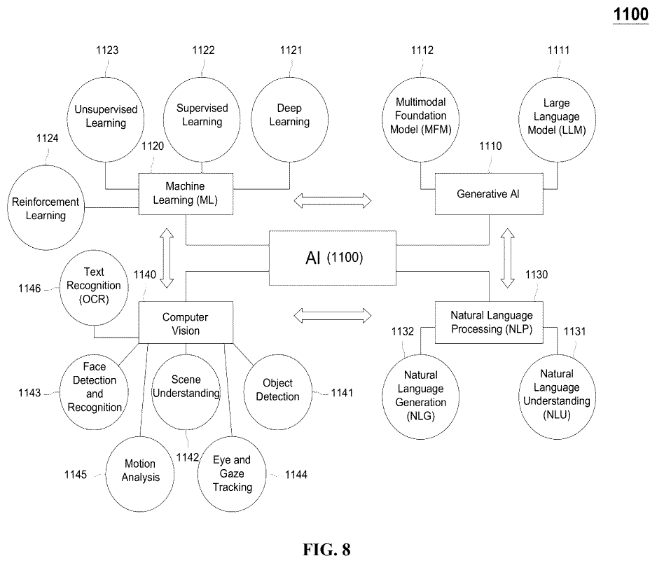

As shown in FIG. 2, the most important configuration of the AI meeting scheduler server 300 is the AI scheduling processor 310. The AI scheduling processor 310 includes a high-performance CPU (Central Processing Unit) capable of handling complex AI operations. In addition, the AI scheduling processor 310 includes internal memory and a GPU (Graphics Processing Unit), where a GPU refers to a computer processor that renders images and videos through fast calculations. As will be described later in FIG. 8, the AI software 1100 adopted in the present invention may sometimes need to perform image and video processing, and thus the better the GPU performance is, the faster the AI calculation will be.

Referring to FIG. 2, the actions performed by the AI meeting scheduler server 300 through the AI scheduling processor 310 according to the present invention can be broadly divided into six modules as shown in FIG. 2.

First of all, as mentioned in FIG. 1, the AI meeting scheduler server 300 needs to send and receive data from multiple other databases and servers 400, 500, 600, 700 within the AI meeting scheduler system 1000, and therefore, a database driver module 320 is required. The DB driver module 320 allows the AI meeting scheduler server 300 to send structured query language (SQL) to multiple DB servers 400, 500, 600, 700 to interact with those multiple DB servers 400, 500, 600, 700 and to perform actions such as fetching data from the DB. Of course, depending on the type of database, the AI meeting scheduler server 300 may need to use a protocol for database communication other than SQL, and if the AI meeting scheduler system 1000 is operating on the web as a whole, the AI meeting scheduler server 300 can communicate with various databases 400, 500, 600, 700 using a combination of HTTP (Hypertext Transfer Protocol) and SQL, for example.

Next, the candidate selection module 330 selects the most suitable meeting participants, e.g., 110 to 130 in FIG. 1, for the meeting to be held when the information about the meeting to be held is entered from the smartphone of the meeting manager or organizer, e.g., 100 in FIG. 1. In this case, for example, one to three times bigger number or more candidates may be temporarily selected for the meeting to be held. The criteria for selecting candidates to attend the meeting in the candidate selection module 330 are based on the information received and collected from the candidate DB server 400, the meeting information DB server 500, and the meeting room management DB server 600, for example, by applying the candidate selection algorithm as follows.

For example, if a scheduled meeting requires three participants in addition to the meeting organizer 100, the candidate selection module 330 may select three to nine or more participant candidates in the first place. Since the information related to the scheduled meeting entered by the meeting organizer 100 is updated to the meeting information DB server 500, the AI meeting scheduler server 300 can obtain information from the meeting information DB server 500 such as the meeting location to be held, the expected meeting method (that is, whether the meeting will be held in an offline meeting room or by an online video meeting, etc.), or the meeting agenda (e.g., a smartphone operating system (OS) developer forum, a meeting on the company's budget formulation, a new product marketing strategy presentation, etc.). In addition, if there are personnel who are required to attend a meeting to be held (e.g., a meeting that Dorthy in the position of CEO as exemplified in FIGS. 1 and 3) or information about the experience/specialties or expertise required for the meeting (e.g., the professional competence of the employee Kim having experience in budgeting in South Korea, as exemplified in FIG. 3), such additional information may be entered by the meeting organizer 100. The candidate selection module 330 performs a matching process to select candidates based on the information of the scheduled meeting entered in this way. However, in the case of the present invention, it is also possible to “anticipate” the number of required attendees, experience/specialties that may be useful for the meeting, and recommended meeting places from only one piece of information, for example, “meeting agenda”, by utilizing various functions of the AI software 1100 shown in FIG. 8. In other words, even if not so much information is entered by the meeting organizer 100, the candidate selection module 330 can still be used as the basis for selecting candidates.

In this way, based on the information of the scheduled meeting entered by the meeting organizer 100 and the various information inferred by the AI software 1100 from it, the candidate selection module 330 selects candidates in the order of the highest match rate with the scheduled meeting. For example, if the meeting organizer 100 simply enters the meeting agenda as “budget proposal meeting,” the AI software in FIG. 8 1100 extracts the workforce information with participant pool “details” corresponding to the keyword “budget” from the candidate DB server 400. To use the example in FIG. 3, Kim would be the candidate with the highest match rate for the keyword “budget”, and Lee, who holds the position of CFO, or James, who has experience in strategy formulation, may also show competing match rates in comparison to Kim.

For more sophisticated meeting participant selection, the AI software 1100 can generate some keywords which it thinks are necessary for this meeting in addition to the keyword “budget.” For example, in the case of “budget formulation meeting,” these keywords can be automatically generated by the AI software 1100 and considered when selecting meeting participants. In this case, Lee holding the CFO position, may have an equal or higher match rate in comparison to Kim. This is because Lee is an employee who is matched with a new keyword “CFO” generated by the AI software 1100.

In the case of the candidate selection module 330 according to the present invention, the weights for each keyword or item (rank, department/team, career length, etc.) may be automatically generated and applied when calculating the match rate for selecting candidates as meeting participants. For example, if we assume that a senior-level strategy expert from the Strategic Planning Office of a company has always attended the “budget formulation meeting” held in the Korean branch, the AI software 1100 may be trained by this previously-accumulated meeting history and may calculate the match rate on the premise that one among three expected attendees of this meeting must include James unless there is a scheduling conflict that will be described later. Even if the user James is the meeting organizer 100, if the AI software 1100 determines that James is the person who should attend the meeting, the candidate selection module 330 may select James as a candidate for the meeting in the first round of AI inference.

Sometimes, depending on who the meeting organizer 100 has requested for a “budget formulation meeting”, the AI software 1100 may perform a different match rate calculation than above. For example, when referring to FIGS. 1 and 3, James, the person who asked to convene the “Budget Formulation Meeting,” can intervene in the selection of candidates for the meeting to include one CFO of the Korean branch office and one senior-level person from the Strategic Planning Office. As another example, if the organizer for the “budget proposal meeting” is the CEO, and if the attendance of the team leader of the procurement team in the past three years is detected from the backup DB server 700, the AI software 1100 will be able to select the procurement team's leader as the top-priority meeting participant even if nobody in the company knew that the procurement team could be involved in this meeting. All these are possible based on the AI learning of accumulated information during the past three years in conjunction with the fact that the meeting organizer for this meeting is the CEO at this time.

However, it should be noted that the results of the first round of AI inference and selection by the candidate selection module 330 are not final. This is because the present invention has the scheduler agent module 340 as shown in FIG. 2. The scheduler agent module 340 should judge whether there is any schedule conflict for each selected candidate according to when and where the scheduled meeting will be held. There are two types of schedule conflicts defined in the present invention. One is the place or locational conflict, and the other is the time conflict, as will be further described below.

The “location conflict” as considered by the scheduler agent module 340 means that the venue of the meeting scheduled to be held is not appropriate in consideration of the address or current location of each candidate previously selected by the candidate selection module 330. For example, if the address of a candidate selected by the candidate selection module 330 is Seoul, South Korea, and the scheduled meeting is expected to be held in New York, USA, this candidate James may be removed from the shortlist by the scheduler agent module 340 due to a conflict of location. Of course, if the meeting venue allows online meetings, i.e., virtual meetings, then in the case of candidate James illustrated in FIGS. 1 and 3, he will be finally selected as a candidate participant unless the time conflict arises. For reference, the location conflict is handled by the location negotiation module 341 as depicted in FIG. 2.

In addition, for example, if the meeting is scheduled to be held in Busan, and a particular candidate needs to hold another meeting in Seoul at least one hour before the Busan meeting starts, the scheduler agent module 340 may determine that it is almost impossible for the particular candidate to attend the scheduled meeting onsite, even if the fastest means of transportation such as an airplane may be used. In this case, the scheduler agent module 340 may also consider the candidate as a non-negotiable candidate and immediately remove the candidate from the shortlist.

However, the first additional point to consider in the above example is whether there is room for the Seoul meeting to be shifted to another date and time (Schedule Shifting), or whether the Busan meeting is a fixed schedule that the candidate must attend. If the Busan schedule is fixed and thus the Busan schedule is not negotiable, and if online video conferencing is not allowed for Seoul and Busan meetings, the specific candidate in the above example will eventually be excluded from the list of candidates, considering the distance between Seoul and Busan cities, and also considering the traveling time by transportation between those two cities. For reference, the time conflict is handled by the time negotiation module 342 as depicted in FIG. 2. Seemingly the time may be regarded as irrelevant to the location. However, as described above, time conflict and time required for traveling may be closely connected to the location conflict especially when the meeting only allows on-site participation.

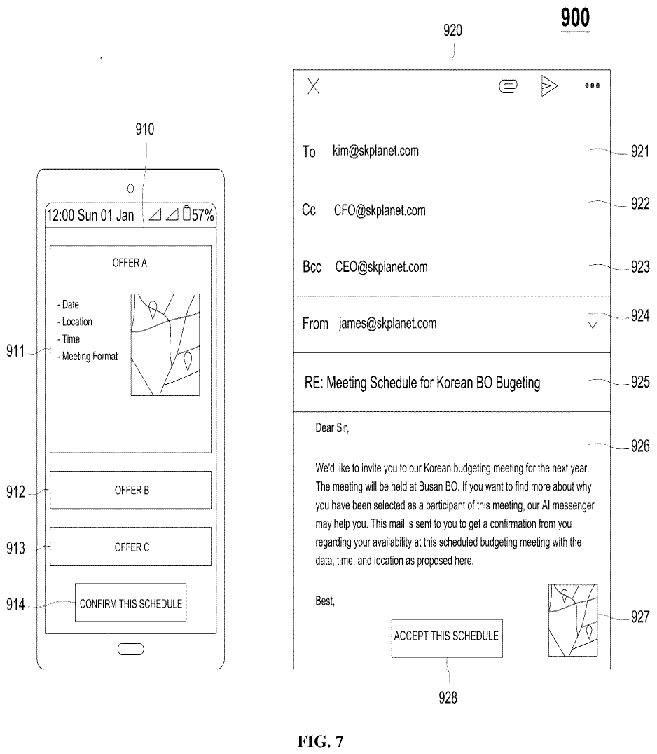

The second point that can be considered in relation to the conflict of places in the present invention is the “priority.” The priority in the present invention can be used in a situation where the organizing user who asked to arrange the scheduling of the meeting enters an arbitrary integer value such as the maximum priority value of 100 for the “budget formulation meeting.” If, as illustrated in FIG. 1, there is a candidate Kim living in New York which is very far from the scheduled conference room at the Busan branch office where the “Budget Formulation Meeting” will be held, the AI meeting scheduler server 300 can contact the user Kim 110 to negotiate Kim's schedule in the same form as shown in FIG. 7, so that Kim may cancel all subordinate schedules, for example, for three days before and after October 18, when the “Budget Formulation Meeting” will be held. In this case, based on the feedback results of the meeting candidate Kim 110, the scheduler agent module 340 will be able to determine whether to include Kim for the budget meeting. For reference, the priority negotiation is handled by the priority negotiation module 343 as depicted in FIG. 2.

For reference, even if there is no conflict of place described above in terms of “residence or address,” for example, if the real-time GPS location of the user 110 updated from the candidate DB server 400 is still confirmed to be New York on the day of the scheduled meeting, it can be concluded that the scheduler agent module 340 according to the present invention cannot allow the attendance of Kim at the meeting scheduled to be held in Busan on the same day. In this case, for example, the scheduler agent module 340 may notify the user Kim 110 that he is determined to be unavailable by AI for the Busan meeting. Then the scheduler agent module 340 will wait until the candidate selection module 330 finds a candidate who can immediately negotiate to join the Busan meeting instead of Kim. This is an example of conflict by the current location.

Next, “time conflict” means that the candidate selection module 330 selects a user 130 who holds the position of CEO as a candidate, but the personal or work schedule of the user 130 received from the candidate DB server 400 overlaps with the date and time of the scheduled meeting. (e.g., between 1 p.m. and 3 p.m. on October 18, see FIG. 1) The time conflict may be relevant to the collision due to the overlapped date and time between two schedules. However, as noted above, different types of conflict are closely related to each other. Thus, traveling time required to attend a meeting might be considered as a location conflict, as a time conflict, or sometimes as a complex conflict where two or more conflicts are entangled.

The scheduler agent module 340 may negotiate or resolve the time conflict problem depending on whether the scheduled meeting and other schedules that overlap with the time zone are fixed or shiftable schedules for the user CEO 130, or whether the priority for a meeting is higher or lower than another scheduled meeting.

The schedule-fixing module 350 in FIG. 2 is a module that considers, for example, the schedule negotiation result by the scheduler agent module 340 during the first and second round of candidate selection process and confirms the third and final selection of candidates to attend the meeting, e.g., the Busan meeting, according to the following process. To be clear, the first round means the process where the scheduler agent module 340 adjusts the meeting schedule based on the very first selection result about the potential meeting's candidates. Then, the second round would mean another process where the scheduler agent module 340, for example, excludes Kim from the candidate list and receives another candidate list from the candidate selection module 330, and so on.

Therefore, the schedule-fixing module 350 can be regarded as a final confirmation tool during the final round of selection, based on whether the candidate gives a consent to the AI's candidate selection result including the expected meeting time, location, and available meeting equipment.

The schedule-fixing module 350 notifies the candidates selected for the second time (e.g., 110, 120, 130, etc.) and the meeting organizer, e.g., 100, of the results of the second selection through the messenger module 380 based on the results of the operation of the scheduler agent module 340. If feedback from the meeting participant 110 or the second-round candidates 110, 120, 130 is received that the meeting is not available for any one of them, the schedule-fixing module 350 may request the candidate selection module 330 and the scheduler agent module 340 to re-scheduling the meeting to be held, as it determines that it is necessary to reflect the negative feedback of the potential meeting participants on AI's meeting scheduling. Even if the first and second rounds are filtered by the candidate selection module 330 and the scheduler agent module 340 and the schedule negotiation is regarded as completed, the schedule-fixing module 350 can wait a reply from the messenger module 380.

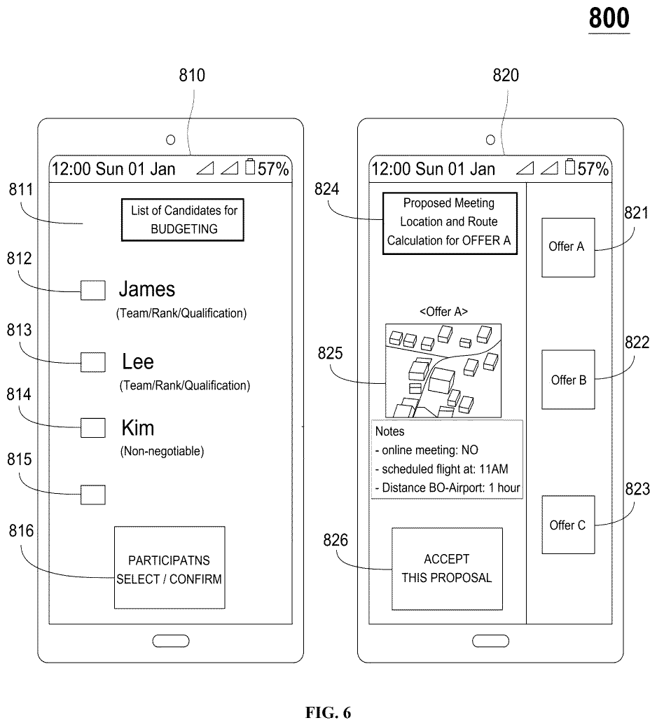

The UI generation module 360 in FIG. 2 is a component that creates an exemplary user UI 800 shown in FIG. 6 and displays it on the user's device 100 to 130. As will be described later in FIG. 6, the AI meeting scheduler server 300 and AI software 1100 may show schedule-related matters to the user 100 to 130 by means of the UI tool.

In the case of the screen displayed to the meeting organizer 100, it can provide a list of candidates for participants (i.e., a list that has been filtered up to the third round) corresponding to the information of the scheduled meeting that the meeting organizer, e.g., 100, requested to schedule from the AI meeting scheduler server 300; and the basis for selecting these participants, and the function that allows the meeting organizer 100 to reschedule if the meeting organizer 100 is not satisfied with the AI calculation results. If the meeting organizer, e.g., 100, has delegated all authorities for finalizing the schedule to the AI meeting scheduler server 300, the user confirmation function (e.g., the button 816 in FIG. 6) about the AI-scheduled meeting confirmed by the schedule confirmation module 350 may not be necessary.

Finally, the request analysis and processing module 370 shown in FIG. 2 analyzes the requirements for the scheduled meeting by analyzing the text, images, or audio or video data related to the meeting organizer's request, by the AI software 1100, when a meeting organizer's scheduling request is received from client devices 100 to 130 to the AI meeting scheduler server 300. This may include, for example, whether his or her attendance of the meeting replied to the messenger module 380 has been confirmed, or whether the meeting organizer, e.g., 100, has delegated all scheduling rights to the AI. If the scheduled meeting is suddenly canceled, the client devices 100 to 130 will be notified accordingly.

FIG. 3 is an illustrative drawing showing an illustrative configuration of a candidate database (“DB”) server 400 that can be adopted in an AI meeting scheduler system according to the first embodiment of the present invention.

Referring to FIG. 3 and FIG. 1, the candidate DB server 400 may contain a DB entry 410 for each candidate individual/team together with details related to the candidates 100 to 130. The organizational chart DB entry 420, for example, may be included as well in the candidate DB server 400.

Regarding the DB entries 410 for each candidate/team, it is desirable to include the name and address information of each individual included in the participant pool, as well as real-time GPS location information, that is the current location, received from each individual's smart devices 100 to 130. Maybe, according to the laws and regulations of the country to which the present invention applies, in order to obtain such detailed individual information, it would be necessary to obtain personal consent regarding the use of privacy information from each individual in advance.

Furthermore, the DB entry for each candidate/team 410 may contain information about each candidate's current and past position information or current team/department information. It is desirable to include information about the projects that each individual is currently working on or has worked on in the past, in order to precisely determine the match rate between the individual's work performance and the expected meeting agenda of the upcoming meeting. In addition, it is also desirable to include the certificate or license information that each individual validly possesses as an expertise information in the DB item 410 for each candidate individual/team, as shown in FIG. 3. Although not expressly stated in FIG. 3, the “candidate” under the present invention does not necessarily have to be an individual, and sometimes the “candidate” may be a team unit, whole department at a company, or a population group belonging to a certain class. For example, if the present invention is used to provide a public hearing service at the Seoul City Hall, the whole citizen of Seoul who meets the specific conditions for attending such public hearing may become the “candidates,” and such public hearing service will be regarded as a “potential meeting” in the present invention.

The organizational chart DB item 420 can be created and stored in a hierarchical configuration as exemplified in FIG. 4. The organizational chart in FIG. 4 may serve as a reference point for determining which employee in the hierarchy of the organizational chart might be a suitable candidate for a particular meeting agenda, especially when the AI software 1100 drives the candidate selection module 330. If the enterprise to which the present invention is applied is a horizontal organization, for example, or if the present invention is applied to a presentation or public hearing for an unspecified number of people, the “hierarchy” distinction between the meeting participants and the audience may be meaningless, in which case the organizational chart DB item 420 may be prepared in a horizontal configuration or may not be required at all.

Next, FIG. 4 is an illustration showing an example of a meeting information DB server 500 that can be adopted in an AI meeting scheduler system 1000 according to the first embodiment of the present invention by classifying meeting agendas by topics or team missions.

As illustrated in FIG. 1, the meeting information DB server 500 can contain various information such as meeting location, time, and available meeting equipment information in the conference room in addition to the meeting agenda. As described in FIG. 2, the AI scheduling processor 310, according to the present invention, automatically determines the optimal meeting candidates even if the meeting organizer, e.g., 100, does not know who an appropriate meeting participant would be. In other words, even if the meeting organizer, e.g., 100, enters only the minimum data like the meeting agenda, it is still possible for the AI software 1100 to find a standard for calculating the match rate for the potential meeting to be held and to select the candidate attendees. Based on the history of past meetings, for example, if a budget preparation meeting has been held in the large conference room at the Busan branch office from 1 p.m. on the third Thursday of October every year, the AI software 1100 that learned this history could predict the time and place of the budget preparation meeting and may provide an appropriate meeting scheduling services to the meeting organizer and potential participants. Therefore, if there is sufficient training data regarding past meeting history, it is possible for AI software 1100 to generate information for upcoming meetings when scheduling the same or similar meeting.

For reference, in FIG. 4, the meeting agenda called “Strategic Planning” is classified into three classes: budgeting, sales strategy, and R&D strategy by the meeting information DB server 500. If a meeting organizer, e.g., 100, makes a meeting scheduling request with the keyword “budget proposal”, the AI software 1100 extracts the information as shown in FIG. 5 from the meeting information DB server 500 and can infer the meeting agenda as “the budget preparation meeting of the Korean branch office” based on the fact that the meeting organizer, i.e., 100 in this example, turns out to work at the Korean branch office.

FIG. 5 is an illustrative drawing showing an illustrative configuration of an offline meeting system 600a that can be linked with an AI meeting scheduler system 1000 according to the first embodiment of the present invention. The offline conferencing system 600a illustrated in FIG. 5 may be a partial configuration of the meeting room management DB server 600 in FIG. 1. Some references not explained below will be addressed when explaining the second embodiment of the present invention.

As illustrated in FIG. 5 and FIG. 1, it may be important to check whether the meeting room 690 has an Internet access for smart devices 610 having WIFI function for scheduling a meeting. In particular, if a specific meeting allows both online video conferencing and offline meeting participation as exemplified in FIG. 5, it may be essential to schedule a conference room capable of supporting the network access. That is, in FIG. 5, there are virtual meeting attendees 660 and onsite meeting attendees 670, and thus, to make this meeting feasible, the network access of both the virtual meeting attendees 660 and onsite meeting attendees 670 would be essential.

The scheduler agent module 340 and the schedule-fixing module 350 mentioned above can confirm the available meeting equipment status for candidates by considering the device environment of the conference room. The available meeting equipment status may have to correspond to the meeting participant's modified request, if there is any.

On the other hand, the meeting room management DB server 600 can record audio information about various noises, by the speakerphone 620 shown in FIG. 5 and FIG. 1, for example. If one or more camera 640 is installed in the offline meeting system 600a of the conference room, it is also possible to visually record the meeting progress in the conference room. Furthermore, the meeting attendees 100 to 130 may want a meeting environment equipped with a conference room smart TV 630, in which case the AI meeting scheduler server 300 may need to check whether there is a available conference room smart TV 630 device from the meeting room management DB server 600.

FIG. 6 is an illustrative drawing showing the user interface (UI) that can be provided to the client who is the meeting organizer, by an AI meeting scheduler service, according to the first embodiment of the present invention.

As previously described in FIGS. 1 to 4, the meeting attendee confirmation interface 810, which contains the list of meeting attendance candidates 811 confirmed by the AI meeting scheduler server 300, may be displayed on the meeting organizer's smart device, e.g., 100, as shown in FIG. 6. The list of candidates for the meeting 811 may include buttons 812 that allow the person who requested the meeting to click on, for example, James, and may also include buttons 813, 814 that allow the meeting organizer, e.g., 100, to indicate his or her intention to manually include Lee as a meeting participant. Sometimes the meeting organizer 100 may still want to include Kim as the meeting participant even when the AI notified that Kim's schedule is non-negotiable for the upcoming meeting. The number of candidates for which scheduling conflicts have been resolved may sometimes be insufficient compared to the required number of people in the requested meeting, and in this case, there may be an empty button 815.

The meeting organizer, e.g., 100, may finalize the list of meeting participants by clicking the select and confirm button 816 included in the meeting attendee confirmation interface 810, for example. If the meeting organizer, e.g., 100, has delegated the authority to select meeting participants to the AI, as mentioned earlier, such a button 816 may be unnecessary.

On the other hand, the meeting organizer, e.g., 100, can be given various suggestions like offer A 821, offer B 822, and offer C 823 regarding the AI's decision on the participant's meeting schedule. The user 100 may click on touch interfaces 824 and 825 to review details of each offer. The detailed interface 820 can be created by the UI creation module 360 that shows any results that the meeting organizer 100 wants to see, in addition to the information displayed in the meeting attendee confirmation interface 810. This detailed interface 820 can also provide a function button 826 for the meeting organizer, e.g., 100, to accept or reject a specific offer.

FIG. 7 is an illustrative drawing that illustrates the message 900 that can be provided to the client who is a meeting participant, by an AI meeting scheduler service, according to the first embodiment of the present invention.

The message 900 exemplified in FIG. 7 is automatically generated by the AI meeting scheduler server 300 including the messenger module 380 in FIG. 2. In other words, in FIG. 6, the UI presents information about the meeting candidates who have completed the third selection filtering to the meeting organizer, e.g., 100, and now FIG. 7 shows a first message 910 that shows the results of the AI calculation to the meeting participants (e.g., 110 to 130) who have been selected for the second time before such participants are confirmed, and asks for a reply to them. For example, the schedule-fixing module 350 in FIG. 2 can make several possible meeting suggestions 911, 912, 913 to participants whose secondary filtering has been completed as the schedule conflict has been resolved by the scheduler agent module 340. As shown in FIG. 7, each proposal 911, 912, 913 provides the optimal meeting date, meeting location, meeting time. Those proposals can also include information about the means (teleconference, onsite meeting, available meeting equipment, etc.) of meeting. If a candidate for the meeting, e.g., 110 to 130, presses the confirmation button 914 to confirm one of those several proposals, the schedule-fixing module 350 may now sort that participant as a third-round selected participant, or a final candidate.

Messages sent to meeting participants, e.g., 110 to 130, may be a second message 920 having an email type rather than the in-app style first message 910. Email messages 920 are sent to meeting candidates 110 to 130 by automatically designating the email recipient 921 as well as the reference recipient 922 who may be, for example, another meeting participant or the recipient's team leader. If it's difficult to reveal a specific recipient publicly, the AI software 1100 can include someone's email address in the BCC recipients 923 field. The sender 924 entry may indicate the email address of the meeting organizer 100, as shown in FIG. 7, or the system email address of the AI meeting scheduler server 300, although not shown in FIG. 7. That is, sometimes the sender 924 may include the email address of the AI meeting scheduler server 300 itself. The subject of the email 925 may simply indicate the meeting agenda. The body of the email 926 may contain a description of the upcoming meeting automatically written by the AI software 1100. The expected traffic route information and map 927 and the approval button about the participation of the meeting 928 may also be included in the email message 920.

FIG. 8 is an illustrative drawing showing the overall configuration of the AI software 1100 for implementing an AI software applicable to all aspects of the present invention including the above-explained first aspect. The AI software 1100 may run on the AI meeting scheduler server 300 in FIG. 1 and FIG. 2 according to the first aspect of the present invention.

In case of the AI software 1100, “AI” refers to the ability of a computer to think and learn. The AI software 1100 usually has to go through various processes such as (i) problem definition, (ii) data acquisition and preparation, (iii) model development and training, (iv) model evaluation and refinement, (v) deployment of AI in actual products, and (vi) execution of machine learning operations. Since these processes are not completely independent of each other, but are interlinked, it may be desirable for the AI software to be communicable with an external third server (not shown) to efficiently assist the AI computing process, rather than limiting the AI scheduling service's capacity up to a pre-defined performance.

In FIG. 8, the AI software 1100 may include a generative AI tool 1110. The generative AI tool 1110 is responsible for receiving training data input and creating similar text, images, or media based on the patterns and structures of the input training data. In the present invention, a generative AI tool 1110 may be useful when automatically generating the UI 800 in FIG. 6 or the message 900 in FIG. 7.

Further, the present invention comprises a large language model (LLM) 1111 as a sub-model. Previously, the UI 800 in FIG. 6 and the message 900 in FIG. 7 contained non-text image or map information; and the multimodal foundation model (MFM) 1112 in the generative AI tool 1110, for example.

Meanwhile, the AI software 1100 in FIG. 8 may be based on machine learning (ML) tool 1120. For example, in order to execute a mobile video conference, a camera mounted on the user's smartphone terminal 100 to 130 may be used, and the video data captured by the user's camera may be used as a temporary storage in connection with the backup DB server 700.

As shown in FIG. 8, a machine learning tool 1120 may adopt a deep learning (DL) model 1121 that analyzes a given data by dividing the data into multiple layers. In addition, a supervised learning model 1122 can be adopted, including learning modeling, which inputs the desired analysis results in advance to induce the AI to produce output that better matches with the user's intent. By entering the expected value in advance before the AI's computation, the AI software 1000 may learn what kind of result would be desirable. On the other hand, it is also possible to adopt an unsupervised learning model 1123 in which the AI software 1100 imitates the training data on the neural network without having input of expected results in advance.

In addition, the AI software 1100 may have a natural language processing (NLP) tool (1130). This is due to the nature of the meeting. For example, the participant candidate details or meeting information to be analyzed in the present invention will contain a large number of human language, obviously.

The NLP tool 1130 may include a natural language understanding (NLU) model that allows machines to interpret a given sentence using lexicon, parsing, and grammar rules. Also, the natural language generation (NLG) model 1132 might be helpful when generating the email 920 in FIG. 7.

Further, the AI software 1100 according to the present invention includes a computer vision tool 1140. In particular, in the case of the present invention, it may sometimes be necessary to train AI software through the video recording input provided by the conference room camera 640, for example. Therefore, the computer vision 1140 tool for video data analysis is preferably included in the AI software 1100.

As for computer vision tools 1140, it is desirable to use an object detection model 1141 that appropriately extracts only the image data required for scheduling meetings. For example, since it is clear that the surrounding wall of the offline meeting room 690 illustrated in FIG. 5 may be a video data that has nothing to do with the meeting scheduling. Then, the AI software 1100 may exclude this image data of walls from the AI calculation.

The scene understanding model 1142 is also one of the AI models that can be adopted in computer vision tools 1140. The scene understanding model 1142 performs AI analysis on which of the objects contained in the image or video should be treated more importantly, and which objects have a certain level of importance or priority over others. From the machine's point of view, it may be just a group of pixels, but if we compare the image of the conference room wall in FIG. 5 with the image of the meeting attendees in FIG. 5, what is needed in the meeting scheduler service may be the image of the meeting attendees, and from this point of view, the scene understanding model 1142 may support the AI software 1100 for the purpose of the efficiency of the entire AI system 1000.

The face detection and recognition model 1143 is required for the analysis of the face, facial expressions, and mouth shape of the meeting participants (e.g., see FIG. 5) during video conferencing. This technology is an AI technology used in social media, photo cleaning apps, facial recognition security entry, and even criminal investigations, and can even infer the age of the person being analyzed by using, for example, the pupil reflex darkness related to age. It also may infer the gender, and emotions from facial expressions and appearance. The video data entered by the conference room camera 640 illustrated in FIG. 5 and the results of facial analysis of the meeting participants may be stored on the backup DB server 700.

The analysis results of the eye and gaze tracking model 1144 may be used for the present invention as well. The eye and gaze tracking model 1144 can be divided into two sub-fields. One is to determine the position of the eyes (“eye localization”), and the other is to find out the direction of the eye's gaze (“gaze estimation”). For reference, in eye analysis using AI, “eye” mainly refers to the pupil (including both dark pupil and bright pupil) and iris, and in addition to pixel data about the pupil and iris. The eye analysis also uses images or video information related to corneal reflection, or iris reflection, limbus, pupil contour, and eyelid (eyelid). In other words, eye localization focuses on accurately judging the existence and position of the human eye in a given image or video. The gaze estimation technology focuses on each frame of the image or video and tries to find out a person's current gaze status and the direction of gaze movement in three-dimensional space. For reference, it may be difficult to treat eye localization models and gaze estimation models equally. However, from the perspective of eye oculography, it would be possible to combine the two models and treat them as an eye and gaze tracking model 1144 as shown in FIG. 8. Since it is possible to analyze the gaze of the meeting participants during the meeting through the image data entered by the conference room camera 640 illustrated in FIG. 5, these meeting-related video records can be stored on the backup DB server 700.

For reference, when using AI software 1100 to track the eyes of meeting attendees, information about the position and posture of the meeting attendees' heads can be consulted. This information can be extracted, for example, from high-definition video data taken by any of the multiple cameras 640 shown in FIG. 5 from the appropriate angle. In short, the present invention proposes to mount an eye and gaze tracking model 1144 for the purpose of comprehensively analyzing information about the face, facial expression, body or head posture of the meeting participants, rather than simply performing AI analysis of the meeting participants by means of an eye and gaze tracking model 1144. Of course, if such eye/gaze analysis data is unnecessary for meeting scheduling, the eye and gaze tracking model 1144 may not be used for the first aspect of the present invention.

As shown in FIG. 8, a computer vision tool 1140 may include a motion analysis model 1145. For example, depending on the position of the head of the meeting attendees captured by the conference room camera 640 in FIG. 5, the eyelids may be shown as sometimes straight and sometimes oval in a single image, and thus defining parameters such as the shape of the eyelids may be exposed to errors. The motion analysis model 1145 is a technique for determining what actions are performed in the captured image based on two or more consecutive image sequences made by the camera that shoots the video, and such motion analysis data may be required for precise calculations of the eye and gaze tracking model 1144.

Finally, computer vision tools 1140 are used to analyze text recognition models, such as optical character recognition (OCR) model 1146 which can be included in the AI software 1100. This is an auxiliary means of the aforementioned scene understanding model 1142 but it may be helpful to some extent in AI analysis according to the first aspect and embodiment of the present invention.

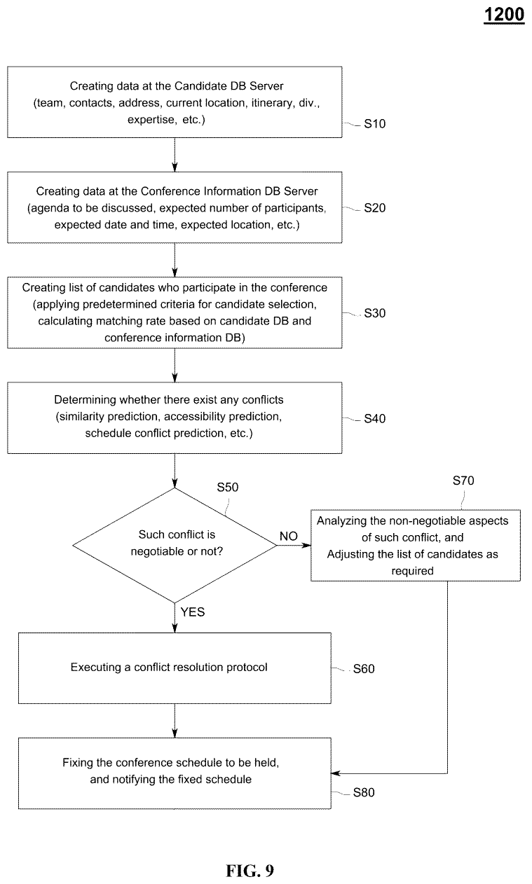

FIG. 9 is a flowchart for illustrating an illustrative AI meeting scheduler service algorithm 1200 implemented by AI software according to the first embodiment of the present invention.

Referring to FIG. 9, firstly, in step S10, a candidate DB server 400 should be generated within an AI meeting scheduler system 1000 according to the present invention, and in step S20, a meeting information DB server 500 should be generated.

Regarding the candidate DB server 400 created in step S10, the AI meeting scheduler server 300 may access the candidate DB server 400 from step S30 while the candidate DB server 400 stores, updates, and manages information that includes at least one of the followings: contacts of the group likely to attend the meeting, the contact information of the individual, the personal address, the person's current location, the personal schedule or work schedule, the information (such as the organizational chart in FIG. 4) of the organization they belong to, or the information of the individual's specialty or expertise. The candidate DB server 400 may contain more information such as the device model type or device performance information of the smart devices used by each individual or organization for accessing meetings and meeting scheduling information.

The meeting information DB server 500 is generated in step S20 including database of the meeting information that includes at least one of the following: the meeting agendas, expected number of participants for the potential meetings, expected meeting schedules, or expected meeting locations. In addition, information about whether the upcoming meeting can also be participated by online teleconference may be included in the meeting information DB server 500.

For reference, step S10 and step S20 can be performed simultaneously in parallel or sequentially, and it is also okay if the order of step S10 and step S20 does not interfere with step S30 to be performed by the AI meeting scheduler server 300.

In the process of performing step S10 and step S20, the AI meeting scheduler system 1000 according to the present invention generates a meeting room management DB server 600 comprising information about the availability of each meeting room, available device or meeting equipment information, or meeting room's physical location.

In step S30, as described above, the AI meeting scheduler server 300 accesses the candidate DB server 400 and the meeting information DB server 500 to calculate the match rate between the selection criteria and the accessed DB information, and generates a list of candidates for meeting participants based on the match rate and the prescribed selection criteria to be specifically applied to the present invention. At this time, the AI meeting scheduler server 300 can additionally access the meeting room management DB server 600 to optimize the scheduling.

However, in order for the AI meeting scheduler server 300 to confirm the schedule of the scheduled meeting, the explicit or implicit approval of the meeting participant candidate included in the meeting participant candidate list is required. As mentioned earlier, the meeting organizer's final approval on the AI-scheduled meeting may not be necessary if the AI meeting scheduler server 300 has been delegated all the authority to set the schedule from the meeting organizer. In addition, participants' explicit approvals refer to a case where the schedule is confirmed through the approval button described above. (see, 816, 826, 928 for example) However, in order to determine the schedule of a meeting to be held, the present invention proposes to further determine whether there is a reason for failure of the AI meeting scheduler server 300 in scheduling the meeting in step S40. Here, the reason for failure is the reason that makes it difficult to calculate the possibility of successful scheduling in the prediction process executed by the AI software 1100. The prediction process executed by the AI software 1100 may include the following three things: the prediction of similarity based on the meeting agenda, organization information, or at least one of the above-mentioned individual expertise information; the prediction of accessibility from the personal address or the mentioned current location to the expected meeting location; and the prediction of the possible scheduling conflicts between the expected meeting schedule and the personal or work schedule.

In Step S50, the AI determines whether the reason for the failure recognized by the AI software 1100 in Step S40 is negotiable or not. As explained earlier, for example, if a fixed schedule with a high priority overlaps with the schedule of a potential meeting, that is a case where the reason for the failure would be marked as non-negotiable, in which case the AI meeting scheduler server 300 goes to step S70 and analyzes concretely the reason why the situation is non-negotiable (e.g., there is a schedule with a high priority and overlapping dates), and if necessary, performs adjustments such as adding/deleting/replacing the list of meeting participants created by step S30.

If the reason for the failure is negotiable, the AI meeting scheduler server 300 in step S60 will resolve the reason for the failure described above according to the prescribed conflict resolution procedures. For example, if the priority of the meeting to be held is the highest, the schedule conflict problem is resolved by automatically notifying candidates of overlapping schedules using the messenger module 380 to highlight that the highest-priority meeting schedule may overlap with his or her work schedule.

When Step S60 or Step S70 is completed, the AI meeting scheduler server 300 in Step S80 notifies the contacts (such as personal email or team email accounts) of the individual or group (e.g., setting up team meeting participants) on the list of potential meeting participants of the fixed meeting schedule.

### Second Embodiment

Now, the second embodiment of the present invention will be described in detail with reference to the attached drawings.

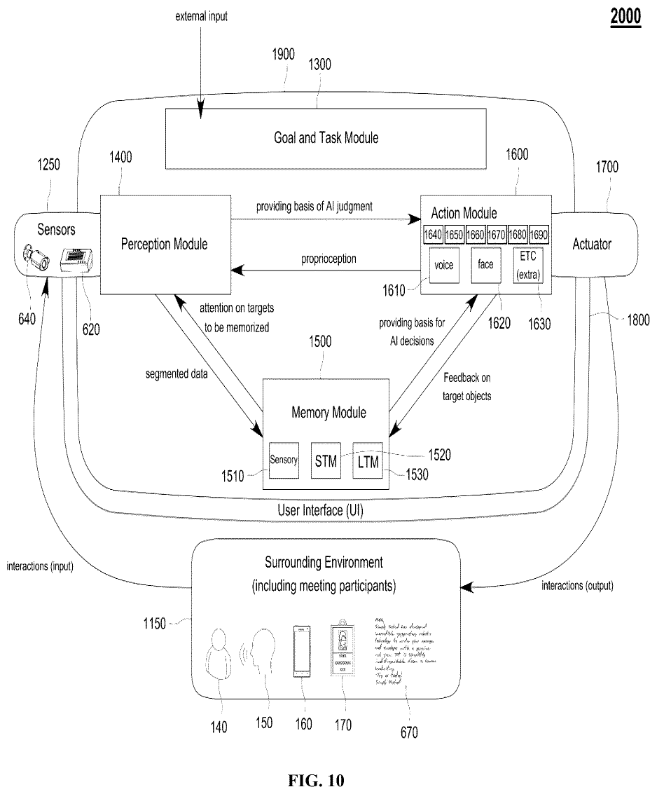

FIG. 10 is an illustrative drawing showing an AI-based automatic participant recognition system 2000 and an AI meeting management agent 1900 according to the second embodiment of the present invention. Here, the AI meeting management agent 1900 can be implemented as an “AI meeting management server,” and in this case, the target object that interacts with the user interface 1800 among the surrounding environment 1150 shown in FIG. 10 will be the “client” in view of the AI meeting management server. For reference, the AI-based automatic participant recognition system 2000 may be referred to as the “AI meeting system 2000,” for the purpose of conveniences.

The second embodiment of the present invention aims to confirm exactly who the person participating in the meeting is. For example, when holding a board meeting for important decision-making of a company, the list of participants who actually participated in the board of directors meeting should match with the list of participants, for example, registered in the company's articles of incorporation and company regulations.

In order to automatically recognize the actual meeting attendees in such a situation where it is very important to determine who the meeting attendees are, the present invention determines that it is desirable to introduce an AI meeting management agent 1900 as shown in FIG. 10. This is true even if the board meeting mentioned above is held online or as a written alternative meeting. This is because the process of board members presenting their opinions for or against important corporate decision-making issues and confirming whether they have signed relevant documents such as minutes by themselves is a necessary procedure regardless of the type of meeting, such as online video conference, telephone conference, or offline meeting.

Referring to FIG. 10, an AI meeting system 2000 using AI software 1100 according to the second embodiment of the present invention includes an environment 1150 and an AI meeting management agent 1900. An AI meeting management agent 1900 can be regarded as an AI machine that performs a kind of role similar to a meeting host or organizer in the present invention. For example, an in-house hardware or software-type AI system authorized to check who the meeting attendees are could become an AI meeting management agent 1900.

Thus, in the present invention, the objects mainly included in the surrounding environment 1150 are meeting participants 140, meeting participants who are speaking 150, and a person who remotely accesses the meeting with a smartphone 160. In addition, the employee ID card 170 worn by the meeting participants 140 or 150, the 680 of the meeting in the meeting room 690 can be considered as the surrounding environment 1150 to be the main object of AI analysis in the present invention. For reference, the meeting minutes 680 shown in FIG. 10 may be physical meeting minutes stored somewhere in the offline conference room or onsite meeting room 690 in FIG. 5, or minutes 680 may be electronic documents (not shown) that can be accessed by the AI meeting management agent 1900.

To be clear, it should be noted that the users 100, 110, 120, 130 in FIG. 1 can be the virtual meeting attendees 660 or the actual (that is, onsite) meeting attendees 670 in the meeting room 690 in FIG. 5. Similarly, the meeting participants 140, the speaking person 150, or a user of smartphone 160 in FIG. 10 may be equal to some of the users 100, 110, 120, 130 or some of onsite meeting attendees 670 or virtual meeting attendees 660 in FIG. 5 although such distinction might be meaningless in explaining the present invention. The employee ID card 170 or minutes 680 may be physically found in the meeting room 690 or in a video footage captured by the camera 640. The offline meeting system 600a in FIG. 5 may be a physical part of the meeting room 690. Because meeting room cameras 640, a speakerphone 620, user devices 610 and smart TV 630 may all be used to provide video or audio footage for AI analysis according to the second embodiment of the present invention, the reference number 650 is now designated to refer to “meeting room sensors 650.” However, a new reference number 1250 will be used to designate the “AI agent sensors 1250” because AI agent sensors 1250 does not have to be physical sensors installed in an onsite meeting room 690 as in FIG. 5.

The AI meeting management agent 1900 according to the present invention consists of a plurality of AI agent sensors 1250, a target and task module 1300, a perception module 1700, a memory module 1500, an action module 1600, an actuator or effector 1700, and a user interface 1800 as shown in FIG. 10.

For the purposes of the second embodiment of the present invention, an AI meeting management agent 1900 may be a virtual conference monitoring agent that interacts with the environment 1150 under the goal of “accurate confirmation of the actual meeting attendee list”.

The AI meeting management agent 1900 receives various types of multimedia information such as audio, video, or text from the surrounding environment 1150 by using the AI agent sensors 1250. More specifically, the AI meeting management agent 1900 may recognize the surrounding environment 1150 by using the laptop camera of a user's smart device 160 or 610 capable of transmitting images via the network; meeting room cameras 640; or the speakerphone 620 installed in the meeting room 690 in FIG. 5. In other words, the AI agent sensors (1250) are the tool that comprehensively receives (i.e., collects “raw data”) of the necessary meeting-related information before the AI meeting management agent 1900 can determine who the actual meeting attendees are.

Furthermore, an AI meeting management agent 1900 may be an autonomous software program that perceptions data received from the surrounding environment 1150 by the perception module 1400 and takes action to achieve the goal. AI meeting management agents 1900 perform intelligent behaviors, sometimes as simple as rule-based systems, or as complex as high-performance machine learning (ML) models 1120 as depicted in FIG. 8.

The AI meeting management agent 1900 of the present invention can identify meeting attendees by itself using a predetermined meeting attendee identification algorithm and an AI training model, and may make a re-evaluation of the identification results. In other words, the AI meeting management agent 1900 has the ability to continuously learn whether the participant recognition results by the action module 1600 match the actual participant list and develop itself to enable better identification of meeting attendees. Therefore, the AI meeting management agent 1900 can operate independently without human control or constant input (such as manually entering a list of participants into the AI or commanding the AI to directly determine the behavior of the AI).

For reference, there is a concept that needs to be distinguished from an AI meeting management agent 1900 in the present invention, and that is Artificial Intelligence Tools. AI tools may look similar to AI meeting management agent 1900 in that they are software programs for automating tasks, but the two are distinct concepts as explained below.

That is, (i) as mentioned above, in the present invention, the AI meeting management agent 1900 has the autonomy to perform a given role independently without requiring constant human intervention, unlike an AI tool. (ii) In addition, in the present invention, the AI meeting management agent 1900 is equipped with a perception module 1400 and a memory module 1500 that enable the detected information to detect the surrounding environment 1150 and remember the detected information using AI agent sensors 1250 such as a camera 640 or a speakerphone 620. (iii) AI meeting management agent 1900 has the ability to evaluate the surrounding environment 1150 and react accordingly to achieve the goal of “accurate identification of meeting participants”, unlike AI tools. In addition, (iv) the AI meeting management agent 1900 can reason through a predetermined algorithm that processes the information, and based on this, it can make appropriate decisions (such as decision making, i.e., determining the identity of the participant), and (v) it is possible to enhance the AI agent's own performance through learning and self-evaluation such as machine learning (ML) 1120, deep learning 1121 or reinforcement learning 1124 which will be discussed later with reference to FIG. 8 again.

In addition, (vi) in case of an AI meeting management agent 1900, it is possible to communicate with other AI agents or humans, including the process of understanding natural language and responding according to that understanding, and may also use methods such as speech recognition or text/image/video exchange. (vii) The goals that the aforementioned AI meeting management agent 1900 wants to achieve may be preset, but it is also possible for the AI to learn the goal by interacting with the surrounding environment 1150. In the case of AI tools, you may not need the goal setting function equivalent to the AI meeting management agent 1900.

Although the surrounding environment 1150 was briefly described earlier, in an AI meeting system 2000 using AI according to the present invention, the surrounding environment 1150 is the object or target of interaction of the AI meeting management agent 1900. Here, interaction means both the aspect of receiving information such as audio, video, and text from the surrounding environment of the conference room 690 (i.e., input from the surrounding environment 1150) and the aspect of reacting to the surrounding environment 1150 (e.g., giving an order to leave the meeting room 690 with voice output to an unauthorized meeting participant (not shown)). Therefore, for example, if the current attendee 150 at a meeting asks the AI meeting management agent 1900 to re-identify the attendee 150 because there is an error on the AI's identity judgment about him or her 150, the AI meeting management agent 1900 may recognize the voice of the meeting attendee 150 again, analyze it again, and then go through the process of re-identifying the meeting attendee 150's identity at the request of the meeting attendee 150.

The AI agent sensor 1250 refers to a hardware or software tool that enables the AI meeting management agent 1900 to identify meeting participants and other situations related to the conference room in various ways, such as multiple surveillance cameras (for video/voice recognition, see 640 in FIG. 5), security access doors (for security control-related information collection, and non-communication, not shown in figures), and speakerphones (for voice recognition, see 620 in FIG. 5) installed in the conference room 690.

The perception module 1400 performs the function of storing a large amount of data collected from the AI agent sensors 1250 in a memory module 1500, for example, in a certain time unit, and sometimes the perception module 1400 directly transmits video and audio data to the action module 1600, so that the action module 1600 helps AI to determine the identity of the meeting participants.

For reference, the objectives and task modules of the AI meeting management agent 1900 according to the present invention can automatically generate “specific tasks” for achieving the goal, such as “applying a complex identity judgment algorithm by combining the facial recognition and voice recognition results of the meeting participants today” when a more general “goal” like “accurate identification of meeting participants” is given to the AI. In the present invention, the goal and task module 1300 focuses on increasing the feasibility of the goal by allowing the AI meeting management agent 1900 to select and focus only on what is relevant to the goal from a vast amount of data from the AI agent sensors 1250.

Based on the information recognized by the AI agent sensors 1250, the content of the meeting participants' speech, the intention to speak, or the progress of the meeting can be analyzed by the NLP (Natural Language Processing, 1130, see FIG. 8) tool, and for example, the eyes, facial expressions, mouth shapes, etc. of the meeting participants can also be analyzed through the image information input from the conference room camera 640 to infer the meeting participants intent that was not spoken. If this inference can help identify participants, the inferred data will be available in a category called “other perceptions” or “extra perceptions” when identifying participants.

Similarly, the memory module 1500 also pays attention to the information collected from the AI agent sensors 1250 likely to meet the objectives (such as video taken by a specific attendee, speech recognition data of a specific attendee, etc.) based on the goals and tasks set by the objectives and task modules 1300, so that the action module 1600 can present optimized evidence data for AI judgments related to attendee identification. For reference, since the configuration of the memory module 1500 in the present invention imitates the human brain, it would be worthwhile briefly looking at the memory structure of the human brain before further explaining the memory module 1500 itself.

In a human brain, sensory memory refers to the memory of visual, auditory, and tactile sensations for one second to a few seconds. It can be said that it is the first place where information about all stimuli in the external environment is stored, so the capacity of sensory memory is very large. However, as for humans, it is known that 99% of information in the sensory memory disappears (i.e., human forgets) unless special attention is paid to it. Thanks to this short-lived sensory memory, the brain can recognize things as if they were looking at things continuously, for example, even when a man blinks his eyes.

The short-term memory (STM), sometimes called working memory, is a temporary repository that can remember up to 7 items in about 20-30 seconds when a human selectively pays attention to the above sensory memory information, and information that has not been organized or encoded (converting information from one form to another) will be also forgotten. The STM is necessary to perform complex cognitive tasks such as learning and reasoning, and for this purpose, cognitive activities such as memorizing something repeatedly are called “working memory”. It is well known that phone numbers are usually made up of seven numbers, which is also based on the above-explained characteristic of working memory.

The long-term memory (LTM) refers to a human memory that stores information for a long period of time, i.e., from a few days to decades. Usually, when a stimulus above the threshold is repeated, the information that humans experience with their bodies corresponds to this, and long-term memory is further classified as (i) a first type called explicit memory, declarative memory, or conscious memory, and (ii) a second type called implicit memory, non-declarative memory, procedural memory, or unconscious memory.

As for the second type, it refers to skills and habits that someone has unconsciously acquired, such as riding a bicycle or keyboard typing skill. The first type of memory refers to what humans remember because they want to remember facts and experiences that can be described in language. The first type of long-term memory includes episodic memory and semantic memory. Among them, anecdotal memory refers to memories that are consciously remembered and subjectively reexperienced based on the source and context of time, space, and situation. Semantic memory refers to a kind of fact, knowledge, or concept that has nothing to do with the spatiotemporal context, and long-term memory that gives the feeling of knowing something and does not depend on the context may belong to this category.

It is desirable that the memory module 1500 of the AI meeting management agent 1900 according to the present invention is constructed virtually the same as the memory structure of the human brain described above. In other words, as shown in FIG. 10, the memory module 1500 according to the present invention is divided into sensory memory 1510, short-term (STM) memory 1520, and long-term (LTM) memory 1530.

In a sensory memory 1510, for example, there may be a space to store the video data of the surrounding environment 1150 received by the conference room camera 640 (i.e., video storage space), a space to store all kinds of voice data including noise in the conference room received by the speakerphone 620 in the conference room 690 (i.e., voice storage space), and a physical or logical space (other storage space) to store data such as language characters.

In case of the STM memory 1520, just like in the human brain, this may include working memory. The working memory can be used as a space to store the input of instructions or prompts and conversation history in the STM memory 1520 for a short period of time. In addition, an interactive buffer space that temporarily stores a certain number of interaction history performed by an AI meeting management agent 1900 according to the present invention also may belong to the STM memory 1520. If the LLM model 1111 is adopted, it is possible to effectively process long contents in STM memory 520 by periodically summarizing the conversation history of the LLM 1111, even if it has some big amount of content.

In the present invention, the LTM memory 1530 imitating the human brain can also be applied to the AI meeting management agent 1900. In the case of LTM memory 530 that can be adopted by an AI meeting management agent 1900 pursuant to the present invention, it may include an episodic memory that stores anecdotal memories, wherein the AI meeting management agent 1900 stores the history of past interactions between users (including the surrounding environment 1150 such as meeting participants and other meeting participants), thereby helping the AI meeting management agent 1900 to make better choices from past successes or failures when encountering similar environments. The episodic memory uses a relational database, file storage, or vector database to store anecdotes or experiences related to the AI meeting management agent 1900 and extract them as needed. In addition, the AI meeting management agent 1900 may include a semantic memory that corresponds to a human semantic memory. The semantic memory is a means of storing general knowledge and concepts that are independent of the source and context of specific events or time, space, and situation, similar to the aforementioned human brain, and can be used to store factual information about the surrounding environment (i.e., the world), and to record and interpret the meaning of words and the relationship between concepts. The semantic memory may be a very important configuration for the AI meeting management agent 1900 according to the present invention because it helps the AI meeting management agent 1900 to understand the context of meetings so that it can efficiently respond to user queries (e.g., questions related to identity verification). The LTM memory 1530 includes procedural memory corresponding to the human's procedural memory mentioned above. By this procedure memory, an AI meeting management agent 1900 according to the present invention is able to learn the optimal meeting participant identification model within a given environment, for example, through the reinforcement learning technique shown in FIG. 8.

In case of the action module 1600, the generative AI tool 1110 in FIG. 8 can be used to generate text, images, and content related to various meetings in various multimedia forms from specific patterns learned by the AI meeting management agent 1900 or data collected from the surrounding environment 1150, and interact with the surrounding environment 1150 through the actuator 1700 or user interface 1800 shown in FIG. 10. For reference, the action module 1600 can also give feedback related to proprioception to the perception module 1400, where proprioception refers to the mechanism that allows the brain to recognize the position and movement of body tissues, taking the human body as an example. Attempts have been made to apply this concept of proprietorship to AI Neural Networks, but since the core of the present invention is not related to proprioception, detailed explanations will be omitted here.

For the purposes of the present invention, an actuator 1700 is a device for moving and controlling a system or machine, and if the AI meeting management agent 1900 is a software type (i.e., not a physically configured AI agent), it may be a software module that transmits text messages to the surrounding environment 1150 or answers questions raised by meeting participants 150 who were speaking out. The actuator 1700 does not necessarily have to perform an externally recognizable act, and sometimes it can also be used to simulate what the consequences will be when performing a certain task. However, in order for the actuator 1700 to interact more efficiently with the surrounding environment 1150, a user interface 1800 may be provided as shown in FIG. 10, for example, so that the user may easily interact with the AI meeting management agent 1900 for identifying meeting attendees or other matters related to the progress of the meeting while looking at the display screen output (not shown) from the AI meeting management agent 1900.

As mentioned earlier, in the present invention, an AI meeting management agent 1900 can be referred to as a virtual conference/meeting manager designed to identify meeting attendees. However, even if it is a virtual manager, it can be implemented as a 3D avatar having the user interface 1800, and the AI meeting management agent 1900 can interact with the surrounding environment 1150 by that 3D avatar. In other words, the user interface 1800 of FIG. 10 is a channel that allows an AI meeting management agent 1900 according to the present invention to exchange information or exchange questions and answers between a large number of meeting participants included any other targets in the surrounding environment 1150.

The user interface 1800 can be operated based on a web browser, or it can perform multimedia exchange operations according to RTP (Real-time Transport Protocol) protocols, etc., based on multimedia sessions established by conference protocols such as SIP (Session Initiation Protocol). In addition, the communication interface installed in the user interface 1800 is also responsible for providing answers in the form of materials, text, and images in response to the meeting participants' requests (i.e., transmitting them to participants by a wired and wireless network) immediately at the meeting site or online when meeting participants request a basis for identifying participants during the meeting.

For reference, in order to understand the queries of the meeting participants received by the user interface 1800 and to produce responses to them, or for the AI meeting management agent 1900 to output voice as an action that is deemed necessary for the proceeding of the meeting, AI processing by the NLP 1130 shown in FIG. 8 is essential. With NLP 1130, meeting participants will be able to experience a significant improvement in the experience related to meeting participation as users, and AI agents will be able to perform important actions such as interacting and learning with meeting participants with higher performance. In some cases, the NLP module 1130 of the AI meeting management agent 1900 may translate, for example, into appropriate computer search terms and retrieve the appropriate answers from knowledge databases (not shown in FIG. 10) or other data on the web and present them to the questioner.

In short, in the AI meeting management agent 1900 according to one embodiment of the present invention, perception 1400, action 1600, and memory module 1500 are intertwined for the function embodiment of the AI meeting management agent 1900, that is, the function of accurately identifying meeting participants. The AI meeting management agent 1900 according to the present invention may use the actuator 1700 to make decisions in a predetermined unit of time and put them into action. The information transfer between the three modules of perception 1400, action 1600, and memory module 1500 can be bidirectional, and the changes occurring in each module 1300, 1400, 1500, 1600, 1700, 1800 may affect other modules. For example, when a goal or task is adjusted, it affects all modules of perception 1400, action 1600, and memory module 1500.

Now referring back to FIG. 8, the AI software 1100 installed in the AI meeting management agent 1900 refers to the ability of a computer to think and learn. Such capabilities can be implemented in the form of a combination of hardware and software, such as NVIDIA® A1800 40 GB Active GPUs, NVIDIA® ConnectX-6 Dx networking SmartNICs, or CPUs to enhance AI computing power.

Further, the present invention comprises the LLM model 1111. The objective and task module 1300 of the AI meeting management agent 1900 according to the present invention can extract multiple tasks by analyzing the target in natural language format input from the outside by LLM, and the task can sometimes be appropriately modified to reflect the execution results according to the action module 1600 later.

In the present invention, the AI meeting management agent 1900 receives and processes text, image, audio and video data through the AI agent sensors 1250 to determine the identity of meeting participants, so that the MFM 1112 may be included in the generative AI tool 1110.

The reinforcement learning (RL) model (1124) shown in FIG. 8 is a branch of machine learning that focuses on decision-making to maximize cumulative rewards in a given situation. In the case of the supervised learning model 1122 mentioned above, the AI is trained with training data with predefined answers, while the reinforcement learning model 1124 performs actions in an uncertain and potentially complex environment and the AI software 1100 attaches the goal by receiving feedback through rewards or penalties. One of the important things in the reinforcement learning model 1124 is “policy,” which refers to the strategy used to determine how to do the next action to achieve the best results. In fact, it is pointed out that reinforcement learning is not suitable for solving simple problems, and in a situation where the AI meeting management agent 1900 needs to make decisions to identify the actual meeting participants, the reinforcement learning model 1124 can be of great help to the decision-making of the action module 1600 of the present invention.

On the other hand, the AI software 1100 according to the present invention may have a type of natural language processing (NLP) tools 1130. This is because, due to the nature of the meeting, not only the setting of goals and tasks at the goal and task module 1300, but also the surrounding environment 1150 which is the object of analysis in the present invention, that is, the details of the candidate, the meeting information, the content of the remarks of the meeting participants, and the name and rank written on the employee card 170 will naturally be written in human language. If the AI agent sensors 1250 detect a language that is different from the default language used by the AI meeting management agent 1900, it may need to perform translation functions during the natural language processing.

The NLP tool 1130 may include a natural language understanding model 1131. Also, the natural language generation model 1132 can be very useful for the second aspect of the present invention when AI should interact with the surrounding environment 1150 through the actuator 1700 shown in FIG. 10.

In the case of computer vision tools 1170, it is desirable to use an object detection model 1141 that appropriately extracts only the image data that is essential for the identification of meeting participants in order to reduce unnecessary AI calculations. In other words, since it is mainly human attendees that should be analyzed by the second embodiment of the present invention, the overall efficiency of the AI operation by selecting and concentrating the AI operation on the object that is classified and identified as a human may improve the total operation volume and operation speed of the AI software 1100, and further affect the identity identification performance or accuracy of the AI-based automatic participant recognition system 2000 according to the present invention.

Likewise, the AI-based automatic participant recognition system 2000 may have to use the scene understanding model 1142 which is one of the AI models that can be adopted in computer vision tools 1140. The scene understanding model 1142 performs AI analysis on which of the objects contained in the image or video should be treated more importantly, and which objects have a certain level of importance or priority over others in view of identity detection. The AI software 1100 installed in the AI meeting management agent 1900 might understand the currently recognized meeting situation and context through the scene understanding model 1142.

The AI-based automatic participant recognition system 2000 according to the second embodiment of the present invention uses the face detection and recognition model 1143 because it is necessary to analyze faces, facial expressions, and mouth shapes of meeting participants during video conferences, for example. Even if it is not a video conference, if a conference room camera 640 is installed, it may be possible to find out the identity of the meeting attendees based on the image analysis of the meeting attendees 140, 660, 670 and to understand the intentions of the meeting speaker 150. In fact, the face detection and recognition models 1143 are AI technologies that are already being used in social media, photo cleaning apps, facial recognition security entry, and even criminal investigations, as explained above.

Moreover, the AI-based automatic participant recognition system 2000 according to the second embodiment of the present invention may have to use results of the analysis of the eye and gaze tracking model 1144. The action module 1600 should make certain decisions according to the present invention, and in addition, in the case of video conferencing, it can be used as a means to grasp the progress of the meeting as a data to judge whether the human meeting participants 140, 150, etc., are properly concentrating on the meeting. In the case of the present invention, for example, if a camera image is captured in which another meeting attendee, e.g., 140, focuses on a speaker, e.g., 150, during a meeting, the AI software 1100 may recommend that the memory module 1500 have the perception module 1400 draw attention to the speaker 150, and the memory 1500 may encode the voice and video data related to the speaker 150 so noted into the short-term or long-term memory as described above.

Moreover, the AI-based automatic participant recognition system 2000 according to the second embodiment of the present invention may have to refer to information about the position and posture of the meeting attendees' heads. This information is also relevant to the situations where some cameras 640 are installed in multiple locations in a conference room 690, which of them can capture high-quality video data from the most appropriate angle to identify a participant. In short, the present invention proposes to mount an eye and gaze tracking model 1144 for the purpose of analyzing the identity and the intention of the meeting participants' speech by synthesizing information about the face, facial expression, body or head posture of the meeting participants, etc. If there is a concern about excessive privacy invasion (especially when identifying people by AI), or if it is not possible to obtain high-quality video data to run the eye and gaze tracking model 1144, the eye and gaze tracking model 1144 may be operated in a deactivated state in the second embodiment of the present invention.

As shown in FIG. 8, computer vision tools 1140 may include motion analysis models 1145. For example, depending on the position of the head of the meeting attendees in the meeting room camera 640 in FIG. 5, the eyelids can be shown as sometimes straight and sometimes oval even in a single image, so defining parameters such as the shape of the eyelids must be a certain shape may lead to errors in accurate gaze analysis. The motion analysis model 1145 is a technique for determining what actions are performed in the captured image based on two or more consecutive image sequences made by the camera that shoots the video, and such motion analysis data may be required for precise calculations of the eye and gaze tracking model 1144. Therefore, the AI-based automatic participant recognition system 2000 according to the second embodiment of the present invention may beneficially utilize the motion analysis model 1145.

Finally, computer vision tools 1140 are used to analyze text by using some models, such as the OCR model 1146. This might be an auxiliary means of the aforementioned scene understanding model 1142, which can be helpful to some extent in AI analysis. Since a meeting may not rely solely on verbal discussions among meeting participants, but also on documents such as meeting presentation materials and various data that serve as the basis for decision-making (e.g., meeting minutes 670), the present invention may require a technology to recognize text from video data including text.

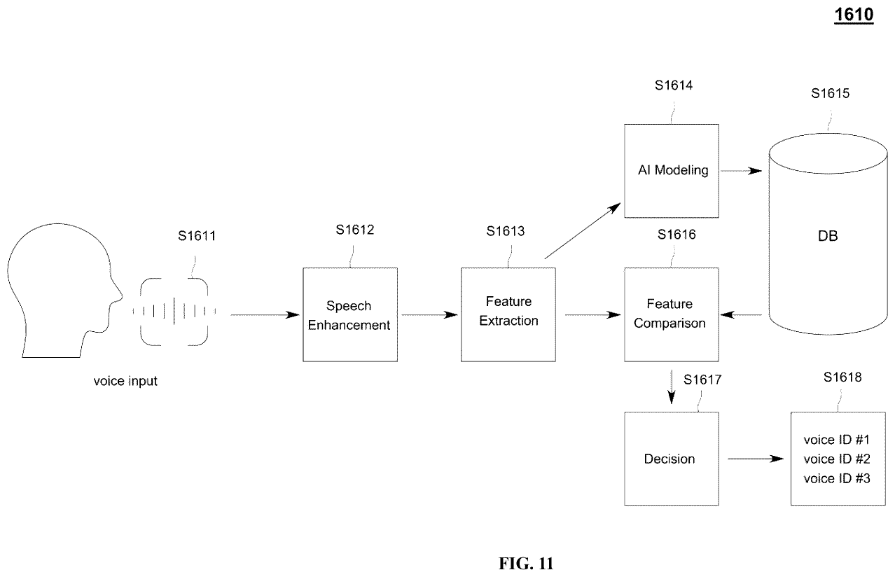

FIG. 11 is an illustrative drawing illustrating the process of identifying meeting participants in terms of speech recognition by using the voice judgment module 1610 in the action module 1600 according to the second embodiment of the present invention. In the present invention, the core is to independently use at least two or more identification means for voice recognition, facial recognition, and “extra identification” to derive the primary identity verification result, and to perform the final identity verification by combining the independently obtained identity verification results. FIG. 11 represents a procedure for verifying the identity of a meeting participant in terms of speech recognition among the core processes of the present invention, and such identification or participant identification procedure is mainly performed in the action module 1600 of the AI meeting management agent 1900.

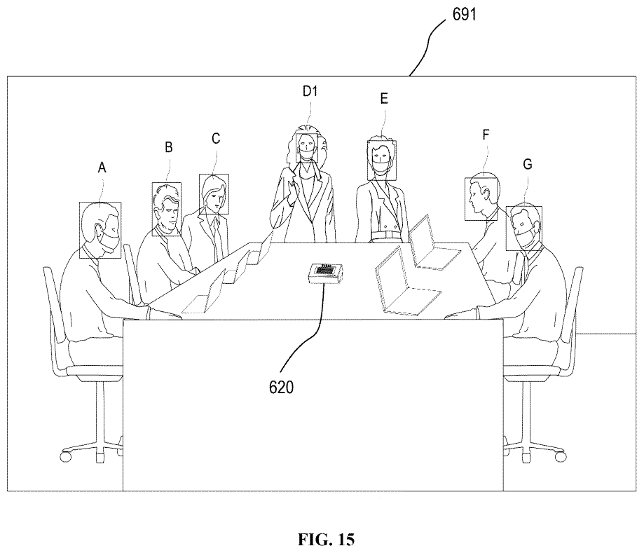

Referring to FIG. 11, for example, by using a speakerphone 620 in a conference room 690 in FIG. 5 or 15 as the AI agent sensors 1250, it is possible for the voice judgment module 1610 to recognize the voice of a meeting participant 140 and 150 at step S1611. If a microphone dedicated to the speaker is installed in the conference room 690, such a microphone can also be a sensor 1250 for voice recognition. If the conference room camera 640 can record voice in addition to video, the conference room camera 640 can also be a voice recognition sensor 1250 for the speech recognition process of the voice judgment module 1610 according to FIG. 11.

In step S1612, a speech enhancement process is performed on the recognized speech. Here, the clarity of the voice may be improved by removing unnecessary background noise from the recognized speech. If the voice reinforcement technique is used in Step S1612, it is possible to recognize the words of the speaker 150 more easily and clearly, for example.

In step S1613, a process called feature extraction is performed. In the present invention, a method is proposed to analyze the continuously input voice by dividing it into frame units, for example, at 25 ms intervals. Generally, if the speech is about 25 ms long, the AI software 1100 can check what the content is. Moreover, in general, there is no sudden change in speech or speech content within an 85 ms frame, and thus a 25 ms frame interval is suggested. For the purposes of the present invention, the “feature” of speech refers to a voice pattern that each individual has uniquely, which includes rhythm, pitch, frequency, timbre, etc. For reference, since the shape and structure of the vocal cords vary from person to person, the wave shape of the voice varies from person to person, and this can be used as one of the characteristics to confirm a person's identity.

The speech-related features extracted from Step S1613 can be converted into mathematical modeling by AI software 1100 and statistical techniques at step S1614. In step S1615, for example, the voice modeling of the speaker 150 is compared with the vocal fingerprint database (DB, not shown) stored in memory module 1500. For example, if the size of meeting participants to which the present invention applies is 2000 internal employees at a particular company, a vocal fingerprint that can uniquely identify each of those 2000 people by voice is stored as a database in the memory module 1500, and the action module 1600 compares the vocal fingerprint of 2000 people stored in the memory module 1500 with the voice modeling of each speaker, e.g. 150, when reading the vocal fingerprint from the database (not shown).

In order to simplify the amount of computation in step S1615, the AI meeting management agent 1900 can be provided with a list of participants for this meeting, and the AI meeting management agent 1900 can be configured to try to match only the vocal fingerprints corresponding to those included in the list at step S1615. However, if the vocal fingerprint comparison is made only within the scope of the list provided to the AI meeting management agent 1900, the fingerprint comparison process will be carried out by excluding the possibility that the vocal fingerprint might correspond to any of around 2000 employees in the company. Thus, the present invention proposes to take the vocal fingerprint database of all personnel belonging to a specific size of organization to which the present invention is applied.

On the other hand, features extracted from Step S1613 can also be directly transferred to Step S1616 to execute feature contrast algorithms. Regardless of whether it goes through step S1614, in the end, in step S1617, the voice judgment module 1610 of the action module 1600 determines whether there exists anyone whose match rate turns out to be above a predetermined threshold level by using the vocal fingerprint, and in step S1618, the identification information such as employee number and name of one or more candidates is extracted. For example, if the speech of the speaker, e.g., 150, in FIG. 10 is compared with the vocal fingerprints of 2000 internal employees, and the vocal fingerprints of three people show a match rate over 95%, the action module 1600 may determine that these three are the candidates (that is, candidate to be a person who actually attended a meeting) based on the voice judgment module 1610.

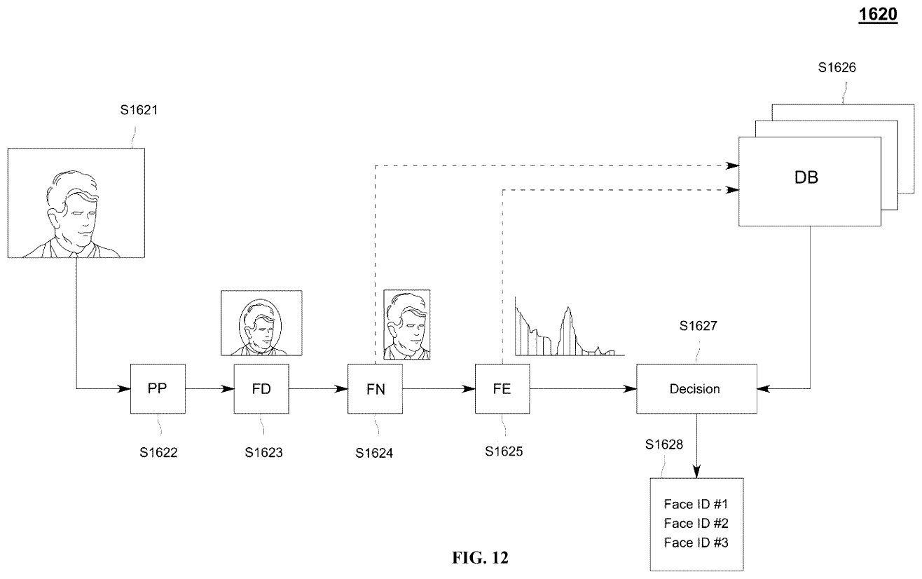

Next, FIG. 12 is an illustrative drawing showing the process of identifying meeting participants in terms of facial recognition by using the “face judgment module” 1620 of the action module 1600 according to the second embodiment of the present invention. As shown in FIG. 11 above, the facial recognition process of the face judgment module 1620 refers to the procedure for confirming the identity of a meeting participant in terms of the technology of AI facial recognition among the core processes for identifying meeting participants based on the present invention, and such identification or participant identification procedure will be mainly performed in the action module 1600 of the AI meeting management agent 1900, as in the case of vocal fingerprint verification in FIG. 11.

Referring to FIG. 12, in step S1621, AI meeting management agent 1900 uses a conference room camera 640 to collect the overall video footage of the seven meeting participants A, B, C, D1, E, F, and G in the conference room image or video 691 illustrated in FIG. 15.

In step S1622, an AI meeting management agent 1900 performs a task called pre-processing (PP) on the collected video footage, which is a step to speed up the facial recognition process, simply removing images from the video other than the face. To this end, the Linear Image Transform (LIT) technique, which ignores scanned images that turn out to be non-faces, the Regional Minima (RM) technique, which removes video fragments that are not faces, and other Perona-Malik Diffusion (PMD) techniques can be applied at step S1622.

For reference, the present invention proposes to convert an image to a gray scale during preprocessing operations. For example, before removing noise from the conference room image or video 691, only the image fragments in small boxes depicted in FIG. 15 corresponding to each face can be analyzed separately, and then the detected facial area can be converted into a grayscale image so that the facial image processing process can proceed more efficiently. In step S1621, various color components can be extracted from the input color image, and the weight of R color, G color, and B color can be applied to each position (i, j) coordinate of each image pixel, for example, to change an RGB image into a grayscale image according to the following formula:

Gs(i,j)=0.2989*R(i,j)+0.5870*G(i,j)+0.1140*B(j,j) Equation (1)

The pixel value calculated based on the Equation (1) is assigned to each pixel present in the face image. After converting the color image to a grayscale image by Equation (1), the pre-processing of the noise removal may be completed. For reference, 0.2989, 0.5870, and 0.1170 in Equation (1) are the weights for each of the R (red), G (green), and B (blue) colors (their sum is 0.9999 and converge to 1), and these weights are known to be suitable for converting color images to grayscale images.

Next, in Step S1623, a face detection (FD) operation is performed to extract only the parts that are recognized as human faces among the entire image input from Step S1621, after the denoising operation of step S1622. In the subsequent step S1624, the face-relevant pixel values will be normalized from the perspective of anthropometry. For example, after normalizing the eigenvector extracted from the facial image, the distance between the main parts of the face (e.g., distance between eyes) is calculated to measure the similarity between different faces and facial fingerprint database (not shown), thereby greatly reducing the error rate of facial recognition and improving the accuracy of facial recognition.

The normalized results in step S1624 can be compared directly to the facial fingerprint database at step S1626 in FIG. 12. For reference, the facial fingerprint database contains facial fingerprints (Facial Biometrics) that can uniquely identify the faces of, for example, each of the 2000 employees at a specific company to which the present invention applies. The facial fingerprint database may be part of the memory module 1500 in FIG. 10, and the action module 1600 compares the facial fingerprints of 2000 people stored in memory module 1500 with the faces of, for example, the seven meeting participants shown in FIG. 15. Of course, as in the case of speech recognition, in order to simplify the amount of computation in Step S1626, the AI meeting management agent 1900 can be provided with a list of participants for this meeting, and the AI meeting management agent 1900 can be configured to match only the facial fingerprints corresponding to those included in the list at Step S1626. However, if the facial contrast is performed only within the scope of the list provided to the AI meeting management agent 1900, the facial similarity measurement with the other 2000 employees in the company will be completely excluded. Thus, the present invention proposes to take the facial fingerprint database of all personnel belonging to a certain size organization to which the present invention is applied as the comparison target at step S1626.

On the other hand, it is preferable to go through step S1624 rather than proceeding directly from S1626 to S1625. Step S1625 is a process of facial feature extraction (FE), and the facial features refer to, for example, the distance between two eyes, the distance from the forehead to the chin, the distance between the nose and the mouth, the depth of the eye socket, the shape of the cheekbones, the contour of the lips, the contour of the ears, or the contour of the cheeks. In other words, considering that each person has a unique face shape, it is possible to extract mathematically computable facial parameter values for each individual from the image of his or her face. In step S1625, an AI model may classify and recognize human faces through Gaussian Mixture Model, Gibbs Model, and Fisher Linear Discriminate Analysis (FLDA) techniques that can be adopted by computer vision tools 1140.

The facial features are recorded in the memory module 1500 of the AI meeting management agent 1900, for example, as for the entire employees at a company. In step S1626, the AI meeting management agent 1900 receives information about the facial features of the internal employees from the memory 1500, and then in step S1627, the action module 1600 can verify the identity by comparing it with the facial features of a specific person extracted from step S1625 (i.e., facial video data related to attendees obtained at the current meeting room site). In order for AI software 1100 to successfully recognize human faces accurately, it is essential to train AI through a predetermined learning model. There are various technologies such as LAMSTAR (Large Memory Storage and Retrieval Neural Network) for the AI facial recognition purpose.

When comparing human facial features, it is also possible to judge the similarity of facial features by determining whether the distance between the eyes of the person is greater or less than a certain threshold, for example. As in FIG. 11, the AI meeting management agent 1900 extracts and organizes the identification information such as employee serial numbers and names of one or more candidates who have been so determined (i.e., step S1628). For example, if the faces of D1, a meeting participant in FIG. 15, are compared with the faces of 2000 employees in the company, and three people show a match rate over 95%, the action module 1600 records these three people as the candidates determined by the facial recognition process of the face judgment module 1620.

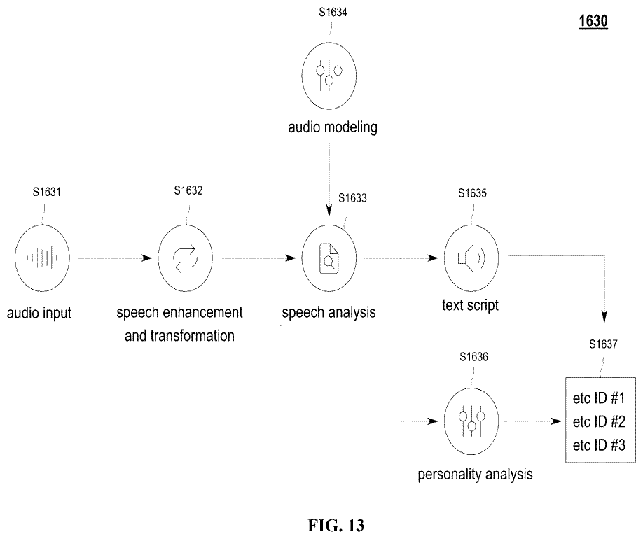

FIG. 13 is an illustrative drawing representing the process of identifying meeting participants in terms of personality and other perceptions by using the “extra judgment module” 1630 of the action module 1600 according to the second embodiment of the present invention. As shown in FIG. 11 and FIG. 12, the extra judgment module 1630 is a composition that assists in confirming the identity of a meeting participant by identifying a meeting participant based on elements other than face and voice, such as a name, personality revealed in voice or facial expression, handwriting appearing from a handwriting, among the core processes for identifying meeting participants of the present invention. The extra judgment module 1630 operates within the action module 1600 of the AI meeting management agent 1900 as in the case of voice or facial recognitions.

Referring to FIG. 13, in step S1631, the AI meeting management agent 1900 receives the voice of the speaker 150 for example by a sensor such as a microphone. In step S1632, similar to step S1612 in FIG. 11, the voice is strengthened and goes through a conversion process called sampling. Human speech is an analog signal and continuous. On the other hand, machines such as computers are designed to convert signals into discontinuous values for processing and understanding. Thus, the sampling and conversion of a continuous analog voice signal into a non-continuous digital audio signal according to a predetermined frequency can be performed in step S1632.

The speech analysis in step 1633 can apply one or more of the several audio modeling techniques provided in step S1634. For example, there are HMM (Hidden Markov Model) techniques and RNN (Recurrent Neural Network) techniques. To briefly explain, the former is a technique that analyzes the words in audio data by dividing them into phonemes, while the latter is a technique that uses the results of audio analysis performed in the past and is used in the current analysis. Although omitted in FIG. 13, step S1633 includes a step to compare the data received in Step S1631 with other identifying fingerprints (e.g., personality, behavior pattern, handwriting, etc.) that are stored for each of the 2000 employees.

The results of step S1633 can be converted into a text transcript of the speaker's voice as in step S1635, or parameters relevant to personality analysis as in step S1636. In either case, the individual-specific characteristics extracted from step S1633 are used in step S1637 to screen candidates who show a mate rate above a predetermined threshold according to the extra judgment module 1630 of the action module 1600. In step S1637, AI meeting management agent 1900 extracts and organizes identification information such as employee numbers and names for one or more candidates who have been judged as actual meeting participants. For example, if the personality inferred from the statements of the speaker 150 in FIG. 10 is compared with the personality-related data of 2000 internal employees, and three candidates have a match rate over 70%, then the action module 1600 may record these three candidates according to the extra judgment module 1630.

For reference, in step S1636, voice signal processing technology, clinical psychological knowledge, and real-time machine learning technology that analyzes an individual's personality and even predicts future behavior through speech analysis can be applied. An example for personality analysis would be Voicesense™. Since the present invention is not about the personality analysis technology itself, no further details regarding the extra judgment module 1630 will be explained here.

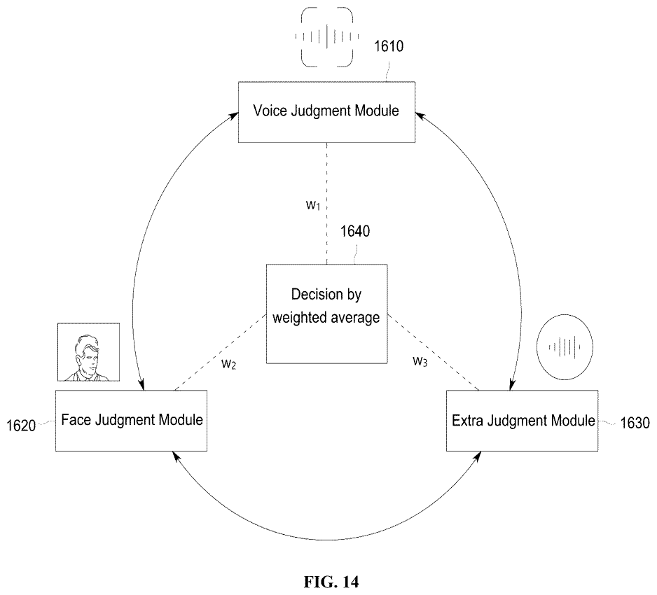

FIG. 14 is a drawing showing an example of identifying a meeting participant by a weighted multi-dimensional recognition process of the weighted average judgment module 1640 according to the second embodiment of the present invention.

In the present invention, the weighted average judgment module 1640 does not determine who the actual meeting attendees are from each of the voice judgment module 1610, face judgment module 1620, and extra judgment module 1630. Rather, the AI meeting management agent 1900 finally determines the identity of the actual meeting attendees by applying weights w₁, w₂, and w₃ respectively to each of the results according to these three modules 1610, 1620, and 1630, and then calculating the weighted average.

For example, if we assume that the face judgment module 1620 contributes 70 points, the voice judgment module 1610 contributes 25 points, and the extra judgment module 1630 contributes 5 points among the total 100 points required for the final decision, w₁, w₂, and w₃ will be 0.7, 0.25, and 0.05, respectively. For example, if there are two candidates who show 95% match rate in the face judgment module 1620, then a person who shows higher result in the voice judgment module 1610 will be the one finally judged by the AI meeting management agent 1900 as an actual meeting attendee. If the match rate of the voice judgment module 1610 is the same between those two candidates, then the AI-based conference attendees will be determined based on the results of the extra judgment module 1630 although the weight of the extra judgment module 1630 might be the lowest in this example.

FIG. 15 is an illustrative drawing showing a conference room applying a weighted multi-dimensional recognition process according to the second embodiment of the present invention. In fact, FIG. 15 is a video footage or picture image 691 of a conference room to be used for the weighted average judgment module 1640 according to the present invention. For reference, as mentioned earlier, the conference room 690 shown in FIG. 5 or the conference room image 691 in FIG. 15 should be considered to belong to the surrounding environment 1150 in FIG. 10. In this case, the screen illustrated in FIG. 15 can be understood as an image or image taken by the AI agent sensors 1250. In addition, the video footage 691 in FIG. 15 includes a speakerphone 620, and if a speakerphone 620 is installed in the conference room 690 as mentioned above, the speakerphone 620 will function as a sensor module 1250 that receives audio signals such as voice input in the conference room 690 depicted in FIG. 5, for example.

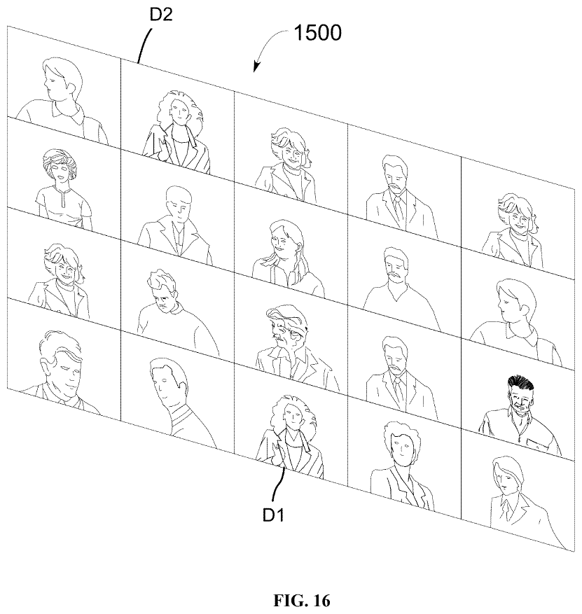

FIG. 16 is a drawing for illustrating the process of analyzing the results of applying a weighted multi-dimensional recognition at the weighted average judgment module 1640 according to the second embodiment of the present invention based on the type and a combined set of identification tools applied for the recognition, and reflecting the analysis results in AI evaluation and learning.

As mentioned earlier, there are a wide variety of technologies that can be used for the voice judgment module 1610, the face judgment module 1620, and the extra judgment module 1630. However, the present invention is not about which of these identification technologies would be superior in identifying the actual meeting attendees. Rather, the present invention proposes to conduct an AI learning process to determine which “combination” of the various technologies used in the voice judgment module 1610, the face judgment module 1620, and the extra judgment module 1630 might show the best identification performance (i.e., the accuracy of recognizing meeting participants), assuming that various technologies can be applied to the voice judgment module 1610, the face judgment module 1620, and the extra judgment module 1630. For example, even by a weighted complex recognition process depicted in FIG. 14, the results of participant identification by AI may not be completely consistent with the actual results.

Table 1 below is also known as a confusion matrix, and with regard to the judgment made by the AI software 1100 in Table 1 (i.e., the “prediction” part on the left side of the table), the AI can make a “positive” or “P” type prediction. For example, if D1 and D2 may be the predicted as actual meeting attendees in FIG. 16 based on the face judgment module 1620 alone. The images in FIG. 16 may be stored in the memory module 1500. In the meantime, the results of the weighted average judgment module 1640 may conclude that the P-type prediction for D1 but determine that D2 was not an actual participant.

Now, it is time to get the actual answer regarding whether D1 participated in the meeting or not. If, in reality, it turns out to be P for D1, but N for D2 (i.e., D1 was the actual attendee, but D2 was not). By making a confusion table after executing numerous predictions by the voice judgment module 1610, the face judgment module 1620, the extra judgment module 1630, and the weighted average judgment module 1640, the AI software 1100 may be able to self-evaluate its own AI prediction performances.

TABLE 1

Actual

| | | P | N |
|---|---|---|---|
| AI | P | TP | FP |
| Prediction | N | FN | TN |

When the AI predicts that the actual P is P, it is called “True Positive, TP”, and when the AI predicts that the real Nis P, it is called “False Positive, FP”. Similarly, for example, if the AI software 1100 predicts that the real N is N, it is called “True Negative, TN”, and if it incorrectly predicts that something that is not N is N, it is called “False Negative, FN”. The chaos matrix shown in Table 1 above is used for the following mathematical equations:

$$( Accuracy ) = \frac{TP + TN}{TP + FN + FP + TN} \qquad ( Equation 2 )$$

$$( Recall ) = \frac{TP}{TP + FN}$$

$$( Precision ) = \frac{TP}{TP + FP}$$

$$TPR = \frac{TP}{TP + FN} \qquad FPR = \frac{FP}{FP + TN}$$

In other words, in Equation (2), “Accuracy” represents the ratio of TP and TN among all decision or class classification results (i.e., the results of predicting actual meeting attendees) in the action module 1600, i.e., the percentage of whether the AI correctly identified the meeting attendees or not. “Recall” focuses on Column P in Table 1, indicating the percentage at which actual evaluation conclusions match the AI's predictions. “Precision” focuses on the P row in Table 1, which refers to the percentage of what the AI software 1100 predicts and is also revealed to be such in the actual evaluation. In addition, “TPR (True Positive Rate)” is the same value as the recall. Higher P results may mean that the current AI prediction method is good. “FPR (False Positive Rate)” is the rate of incorrect prediction by the AI, and the lower the FPR value, the higher the confidence in the current modeling used by the AI software 1100.

In short, Equation (2) is a technique for mathematically self-evaluating AI performance based on the confusion matrix. Next, it is necessary to review the following two equations:

$$F 1 Score = \frac{2 \times Precision \times Recall}{Recall + Precision} \qquad ( Equation 3 )$$

$$Weighted F 1 Score = {\sum }_{i = 1}^{N} {w}_{i} \times F 1 {Score}_{i} \qquad ( Equation 4 )$$

The “F1 Score” in Equation (3) is the Harmonic Mean of precision and recall. In data science, based on numerous tests or field results on various AI models, precision and recall values are calculated for each model, and then this “F1 Score” is calculated for each model. Due to the nature of “F1 Score”, for example, even if the recall value is 100, but if the precision value is low, the “F1 Score” value will be overall lowered, and as a result, it will be difficult to judge the AI model as having excellent performance. This means that an AI model with a high “F1 Score” value will soon perform better in terms of both precision and recall. F1 scores are usually interpreted as very good if they are above 0.9, excellent if they are 0.8 to 0.9, moderate if they are 0.5 to 0.8, and below 0.5 as poor. Although not presented in Equation (3), there is also the concept of the F2 score, which can be seen as a modified form of the F1 score, which places more weight on the recall value than the precision. If finding TP is very important, someone may consider using F2 scores. In addition, the F-beta score is an F-Score calculation technique that places more emphasis on precision when the beta value is less than 1, and more weight on the recall value when the beta value is greater than 1.

The present invention proposes to self-evaluate the performance of the weighted average judgment module 1640 by using the Equation (4). Furthermore, the present invention suggests that weights applied for the weighted average judgment module 1640 should be adjusted if the confusion matrix result of the weighted average judgment module 1640 turns out to show negative performances. In addition, the present invention further suggests that specific algorithms used for the voice judgment module 1610, the face judgment module 1620, the extra judgment module 1630 should be replaced to make a different set or different combination of technologies for the voice judgment module 1610, the face judgment module 1620, the extra judgment module 1630 until some satisfactory result according to the Equation (4) may be acquired.

For example, if the analysis of meeting participant D1 by the current weighted average judgment module 1640 shows that there are 197 TPs, 40 FPs, 42 FNs, and 620 TNs, the “Weighted F1 Score” for participant D1 is 83.40%. In other words, the current AI model did not receive a “very good” rating of 0.9, which may be due to the fact that D2, who looks similar to D1, is working at the same company, as exemplified in FIG. 16, and the weight of participant identification due to appearance, i.e., face, might have been set too high, resulting in a weighted F1 score of 0.9 or less. In this case, the AI-based automatic participant recognition system 2000 can consider replacing the AI product or algorithm that analyzes faces by something else, or adjusting the w₂ value a little lower to increase the proportion of participant identification based on speech recognition or extra recognition methods. This is the “Self-Evaluation and Review” process according to the present invention.

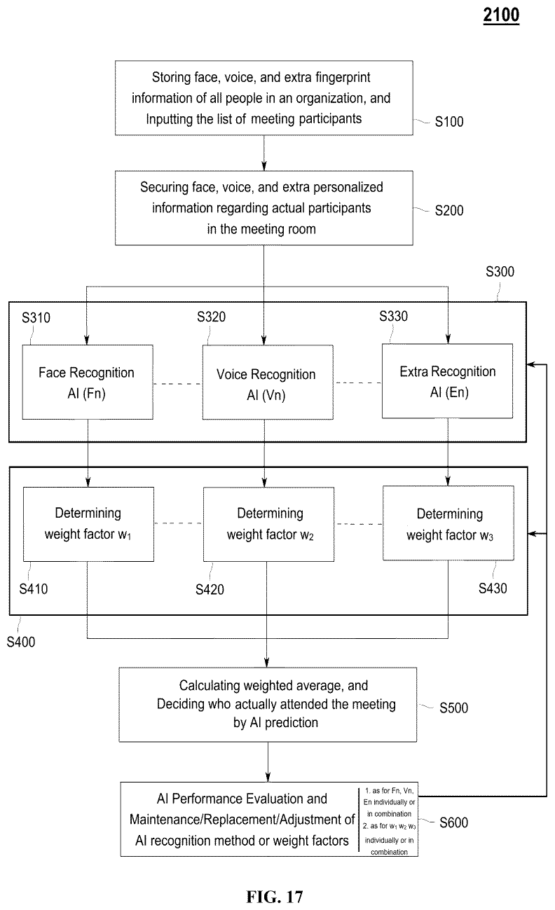

FIG. 17 is a flowchart showing the overall AI meeting participant automatic recognition algorithm 2100 according to the second embodiment of the present invention.

First of all, in step S100, the AI meeting management agent 1900 stores facial fingerprints, vocal fingerprints, and other extra fingerprint information for all members of a certain organization in a DB. The list of meeting participants for a specific meeting may also be entered in step S100.

In the step S200, the AI meeting management agent 1900 uses sensors 1250 to obtain initial raw data on the faces, voices, and other extra fingerprints of people who are actually attending an online video conference or an offline meeting.

In step S300, the initial data obtained from step S200 is compared and contrasted with fingerprint DB information for the entire organization managed by step S100. In other words, as mentioned earlier, the action module 1600 of the AI meeting management agent 1900 performs the facial recognition process by the face judgment module 1620 at step S310; the speech recognition process by the voice judgment module 1610 at step S320, and extra recognition processes by the extra judgment module 1630 at step S330 independently of each other. In the face recognition process at step S310, one among many commercial face recognition AI algorithms such as F1, F2, F3, . . . , and FN will be adopted. In other words, the present invention is not configured to use only one specific AI algorithm for facial recognition, but to select one among various AI algorithms.

The same will be applied for the speech recognition at step S320, where the AI meeting management agent 1900 selects one of the speech recognition algorithms V1, V2, . . . , and VN for speech recognition and applies it to the identification of participants in a meeting. In the step S330, it also selects one of the AI algorithms E1, E2, . . . , and EN for extra recognition.

After that, at step S400 the weight values are entered or automatically decided by AI. In other words, in step S410, the AI meeting management agent 1900 may automatically decide how much weight to give to the results of facial recognition as w₁. Similarly, in step S420, the AI meeting management agent 1900 automatically determines how much weight w₂ should be given to the results of speech recognition, and if the extra recognition process is also required, the weight w₃ value will be determined. All these weight values may be manually adjusted or automatically managed by the AI.

In step S500, a weighted average is derived to make a final judgment on the actual meeting participants' identities. The final judgment result of step S500 may be highly accurate because it reflects a multifaceted AI identification process and weights, but sometimes the AI may incorrectly judge that another person in the company who looks similar, as exemplified in FIG. 16 above, attended the meeting. Therefore, step S600 is required. During step S600, the AI evaluates the performance of the AI software 1100 itself. If necessary, manually or automatically by AI, an appropriate measurement should be taken at step S600 such as replacing the F1 algorithm by the F2 algorithm in the next analysis, keeping the V1 algorithm but adjusting some weight values, or discarding the current extra identity analysis algorithms E7, for example. Of course, as described earlier, the adjustment of the weights w₁, w₂, and w₃ can be done at step S400, either in parallel or sequentially with the performance evaluation for the replacement of the AI algorithm.

### Third Embodiment

The third embodiment of the present invention is explained in detail with reference to the attached drawings. In addition, if the present invention is applied to an internal meeting, it can be used to analyze the work attitude of team members attending the meeting and reflect it in personnel evaluation, and as in the aforementioned example, it can also be used for the purpose of analyzing the attitude of students in a professor's class and reflecting it in the grade evaluation. Therefore, all the words “meeting” mentioned below are used in the specifications, drawings, and claims throughout the specifications, drawings, and claims, to indicate various forms of meetings including “lectures.” Againn, it should be noted that the present invention should cover virtually any form of meeting included in the “expanded meeting concept” mentioned earlier.

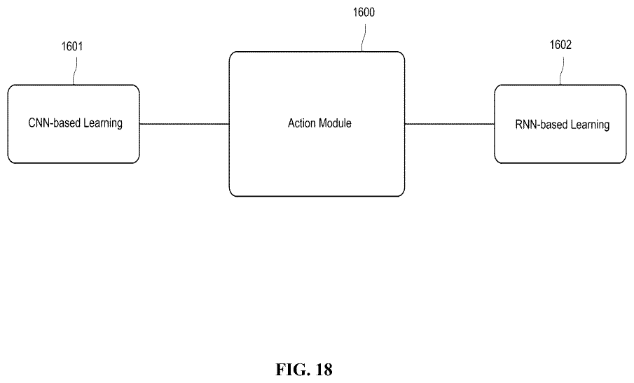

FIG. 18 is a drawing for illustrating some of the AI training processes for analyzing the meeting participation attitude or behavior of meeting participants through video, by the AI meeting system 2000 and the AI meeting management agent 1900 depicted in FIG. 10, according to the third embodiment of the present invention. The third embodiment of the present invention aims to analyze the behavior of a meeting participant from a video footage taken by a meeting participant, where “the behavior of a meeting participant” refers to whether the meeting participant concentrated on the meeting or how good the participant's attitude during the meeting might be. The meeting participation scores can be obtained synthetically from the meeting participant's eye gaze, head posture, self-talk or mouth shape (that is, silence speech), or etc. Strictly speaking, the main purpose of the present invention is to analyze whether the meeting is proceeding properly and intensively by analyzing some indicators that can guess the behavior and attitude of the meeting participants, rather than analyzing the behavior and attitude itself.

Therefore, it should be noted that the participation score is different from the participation evaluation score. This will be clarified more in detail below.

According the AI meeting system 2000 of the present invention, one of the key components is an AI meeting management agent 1900 that can collect meeting content and sometimes intervene in the meeting just like a conference manager or organizer. In addition to this, the AI meeting management agent 1900 can be implemented as an “AI conference evaluation server”, in which case at least some of the surrounding environment 1150 shown in FIG. 10 (e.g., meeting participants can act as a “client” interacting with the server.

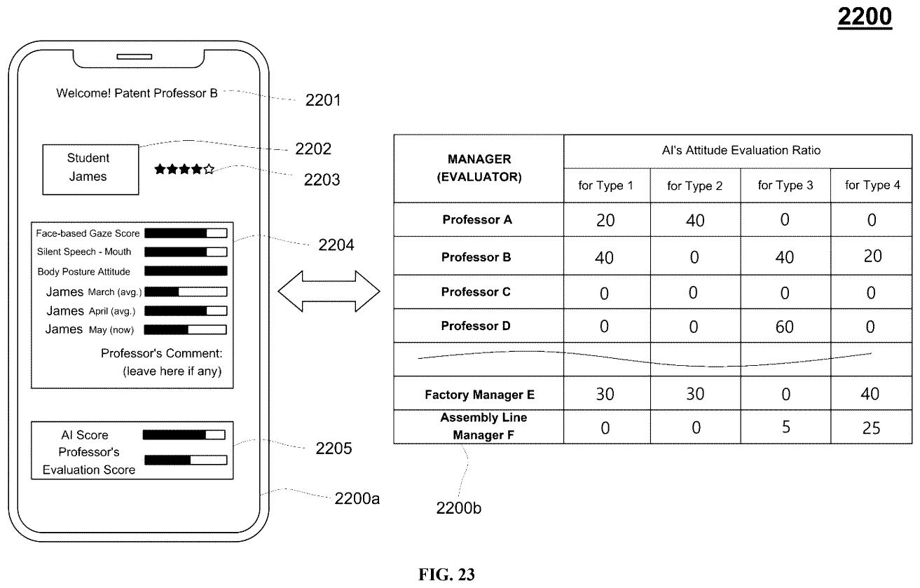

For example, referring to FIG. 10 and FIG. 1, the objects included in the surrounding environment 1150 in the present invention include meeting participants 140, 150 and a meeting evaluator 180 authorized to evaluate the meeting. For reference, the smartphone 180 shown in FIG. 1 itself is not a meeting evaluator, but the meeting evaluator interface 2200 in FIG. 23 can be implemented in the form of an app on smart devices 180 including smartphones used by the meeting evaluator 180. Of course, the AI behavior analysis of the meeting participants 140, 150 according to the present invention may be mainly done at the action module 1600, but the judgment result of the action module 1600 will be eventually presented to the meeting evaluator 180 as an “participation evaluation score” for each meeting participant by transmitting it from the AI meeting management agent 1900 to the meeting evaluator's smartphone 180. Thus, the AI meeting system 2000 according to the present invention consists of a client-server relationship in which the meeting evaluator 180 is the client, and the AI meeting management agent 1900 is a server. It is true that the meeting evaluator 180 also belongs to the surrounding environment 1150, but in consideration of the special meaning of the evaluator in the third embodiment of the present invention, the expressions such as “conference evaluator 180”, “evaluator terminal 180”, and “evaluator device 180” are used hereafter to refer to the person who has the authority to evaluate the conference or the individual participants. Any IT device (computer, laptop, smartphone, etc.) may be used by the conference evaluator. If the conference evaluator is using more than one smart device (e.g., using a smartphone and a smart pad at the same time), at least one of them will be the evaluator's device 180 according to the present invention.

Therefore, an app with an interface 2200 depicted in FIG. 23 may perform all or part of the functions of the action module 1600 within the evaluator's smartphone 180 if it is a stand-alone application. Meanwhile, it is also possible to have some processes for meeting evaluation performed on the server side 1900 and the rest performed on the client side 180. It should be noted that the evaluator client 180 may have to communicate with the AI meeting system 2000 according to the present invention so that the evaluator 180 may only receive the AI operation results of the server 1900 and most of the AI computations are done at the server side 1900.

Note that the surrounding environment 1150 can include both real-world conference rooms 690 and conference rooms in virtual spaces (visible through a smart TV 630 as in FIG. 5). The surrounding environment 1150 may include, for example, the employee ID card 170, or student ID card worn by the meeting participants 140, 150, and the meeting minutes 670, or the student's notebook may be displayed in the conference room as a surrounding environment 1150. Since the main purpose of the present invention is to analyze the behavior of a meeting participant, the main object of analysis of the AI software 1100 is the meeting participant 140, 150.

In the present invention, the goal and task module 1300 of the AI meeting management agent 1900 can be set as, for example, “for the evaluator device 180, the participation of each student (or employees participating in the internal meeting) in the lecture (or work meeting) shall be checked.” This kind of goal can also be entered externally into the AI meeting management agent 1900 in the form of sentences composed of natural language, as explained in FIG. 10 and FIG. 8.

The goal and task module 1300 sets one or more detailed tasks that can be derived from the input goals. For example, “AI should analyze the concentration of the lecture based on inferences from the students' eyes and body posture captured in the video.” An AI meeting management agent 1900 configured based on a goal or task may be a virtual conference monitoring agent that interacts and cooperates with the environment 1150, especially the evaluator device 180, under a given goal.

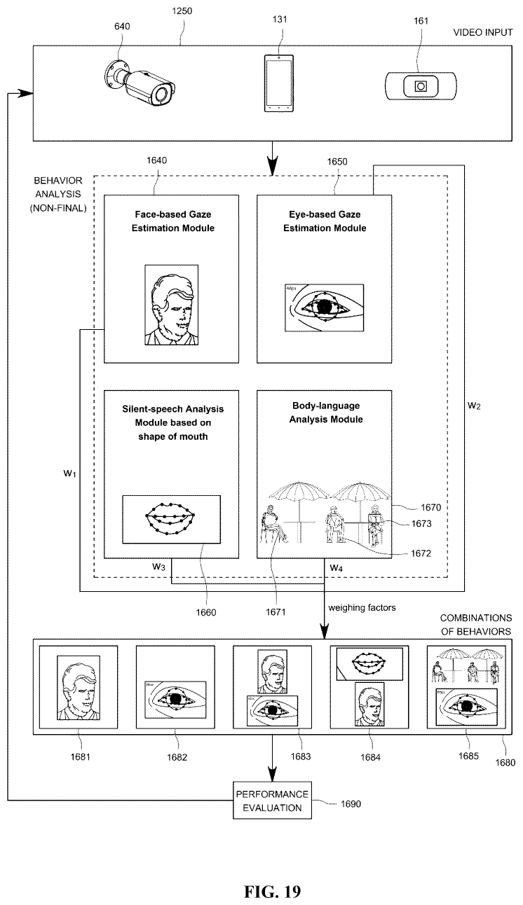

The AI meeting management agent 1900 receives video data from the surrounding environment 1150 using the smartphone camera 131 in FIG. 19 or external camera 161 capable of transmitting images via the network to the AI meeting management agent 1900. In short, sensors 1250 are a collective concept of tools that receive various information necessary for AI meeting management agents 1900 to judge the situation in the conference room and evaluate the attitude of meeting participants.

As will be described later, an AI meeting management agent 1900 pursuant to the present invention drives a predetermined algorithm for analyzing the behavior of meeting participants, and it is possible to improve the accuracy of behavior analysis by using an AI training model. Of course, as will be described later in FIG. 23, if there is any manual input related to the evaluation of the participation score from the evaluator device 180, it can be reflected in the AI calculation.

Furthermore, the AI meeting management agent 1900 not only presents the results of the behavior analysis of meeting participants by the action module 1600 for the evaluator device 180, but also enables improved behavior analysis by continuously self-learning based on the AI performance analysis results. Therefore, an AI meeting management agent 1900 can operate independently without human control or continuous input (e.g., manually inputting a specific student's usual attitude from the outside). For example, if the weight value or the participation score is deemed unreasonable, it is possible for the AI software 1100 to suggest to the evaluator device 180 a better weighting or scoring combination based on AI's self-learning and training.

FIG. 18 is a drawing for illustrating some of the AI training processes for analyzing the meeting participation attitude or behavior of meeting participants through video according to the third embodiment of the present invention.

As mentioned above, the AI meeting management agent 1900 according to the present invention is equipped with the AI software 1100 shown in FIG. 8, and it is necessary to make prior learning with sufficient training data in order for the action module 1600 of the AI meeting management agent 1900 to determine which class of the behavior during the meeting may be regarded as a negative or positive sign for evaluating the participation score. For example, closing the eyes, yawning, sitting in the opposite direction of the meeting host during the meeting would be highly likely regarded as negative signs as a meeting attitude by human evaluators 180. Thus, the AI meeting management agent 1900 needs to produce similar evaluation results with the human evaluator. For this purpose, AI training is required. FIG. 18 shows some of the techniques applicable to the AI meeting management agent 1900 from the perspective of this AI training. AI training is also ultimately aimed at improving the performance of the action module 1600.

Just as the memory module 1500 according to the present invention imitates the human brain, the deep learning model 1121 uses a structure called a neural network that mimics human neural system. As in FIG. 18, the typical learning techniques currently adopted by the deep learning model 1121 include CNN (Convolutional Neural Network) based learning process 1601 and RNN (Recurrent Neural Network)-based learning process 1602.

Referring to FIG. 18, first of all, CNN (Convolutional Neural Network) based learning models 1601 are training methods often used to extract features from image data. For example, TensorFlow™, one of the leading AI open source software, provides a dataset called CIFAR-10™, which contains 60,000 color images. These images are classified into a total of 10 classes. In other words, 16,000 training images are provided for each class. There are 10 classes used in CIFAR-10™, including airplanes, cars, birds, cats, deer, dogs, frogs, horses, ships (cruise ships, etc.), and trucks, and 50,000 out of 60,000 images are used to train CNNs, and the remaining 10,000 images are used to test the image classification performance by CNNs.

In a general neural network learning, three layers are basically used. The first is the input layer, which can be understood as the input layer that includes the aforementioned dataset of 60,000 images. The second is the hidden layer, and the third is the output layer. If there is no hidden layer, the output layer only outputs the input data set as it is, and the AI does not learn anything. In other words, the hidden layer can be seen as the most important component of AI learning because the output layer's result may become different from the input layer thanks to the hidden layer. Also, there are multiple nodes in the hidden layer that are modeled after human nerve cells or neurons. There can be a wide variety of nodes, such as nodes that perform specific operations, nodes that detect the edges of images, nodes that identify red colors, and the number of nodes increases depending on what the training goal is and how complex the operation is to be performed, and the number of hidden layers can be not one, but more than one.

In the CNN-based learning 1601, there are three types of hidden layers. First of all, the convolutional layer performs functions such as scanning the input image or detecting characteristic elements in the image. The pooling layer is responsible for simplifying the results of the convolution layer in order to efficiently process the results of the work performed by each node of the convolution layer. In short, a dataset that requires less computation than the initial input dataset can be created in the pooling layer. Finally, the fully-connected layer (FC Layer) takes the simplified results from the pooling layer, connects all the nodes, and then classifies the image into one of the 10 classes illustrated above, for example. The CNN-based learning 1601 should be implemented so that the action module 1600 can process all one-dimensional, two-dimensional, and three-dimensional images/images.

In the present invention, the features related to the mouth shape and the image around the eyes of the meeting participants, e.g., 140 and 150, are extracted from the video input from the conference room camera 640, and the gaze of the meeting participants 140 and 150 is analyzed. Furthermore, the behavior of the meeting participants 140 and 150 is analyzed by referring to the image data other than the face (e.g., body posture, etc.), and the AI algorithm exemplified in FIG. 19 of the present invention is desirable to be trained by the CNN-based learning 1601. For reference, the CNN-based training 1601 can be done within the action module 1600, but as seen in the example of TensorFlow earlier, the training with tens of thousands of images and testing may not be done in the action module 1600 alone. Rather, it can be done on an external third-party server networked with the AI meeting management agent 1900. In addition, 3D CNNs are also used to detect which behavior will be initiated in recent image sequences, that is, for the purpose of predicting human behavior in advance.

Referring to FIG. 18 again, the basic structure of the RNN (recurrent neural network)-based learning model 1602 includes an input layer, a plural hidden layer, and an output layer, as in the case of general neural network learning. In most AI neural networks, inputs and outputs are separate and independent, but in RNN-based learning 1602, information is circulated in the form of a loop in which the output is obtained based on past input values and current input values. At this time, a memory module 1500 is used to store past inputs. The RNN-based learning 602 is particularly useful for predicting future stock prices, generating text that is expected to be input, or performing translation functions, because it learns data covering from the past to the present (i.e., it reads input data from left to right).

In short, since the present invention mainly consists of analyzing video data during a meeting with artificial intelligence, it is proposed that an AI meeting management agent 1900 is basically trained according to a CNN-based learning model 1601 that shows excellent performance in image learning.

FIG. 19 is a drawing for the overall description of an AI algorithm that can be used for analyzing the behavior of meeting participants 140, 150 through a meeting video according to the third embodiment of the present invention. However, since various criteria for judging human behavior by image analysis are shown in FIGS. 19 to 22, it would be good to first explain what the image analysis of the present invention is about.

The present invention relates to the analysis of video images of meeting participants. Specifically, the present invention distinguishes the behavior of meeting participants from the conference video into three types: (i) behavior judgment based on gaze analysis (“gaze estimation”), (ii) behavior based on mouth shape analysis (“silent speech”), and (iii) behavior judgment based on facial and body posture analysis (“body language”). Here, the present invention further divides gaze analysis into two sub-types. One is “face-based gaze analysis,” which analyzes the gaze through facial images, and the other is “eye-based gaze analysis,” which analyzes the area around the eyes, including the pupils. Thus, FIG. 19 shows all four AI modules 1640, 1650, 1660, 1670 that make up the present invention. And the behavioral analysis results of these four AI modules 1640 to 1670 are output as first, second, third, and fourth participation scores. In addition, the action module 1600 includes the behavior combination module 1680, which obtains comprehensive behavior analysis results by assigning a predetermined weight to the analysis results of the above four basic modules 1640 to 1670. Furthermore, the performance evaluation module 1690 evaluates the accuracy of AI analysis that may vary depending on the behavior combination of the behavior combination module 1680.

For example, if the gaze of the meeting participants 140, 150 is not directed toward the lecturer (that is, an evaluator 180) or the textbook, then the face-based gaze analysis module 1640 or the eye-based gaze analysis module 1650 can judge that the attendance attitude of the meeting participants 140, 150 is poor from the perspective of their gaze during the lecture. In addition, for example, there may be cases where someone wants to communicate something to another person in a silent or near-silent manner during a meeting. Depending on what the content is, the attitude of attending the meeting can be inferred by understanding the so-called silent speech. This analysis is handled by the mouth-based language analysis module 1660. In addition, facial expressions, gestures with hands, or for example, sitting on a chair with indifference to the meeting can help analyze the behavior of meeting participants 140, 150 by analyzing the conscious or unconscious body language, which can be analyzed in the body language analysis module 1680.

It is worth noting that the input data for an AI module 1640 to 1670 that evaluate the first, second, third and fourth participation scores according to the present invention is relatively easy to obtain from a conference room camera 640, a smartphone camera 161, or a webcam 131. In other words, the present invention assumes that it does not use expensive dedicated equipment for gaze analysis, mouth shape analysis, and body posture analysis.

For example, before AI technology became as widely spread as today, some technology was developed to track the eye using a head-mounted eye tracker. In addition to eye trackers, there was also equipment that observes the eye movements of the subjects by installing a high-performance camera at a distance of about 60 cm from the subject. In a more invasive way, sensors are attached to the subject's face and around the eyes to analyze the gaze. In some cases, special sensors had to be attached around the lips and neck to analyze the shape of the mouth, and in the case of body posture measurement, movement sensors were attached to various parts of the body to measure body posture.

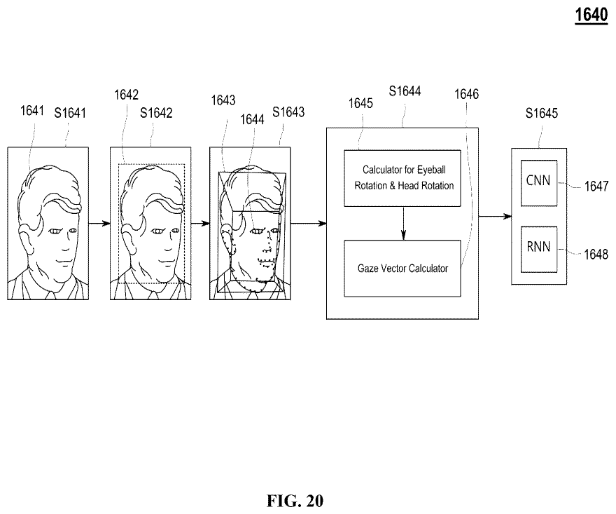

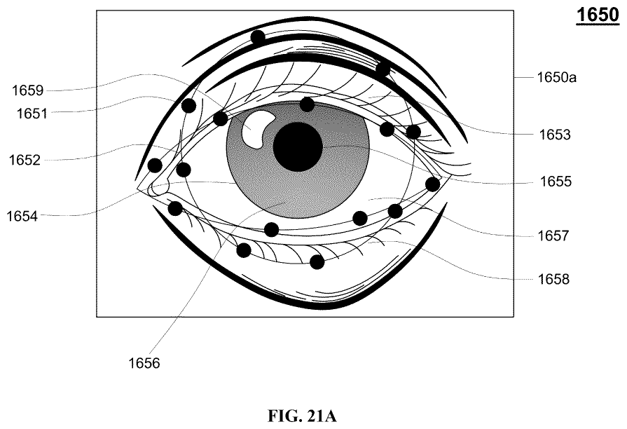

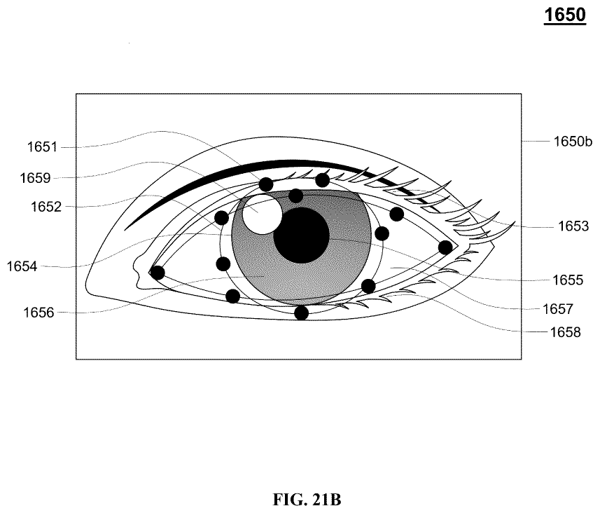

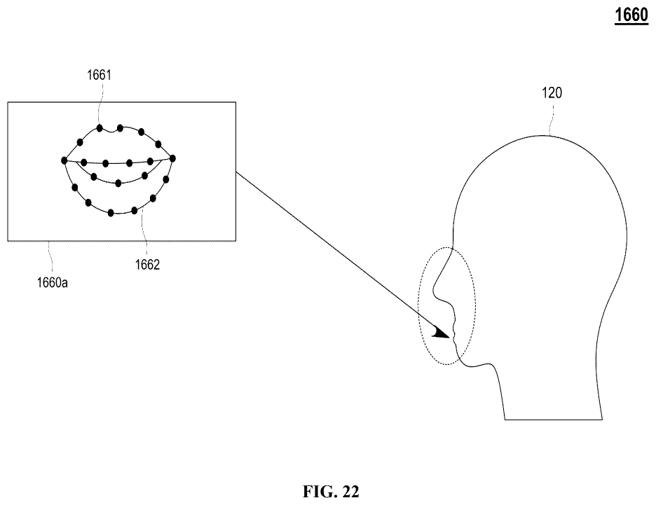

However, the present invention does not require such expensive and inconvenient devices. Such laboratory-equivalent apparatus will not be included in the AI agent sensors 1250. In the same vein, FIG. 20 indicates a technology that analyzes gaze based on facial images, even in situations where laboratory-level eye-tracking equipment is not available, and FIGS. 21A and 21B also suggest the eye-based gaze technology using a laptop webcam 131 or a smartphone camera 161 even without equipment such as an eye tracker. In FIG. 22, the technology to analyze the language of silence from mouth-shaped images in addition to gaze analysis does not presuppose sensor devices attached to the mouth, tongue, neck, etc.

Rather, the smartphone camera 161, which can be one of the sensors 1250 in the present invention, has recently become more powerful to the extent that the performance of smart devices may surpass that of PCs (Personal Computers). In this sense, the performance specifications of the recent smartphone camera 161 that can be used as a sensor 161 in the present invention will be briefly pointed out.

The latest high-performance smartphone camera 161 consists of multiple cameras installed for various purposes, such as a telephoto camera with 2× telephoto at 12 MP (megapixels) and 2× telephoto, a 48 MP wide camera, and a 48 MP ultra-wide camera. These high-performance smartphone cameras 161 can shoot ultra UD (Ultra High-Definition) video, and the recorded video can be encoded with the latest image compression technology such as HEVC (High Efficiency Video Coding). In preparation for high-capacity video and photo storage, the built-in memory of smartphones now reaches 1 TB (Terabyte) or so. In addition, in order to support the shooting function of these high-performance smartphone cameras 161, smartphones are equipped with camera flash, LiDAR (Light Detection and Ranging) scanner, and a microphone for noise cancelling of background sounds recorded during video recording.

Putting the above together, the AI software 1100 which analyzes the behavior of the meeting participants 140 and 150 from the conference video according to the present invention receives the initial image data from the AI agent sensors 1250 that are somewhat common in our daily lives.

Now, referring back to FIG. 19, the explanations about the face-based gaze analysis module 1640, the eye-based gaze analysis module 1650, and the mouth-shape-based language analysis module 1660 will be given later, and only the body language analysis module 1670 will be explained with reference to FIG. 19.

The data input to the Body Language Analysis Module 1670 may be a picture received from a conference room camera 640, a smartphone camera 161, or a webcam 131. However, due to the nature of body language expressed as a continuous action, it would be more desirable for the present invention to analyze body language using video or real-time recording/streaming data.

In the present invention, the AI software 1100 of the body language analysis module 1670 extracts the key features (hereinafter referred to as “landmarks” for the convenience of use of the term) or key parts related to human body behavior from a given input image. In other words, the starting point of the AI analysis according to the present invention is to recognize a line 1672 connecting many landmark points 1671 representing, for example, the arm joint of a person reading a newspaper and a plural landmark point 1672 regarding the leg joint of a person who appears to be sitting on a chair resting, as exemplified in FIG. 19.

As for the body language analysis module 1670, it is desirable to include landmark data on hands 1673 and landmark data on faces (not shown) as the target of analysis. Hand gestures are often a key factor in interpreting body language, and in the case of faces, if facial expressions can be confirmed from a given input video, such facial expressions can be an important basis for body language interpretation.

After extracting point and line data 1671 to 1673 about body landmarks, the body language analysis module 1670 uses pre-trained AI algorithms to determine which class the characters in the video belong to. In other words, the analysis results of the body language analysis module 1670 divide the classes into postures, for example, postures with meeting participation between 90-100 participation score points, postures with 80-90 points, . . . , postures with 0-10 points, etc., and each class is defined to include subclasses. For example, a subclass of body posture that converts to a score of 0-10 for meeting participation may include a prone position at a desk, a posture of walking out of the conference room during a meeting, or a posture of sitting with back toward the lecturer. A class with a score of 90-100 may include a posture of sitting upright on a chair in the conference room facing the front of the meeting room as a subclass. In addition, the body language analysis module 1670 can be AI trained so that leg posture and hand gestures act as class determinants, for example.

Now, referring to FIG. 20, the face-based gaze analysis module 1640 of the present invention receives facial data 1641 of the meeting participants from a conference room camera 640, a smartphone camera 161, a webcam 131 at step S1641. The facial data 1641 can be a photograph, a decoded video frame, or part of a live video stream. In other words, the AI meeting management agent 1900 can recognize the image containing the eyes and faces of the meeting participants 140, 150 by the perception module 1400 with the help of sensors 1250 that include conference room camera 640 or a webcam 131 via a wired and wireless network, and the recognized video footage will be transmitted as an input value for the AI operation of the action module 1600 within the AI meeting management agent 1900.

For reference, the action module 1600 may be trained with a dataset of LFPW™ (Labeled Face Parts in the Wild, first published in 2011 in an academic journal) dataset consisting of 1432 sample facial images, and may have already received training related to facial recognition. HELEN™ (first published in an academic journal in 2012), which includes 2330 facial images and facial landmark information identified from faces, is also a useful training dataset for applying the gaze recognition technology of the present invention.

In step S1642, the AI meeting management agent 1900 can recognize objects that can be classified as human faces (including eyes) among the images obtained at step S1641, and only the image fragments of the face can be cropped for computational efficiency and noise removal. The box shown in step S1642 (that is, a reference number 1642) is called a bounding box, and if it is necessary to measure the posture of the head, the bounding box 1642 can crop the area of the face including the human head as shown in step S1642 in FIG. 20.

In step S1643, one or more features that appear uniquely for each human face image in the bounding box 1642 generated at step S1642 are extracted by, for example, CLNF (Constrained Local Neural Field) technology. In other words, when analyzing the facial image by the AI software 1100, the head pose information and landmarks in the face can be recognized as numerous points 1644 and lines 1643, as exemplified in FIG. 20. Each of the landmark points 1644 can contain three-dimensional coordinates, which can be used to extract pitch (the angle at which the head is nodded up and down) and yaw (the angle at which the head is turned from side to side).

For reference, the polygonal line 1643 surrounding the human face is used to estimate the head posture. In addition, as shown in step S1643, the eyes contained in the face are also important landmarks of the face, and many dots 1644 are created around the eyes. It would be possible to assign landmarks with different identification codes on the left and right sides of the landmark information. This is because just by combining images from the left and right eyes, it is possible to analyze the gaze with a significant level of accuracy.

Now, in step S1644, the values related to Eyeball Rotation and Head Rotation are calculated by the calculator for eyeball rotation and head rotation 1645 from the line data 1643 and point data 1644 related to landmarks extracted at step S1643, and the gaze vector is obtained by the gaze vector calculator 1646 from these two rotation values acquired at the calculator for eyeball rotation and head rotation 1645. Although not specified at step S1644, information about head posture and eye position (two-dimensional or three-dimensional coordinate values) can also be used to obtain the gaze vector, and a technique for measuring the angle between the remaining landmark points 1644 and the center of the iris can be used in the gaze vector calculator 1646 using the pupil center of the human eye as a reference point.

In step S1645, if the face image 1641 entered at step S1641 is a photograph, the CNN processing module 1647 classifies the image (i.e., classified into classes such as gaze, person, head, etc.). If the facial image 1641 input at step S1641 is a video or a real-time stream, the values at step S1643 and step S1644, which can be repeatedly executed frame by frame, may be additionally entered into the RNN processing module 1648 as time series values to perform the final gaze analysis. The time-series eye movement included in the facial image 1641 may improve the accuracy of gaze analysis according to the present invention. Of course, the step S1645 can also compensate for errors in eye line measurement. In the case of photographs and videos, the step S1645 is the stage in which the final gaze analysis results of the face-based gaze analysis module 1640 are produced in the present invention.

As in the case of body posture analysis earlier, the results of gaze analysis based on the final facial image output in step S1645 can be converted into a participation score. The face-based gaze analysis module 1640 is pre-trained according to various “face-based” gaze classes that define engagement scores. For example, a class with a score of 90-100 is directed at the person who is currently speaking, a class with a score of 50-60 may be when the gaze based on the face is directed only at the conference desk and not at the speaker for more than 5 minutes, and a class of 0-10 may be predefined as not facing the other meeting participants at all.

FIG. 21A and FIG. 21B are drawings for illustrating the process of analyzing the eyes of a meeting participant captured in a conference video according to the third embodiment of the present invention. FIG. 21A and FIG. 21B are intended to indicate that the landmark marks related to the eye may differ depending on the shape of the eye and the gaze between the eye data 1650a and the eye data 1650b, and there is no particular difference between FIG. 21A and FIG. 21B in the explanation of the eye-based gaze analysis module 1650.

The eye-based gaze analysis module 1650 receives eye data 1650a, 1650b of the meeting participants from the conference room camera 640, smartphone camera 161, and webcam 131. As shown in FIGS. 21A and 21B, the eye data 1650a, 1650b may be overlapped for analysis.

Although the eyebrows are not shown in FIGS. 21A and 21B, the human eye consists of the upper eyelid (upper eyelid, 1653), the iris 1656), the limbal ring 1654, the pupil 1655, the sclera 1657, and the lower eyelid 1658, which is the fibrous tissue of the white of the eye. And there is an important landmark in the analysis of the “eye-based” gaze, which is the glint 1659. The glint 1659 refers to the bright reflection of external light sources reflected on the cornea covering the lens and iris 1656 of the human eye, and sometimes the glint 1659 is called the corneal reflection portion 1659. To be clear, the corneal reflex in fact refers to the action of people's blinking unconsciously to protect their eyes.

The glint 1659 itself is not a component of the eye. However, with the presence of an external light source, the glint 1659 can be captured in the image data of the eye 1650a, 1650b as shown in FIG. 21A and FIG. 21B. The position and shape of the glint 1659 vary depending on the direction of the gaze, as exemplified in FIG. 21A and FIG. 21B. For reference, the face-based gaze analysis module 1640 in FIG. 20 also extracts eye-related landmarks, but there is no major problem in running the face-based gaze analysis module 1640 even if the data on the detailed components of the eye and the detailed landmarks of the eye 1653 to 1659 such as glints shown in FIG. 21A and FIG. 21B are not obtained. In short, the face-based gaze analysis module 1640 is a method of estimating gaze from information about the rotation of the head and pupils, as described above, while the eye-based gaze analysis module 1650 sets the detailed components of the eye and glints 1653 to 1659 as landmarks, and the eye-based gaze analysis module 1650 trained on this basis performs AI operations. Therefore, the eye-based gaze analysis module 1650 requires all or at least some of the detailed eye landmarks 1653 to 1659. It should be also noted that the detection of detailed eye landmarks 1653 to 1659 in the present invention can be done by means of a webcam 131 or a smartphone camera 161, for example, and not by the aforementioned expensive and inconvenient eye tracker. Therefore, for example, the Purkinje image analysis technique or the Pupil-Glint vector analysis technique may be more accurate than the gaze analysis according to the present invention, but it may be unsuitable for adoption in the eye-based gaze analysis module 1650 in the present invention.

The structural features of the eye described above, i.e., landmarks 1653 to 1659, can be recognized by the AI software as landmark points 1651 and lines 1652 related to the eye, as shown in FIG. 21A and FIG. 21B. Similarly, the AI application of the smartphone 180 may be sufficiently trained by the eye-related CNN processing module (which can correspond to the CNN processing module of FIG. 20) based on the data of a number of landmark sample data and actual gaze data obtained from the human eye captured by the smartphone camera 161. If the eye data 1650a, 1650b is obtained by video footage or real-time video stream, it will be possible to perform a more sophisticated gaze analysis with the eye-related RNN processing module, just like at step S1643 and step S1644 in FIG. 20.

The analysis results of the eye-based gaze analysis module 1659 can also be converted into participation scores, just like in the case of the face-based gaze analysis module 1640. In other words, the eye-based gaze analysis module 1650 is trained according to various “eye-based” gaze classes prescribed according to a predetermined level of participation. For example, a class with a score of 90-100 may include a case where the eye's gaze is directed at a specific person (team leader, lecturer, professor, etc.) displayed on a laptop monitor for meetings or classes, a class with a score of 80-90 may be directed at the meeting minutes 670 or textbook reflected on a smartphone camera 131, and a class with a score of 0-10 may refer to a situation where the gaze is not directed to a specific person or meeting minutes for more than 10 minutes.

One thing to note is that the final gaze analysis results of the face-based gaze analysis module 1640 and the final gaze analysis results of the eye-based gaze analysis module 1650 are produced independently, and therefore the two results may not be the same. In other words, in the present invention, a participation score of 92 points may be calculated by the face-based gaze analysis module 1640, while a participation score of only 30 points may be obtained by the eye-based gaze analysis module 1650, for example.

In FIG. 19, a behavioral combination module 1680 is installed in an AI meeting management agent 1900, and the weight w₁ is set by the AI software 1100 for the result value 1681 of the face-based gaze analysis module 1640, and the weight w₂ is set for the result value 1682 of the eye-based gaze analysis module 1650. The weight w₁ and the weight w₂ may be used to obtain the overall reflected results 1683 as “eye-based behavior analysis results,” that reflects both the face-based gaze analysis and eye-based gaze analysis. However, the specific values of the weight w₁ and weight w₂ may vary depending on the performance evaluation module 1690 of the AI meeting management agent 1900, and the specific performance evaluation method of the performance evaluation module 1690. In addition, as will be described later in FIG. 23, the weight w₁ and weight w₂ can be manually adjusted by the evaluator 180, reflecting that the optimal behavior analysis judged by the AI software 1100 and the reference point of the participation analysis judged by the evaluator 180 may differ. Of course, if the weight w₁ and weight w₂ set by the evaluator 180 or the result value of the face-based gaze analysis module 1640 and the peak setting of each of the eye-based gaze analysis modules 1660 are unreasonable in the judgment of the AI software 1100, the AI meeting management agent 1900 may suggest that the evaluator device 180 readjust the weights or the peak settings by each module 1640 to 1670.

FIG. 22 is a drawing for illustrating the process of analyzing the shape of the mouth of a meeting participant captured in a meeting video according to the working embodiment of the present invention. As explained earlier, FIG. 22 is a drawing that represents the process of analyzing the so-called language of silence from mouth-shaped images.

The basic operation of the mouth-shape-based language analysis module 1660 shown in FIG. 22 is similar to that described in FIG. 20. First of all, as already explained, FIG. 22 assumes that it is possible to analyze the shape of the mouth by a webcam 131 or a smartphone camera 161 without laboratory-level equipment.

The mouth-shape-based language analysis module 1660 receives the mouth-related data 1660a of the meeting participants from the conference room camera 640, the smartphone camera 161, and the webcam 131. The mouth-related data 1660a may be cropped from the facial data of the meeting participant, and the present invention proposes to train a mouth-shape-based language analysis module 1660 so that the AI can learn the shape of the mouth movement by a training dataset consisting of video images or image sequences if possible.

For example, the LRW™ (Reading in the Wild) dataset consists of more than 480,000 video clips of multiple English words such as “ABOUT, ANYTHING, BANKS, MAJOR, MEMBER” as each class, and then various characters from the BBC™ broadcast pronounce the words of each class. Each video consists of 29 frames, and the moment when the word appears is located somewhere out of the 29 frames. However, the dataset for mouth shape analysis, including the LRW dataset, includes an image covering the person's chin to the head, and it is desirable to cut out only the image around the mouth and pre-process the mouth-related data 1660a in the form shown in FIG. 22. Also, since the color of the image can only be noise in the mouth shape analysis, it may be desirable to convert the image to a grayscale image.

The mouth-related data 1660a is converted to a state where the landmark points 1661 and lines 1662 regarding the mouth shape are overlapped with the mouth-related data 1660a. In the same way, a trained mouth-shape-based language analysis module 1660 can guess what words the meeting participants 140, 150 are saying just by analyzing the mouth shape of the meeting participants 140, 150 in the silent video footage. In short, it is possible to analyze what meeting participants are saying at the moment based on the change in their mouth shape.

However, as already explained, an important point in the present invention is that the face-based gaze analysis module 1640, the eye-based gaze analysis module 1650, and the mouth-shape-based language analysis module 1660 all operate independently. For example, if the gaze is not directed at the professor in the lecture and seems to be whispering something to the friend next to him, but the results analyzed by the lip shape-based language analysis module 1660 show that if the friend is discussing the content related to the lecture, the behavior according to the gaze analysis can be classified as negative, but the behavior of the meeting participants according to the mouth shape analysis may be classified as a very positive class and can be given a high participation score.

Accordingly, the present invention proposes to assign a weight w₃ to the results analyzed by the mouth-shape-based language analysis module 1660 by the AI software 1100 to derive the “first comprehensive behavior analysis result, for example, 1684 in FIG. 19” and then make a final judgment on the behavior of the meeting participants. In addition, it is proposed to assign a weight w₄ to the results of the analysis by the body language analysis module 1670 to derive the “second comprehensive behavior analysis result, for example, 1685 in FIG. 19” and then make a final judgment on the behavior of the meeting participants. Of course, it is also possible to calculate the “third comprehensive behavior analysis result (not shown)” by introducing another weight to the “first comprehensive behavior analysis result” and “the second comprehensive behavior analysis result.”

Furthermore, even if the “first comprehensive behavior analysis result (e.g., 1684 in FIG. 19)” does not reflect the results from both the face-based gaze analysis module 1640's analysis results 1681 and the eye-based gaze analysis module 1650's analysis results 1682, in some cases, for example, the gaze analysis may produce a result based on only the face-based gaze analysis module 1640 with the weight w₂ set to 0 and may fuse another result of mouth shape analysis with the face-based-only result (i.e., 1684 in FIG. 19). As mentioned earlier, the present invention proposes a practical model for analyzing the behavior of meeting participants 140, 150 without laboratory-level measurement equipment and converting it into an engagement score. Therefore, depending on the situation, the action module 1600 may not be able to obtain sufficient detailed landmark features of the eye 1653 to 1659 required for the eye-based gaze analysis module 1650. Of course, sometimes the face-based gaze analysis module 1640 can be a secondary gaze evaluation index when almost all the landmark data required by the eye-based gaze analysis module 1650 can be obtained, in which case the AI meeting management agent 1900 or the evaluator device 180 can set the weight w₁ to have a value less than the weight w₂. This can also be the case when the weight w₄ assigned to the analysis results of the body language analysis module 1670 is used to combine the analysis results of other modules 1640 to 1660 with the results of the body language analysis module 1670. In the end, depending on how much landmark data is obtained from either the face-based gaze analysis module 1640, the eye-based gaze analysis module 1650, the mouth-shaped language analysis module 1660, or the body language analysis module 1670, the relationship or ratio among weight w₁ to weight w₄ can vary, and it can be very flexible, reflecting the unpredictable meeting situation in the real world.

Considering the realistic meeting situation, the present invention proposes a configuration called a behavioral combination module 1680 as shown in FIG. 19, and furthermore, the performance evaluation can be made for the adjustment of weighting values w₁ to w₄ by the behavior combination module 1680. The adjustment value for the weighting values w₁ to w₄ can be changed as necessary. The AI meeting management agent 1900 or the evaluator device 180 can consider limiting the maximum score produced by one or more of the eye-based gaze analysis modules 1650, mouth-shape-based language analysis modules 1660, and body language analysis modules 1670 differently, or replacing the AI model already applied to each analysis module 1640 to 1670 with another model.

Now, the performance evaluation module 1690 of the present invention shown in FIG. 19 will be explained. The present invention acknowledges the uncertainty that the behavior analysis of the participant's behavior by AI may not be consistent with the reality, even if the behavior combination module 1680 is used. Therefore, AI performance analysis as shown in the confusion matrix as shown earlier may be necessary for the third embodiment of the present invention as well.

The confusion matrix tries to reflect whether the behavioral predictions made by the face-based gaze analysis module 1640, eye-based gaze analysis module 1650, mouth-shape-based language analysis module 1660, and body language analysis module 1670 may be consistent with reality.

For example, the action module 1600 gives weight to the face-based gaze analysis module 1640, eye-based gaze analysis module 1650, mouth-shape-based language analysis module 1660, and body language analysis module 1670, and finally the behavior combination module 1680 can make a “positive” or “P” type prediction. Conversely, the result may be “poor meeting attitude.” In other words, it can make predictions of type “Negative” or “N”. However, when the AI's prediction is actually checked, it may be concluded that the N-type prediction for the meeting participant that is the subject of the analysis turned out to be P, or it may be concluded that the AI correctly predicted the N result. For example, the analysis results of the mouth-shape-based language analysis module 1660 were predicted to be in the 90-100 point class, but in reality, the meeting participants 140, 150 may be in the 0-10 point class because they are having a very poor conversation, and vice versa.

The present invention proposes an AI performance evaluation method based on the above-mentioned Equation (4). That is, the performance evaluation is made for the adjustment value between the weight w₁ to w₄ by the behavior combination module 1680, and the adjustment value between the weights w₁ to w₄ is changed as necessary. Likewise the AI model applied to the face-based gaze analysis module 1640, eye-based gaze analysis module 1650, mouth-shape-based language analysis module 1660, and body language analysis module 1670 may be suggested by AI to be replaced by other algorithms.

FIG. 23 is an illustrative drawing for illustrating a system and method for a meeting evaluator 180 evaluating one or more meeting participants 140, 150 based on behavior analysis by an AI application based on video data obtained during a meeting, according to the third embodiment of the present invention. For this purpose, FIG. 23 shows a meeting evaluator interface 2200 that can be implemented in the form of a smartphone application, for example, according to the third embodiment of the present invention.

It will be discussed with a specific example on how the behavior analysis or participation analysis according to the present invention described with reference to FIG. 19 to FIG. 22 can be used on the evaluator apparatus 180 for evaluating meetings by referring to FIG. 23. A, B, C, D, E, and F shown in FIG. 23 correspond to different evaluators who have the evaluation authority of a meeting. In addition, in FIG. 23, a smartphone app UI for evaluators 2200a is shown on the left, and on the right, the weights set by different evaluators are organized in the form of a table 2200b. For reference, since the table 2200b is stored in a database by the AI meeting management agent 1900 pursuant to the present invention, the table 2200b may not be explicitly displayed on each evaluator's device 180.

Now, a civil law professor at a university seems to assume that 20% of class participation should be reflected when evaluating students' grades. When trying to evaluate the 20% participation using the AI meeting system 2000 according to the present invention, Professor A of civil law class must first understand that the criteria for behavior analysis according to the present invention, which can be divided into four categories: face-based gaze, eye-based gaze, mouth shape, and body posture.

Now, civil law professor A sets the AI attitude evaluation rate considering his teaching environment. In other words, professor A using the evaluator device 180 inputs the weight w₁ to w₄ to be applied in the behavior combination module 1680 of FIG. 19, instead of using the automatic allocation of weighting values by the AI software 1100. For example, suppose that the classroom environment of civil law professor A is an offline lecture, but all students are provided with a class PC and a webcam 131 is installed on that PC. In addition, it is assumed that students who are unable to attend offline due to circumstances must turn on their smartphone camera 161 and participate in the lecture so that their face is visible. Based on this assumption, the civil law professor A may think that the most reliable evaluation criterion among the AI evaluation criteria according to the present invention would be the eye-based gaze analysis. The webcam 131 in the classroom will be able to accurately analyze the eyes of each student, which may be a method of evaluating class participation that is difficult for even professor A himself when evaluating a large number of students in the offline classroom.

Therefore, a weight of 40%, i.e., 0.4, is set for the weight w₂, and for example, a weighted w₁ value of 20%, i.e., 0.2, is set for the face-based gaze analysis result. In addition, if the civil law professor A wants to do the attitude evaluation for the remaining 40% by himself manually, the weight w₃ and weight w₄ values can be set to 0, respectively. In other words, when the 20% attitude score reflected by professor A in the credit is converted into 100 points, 40 points will be are determined by the professor himself, and the remaining 60 points are based on the results of the AI meeting system 2000 according to the present invention. Again, that 20 points from that 60 points will be determined by the gaze evaluation results based on facial analysis, and the remaining 40 points will be determined by the eye-based gaze analysis results that the professor A gives more trust than the face-based gaze analysis. In this case, the highest participation score that a student meeting participant 140, 150 can receive from the AI meeting system 2000 is 60 out of 100, and if the credit is converted to 100 points, it is equivalent to 12 points. In other words, out of the 100% rate of total grade evaluation, the civil law professor A had 12% automatically graded by the AI meeting system 2000.

On the other hand, for example, patent law professor B may find it difficult to trust the results of eye-based gaze analysis due to his teaching environment. The patent law professor B's lectures are only available for offline lectures. Moreover, considering the bad conditions of camera equipment installed in the classroom, the patent law professor B believes that it will be difficult to reliably analyze the eye gaze for each student. For example, professor B of patent law can set the weight w₂ value to 0, the weight w₁ value to 40% or 0.4, the weight w₃ value for mouth shape analysis to 0.4, and the weight w₄ value of 0.2 for body posture to be applied. The professor B might have thought that, even if it is difficult to photograph the students' eyes due to the poor classroom environment, it might be possible to capture the face, head posture, mouth shape, and body posture with multiple cameras 640 installed in the classroom. However, if the professor B determines that the students' gaze and whether or not the student is chatting with other students are more important factors than the student's body posture during the lecture, professor B may think that the weight of w₄ for body posture can be set at 0.2 at the lowest. Of course, the eye-based gaze analysis in the attitude analysis may be excluded from the participation evaluation, and professor B, unlike professor A, may want the AI to completely evaluate about the student participation attitude. Therefore, as shown in FIG. 23, the sum of the values of weight w₁ to weight w₄ set by the professor B is 100%, that is, 1.0.

However, if a physical education professor C believes that she can evaluate each student's attitude by her own eyes, professor C may set all the weights w₁ to w₄ values as zero.

In addition, if the mouth shape analysis of the AI meeting system 2000 is deemed to be particularly important, for example, as in Mathematics Class's professor D, and the professor D can assign 60% to the weight w₃ value, that is, 0.6, so that it will be automatically entered into the grade evaluation system, and then the professor D may decide to evaluate the remaining 40% by herself.

As another example, E, the factory manager of Plant 1 located in Ulsan, found it difficult to judge the attitudes of many employees in the vast Plant 1 factory, so he decided to apply the AI meeting system 2000 according to the present invention to employee evaluation. The camera 640 equipment in Plant 1 that produces semiconductors is supported with a number of very high-performance and sophisticated cameras for technical security purposes, even if it is not for evaluation purposes. Thus, the Ulsan Plant 1 Manager E can assign a large weight to eye analysis but 30% weight each for face-based analysis and eye-based analysis. And in case of the weight w₃, it can be set to 0 because the manger E may judge that it is impossible or undesirable to monitor all the words of many workers in the factory, and for example, for the weight w₄ value, it can be set to the level of 40% because it is judged that a work attitude with an improper body posture can increase the process error or some ethical issues among the employees.

Another manager F, who oversees the smartphone assembly line located in Icheon, supervises some highly skilled technical personnel, so he may want to evaluate the attitude of his employees himself. However, if he still wants to reflect the content of small talk or AI evaluation based on body posture in the personnel evaluation, the manager F, as the head of the assembly line in Icheon, assigns 5%, or 0.05, to the weight of the mouth shape analysis w₃ value, and 25% to the weight w₄ value of the body posture analysis. In this case, the remaining 70% of the attitude score will be directly entered into the personnel evaluation system by the Manager F.

FIG. 23 shows the UI 2200a displayed for the patent law Professor B evaluator. For example, in the evaluator UI 2200a of FIG. 23, a phrase indicating that patent law Professor B is a user is indicated as the reference number 2201. An attitude evaluation about the student James 2202, one of the students of patent law Professor B, may be briefly shown to the professor B by the star ratings 2203.

In the evaluation box 2204, the results of student James' behavior analysis are displayed in real time, for example, with a graph. However, in case of the eye-based gaze analysis, the weight is set to 0 by Professor B, so the graph related to this may not be displayed in the evaluation box 2204. In addition to the results of real-time behavior analysis, as shown in FIG. 23, the average monthly attitude score of the student James may be displayed in the evaluation box 2204 so that Professor B can check the overall trend of James' attitude towards his class.

For example, the evaluation score box 2205 may be divided into the score part delegated by Professor B to AI software 1100 and the score part decided by the Professor B. In fact, referring to the table 2200b, the professor's own evaluation score would be meaningless because Professor B of patent law already set a total weight of 100% for the AI's evaluation without leaving any room for the professor's own evaluation. For another example, in case of Mathematics Professor D, the other behavioral analysis except for the 60% mouth shape analysis was set to be judged by Professor D himself, and thus, the professor's direct evaluation score may be significant and sometimes have a great impact on the aforementioned average star rating 2203.

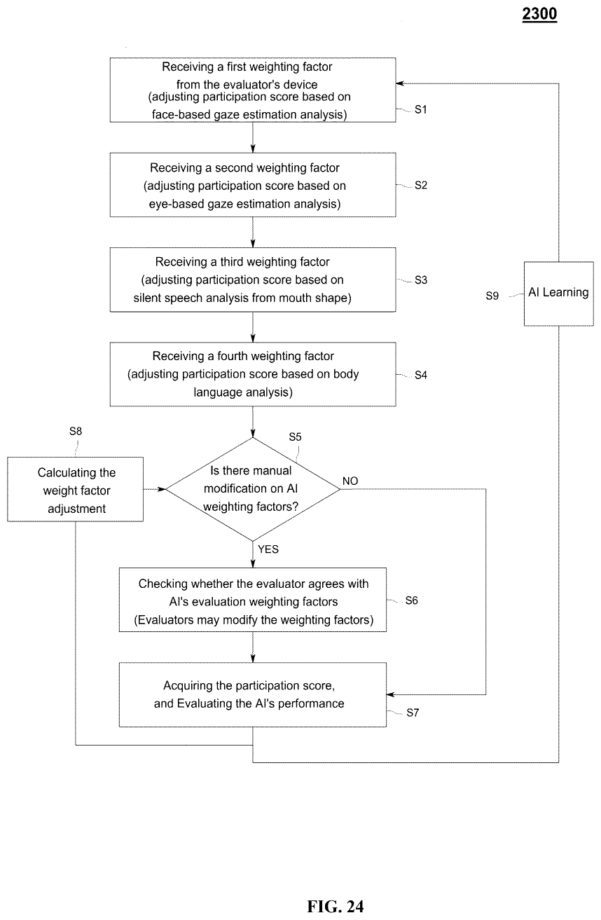

FIG. 24 is a flowchart showing the whole AI meeting evaluation algorithm 2300 according to the third embodiment of the present invention.

Referring to FIG. 24, in step S1, an AI meeting system 2000 or an AI meeting management agent 1900 according to the present invention receives the first weight w₁ for face-based gaze analysis from the evaluator device 180. In the example of FIG. 23, this is the process of receiving a 40% weight for “gaze type 1” from Professor B. As mentioned above, the reason why Professor B of patent law gives 40% weight to face-based AI analysis may be because he personally believes that the AI can sufficiently analyze the students' gaze according to face-based AI analysis, and in addition, for example, Professor B's classroom environment does not have equipment that can take detailed pictures of landmark information about the students' eyes, then he may determine that eye-based gaze analysis was not suitable for his lecture environment, so he may have set the gaze analysis according to the present invention to be completed solely by the face-based gaze analysis.

In step S2, the AI meeting system 2000 or the AI meeting management agent 1900 receives a second weight w₂ for eye-based gaze analysis from the evaluator device 180. In the example of FIG. 23, professor B of patent law sets the second weight to 0, but the other evaluators, A and E, assign weights of 40% and 30%, respectively, to the gaze analysis. This may be because, for example, Civil Law Professor A mainly runs his classes based on online video lectures, and students must be able to see their faces to the professor with a smartphone camera to be recognized as attendance. In the case of E, the head of Ulsan Plant 1, for example, since high-performance security cameras are installed throughout the factory where important company products are manufactured, E might have judged that there would be no problem even if the same weight of 30% each was given to face-based gaze analysis and eye-based gaze analysis as shown in FIG. 23.

In step S3, the AI meeting system 2000 or the AI meeting management agent 1900 receives a third weight w₃ for mouth-shape-based behavior analysis from the evaluator device 180. For example, physical education professor C in FIG. 23 may have set the third weight w₃ to 0 because she judged that it was unnecessary or impossible to check the students' mouth shapes one by one due to the nature of outdoor practical classes, and math teacher D may have set a high weight of 60% in the analysis of language/behavior based on lip shape in judging class attitudes because she did not like students to speak without permission during lectures, as mentioned above.

In step S4, the AI meeting system 2000 or the AI meeting management agent 1900 receives the fourth weight w₄ for body language-based behavior analysis from the evaluator device 180. For example, in FIG. 23, the manager F of the assembly line in Icheon may think that the body posture of the assembly line employees reflects their work attitude and that the body posture can be directly related to a safety accident. For this reason, the fourth weight w₄ may have been set relatively high at 25%. On the other hand, as mentioned above, if someone is not talking in class, the professor D may have decided that body posture is not important in evaluating the attitude of the class, so he set the fourth weight w₄ to 0.

In step S5, the AI meeting management agent 1900 checks whether there are any weights that can be adjusted, such as the table 2200b set by the evaluator device 180 in FIG. 23. In fact, this is a stage that is fed back after Step S7 and Step S8, for example, the AI software 1100 can judge that there is no need to set the proportion of eye analysis to 0 compared to the performance of the cameras installed in the Icheon assembly line F, while the head of the Icheon assembly line F in FIG. 23 gave 0 weight to eye analysis. Or, as a result of the evaluation with the confusion matrix technique and the mathematical Equations (1) to (3), the AI meeting system 2000 or AI meeting management agent 1900 concludes that it does not properly reflect the work attitude of the actual assembly line employees as a result of the evaluation with the confusion matrix technique, and the AI meeting system 2000 or AI meeting management agent 1900 concludes that it does not properly reflect the work attitude of the actual assembly line employees.

If a manual weight adjustment exists in step S5, in step S6, the AI meeting management agent 1900 must wait from the evaluator device 180 to accept the AI's weight adjustment proposal, and only if the evaluator device 180 accepts the AI modification proposal, the weights will be able to be applied to the calculation of the participation assessment. It is also possible for the evaluator device 180 to override the AI proposal and adjust the weight based on the assessor's new logic or judgment in step S6.

In Step S7, after going through the above weight setting/adjustment process, the AI operation is executed to calculate the participation evaluation score by the AI meeting management agent 1900, and the display screen such as the evaluator UI 2200a in FIG. 23 is rendered for the evaluator. Apart from the generation of the evaluator UI 2200a, the AI meeting management agent 1900 according to the present invention can check whether the meeting participation analysis by AI is in line with the reality according to the AI performance evaluation technique described above, and if necessary, may move to step S8 to perform an operation to adjust the existing weight settings. For this calculation, the AI meeting management agent 1900 would need to receive data input from the outside regarding the actual meeting (or lecture) participation status of employees/students, and based on this, it would be possible to create a confusion matrix.

Apart from Step S8, the AI meeting management agent 1900 goes through the AI learning or training process described in Step S7 and then to Step S9 so that it can make its own performance improvements.

The present invention is described in detail with reference to the above attached drawings. In the present invention, “Module” may mean one or more program sets consisting of computer program instructions or scripts, and may sometimes be in the form of an execution file in which the source code is compiled for the purpose of manipulating a hardware processing device or controlling data and information. Furthermore, a program instruction written pursuant to the present invention may be included in an encoded signal for information transmission, which may be transmitted and received between devices and may induce mutual cooperation between multiple devices.

It should be noted once again that the computer program implemented under the present invention may be implemented as a program that operates in parallel and cooperatively in a plurality of places connected by a communication network, and that only a computer program operating in a physical place must be able to implement the function of the present invention.

The “processing device” referred to in the present invention may include FPGA (Field Programmable Gate Array), ASIC (Application-Specific Integrated Circuit), etc., and sometimes it can be implemented as a protocol stack, database management system, operating system, virtual machine, or a combination thereof.

For the purposes of the present invention, “memory” means all computer storage media, which may be a random or serial access memory device that can be read by a computer, and may include a medium such as a disk that physically stores the above computer program. Accordingly, in the present invention, the memory may be composed of EPROM (Erasable Programmable Read Only Memory), EEPROM (Electrically Erasable Programmable Read Only Memory), DVD (Digital Video Disk), RAM (Random Access Memory), or a combination thereof, and the memory or storage space based on the cloud service may also correspond to the memory of the present invention.

For the purposes of the present invention, “database (DB)” means a structure in which information or data stored electromagnetically in a computer system is combined. Databases are usually controlled by DBMS (Database Management System), and DB applications and DBMS can be called DB systems or simply databases.

For the purposes of the present invention, “server” means a computer device that provides resources such as multimedia on a network, and in fact, a server can be implemented in two forms: hardware or software. A hardware server is a physical device connected to a computer network, and any computer can function as a server or host if it is equipped with server software. A software server is a computer program that provides specific services for client programs over a network or locally.

In short, the embodiment of the present invention is described in detail with reference to the attached drawings, but in addition, if the present invention is obvious to the contractor, it should be regarded that even such a simple design change is intended to fall within the technical category of the present invention. The invention should be limited only by the attached claims.

What is claimed is:

1. A computer-implemented method to manage meeting schedules for multiple meeting participants, comprising:
a first step of accessing a candidate database (DB) server that includes at least one of a list of a potential meeting's group participants or personal contact, address, current location, work schedule, team information or expertise of an individual potential meeting participant, by an artificial intelligence (AI) meeting scheduler server that is connected with personal meeting terminals of the multiple meeting participants via a network;
a second step of accessing a meeting information DB server that includes a potential meeting information including at least one of the potential meeting's expected agenda, expected number of participants, expected meeting time or expected meeting location for the potential meeting, by the AI meeting scheduler server;
a third step of calculating a match rate between a first data received from the candidate DB server and a second data received from the meeting information DB server based on at least one predetermined selection criteria, and creating a meeting candidate list based on the match rate and the predetermined selection criteria, by the AI meeting scheduler server; and
a fourth step of deciding a meeting schedule for the potential meeting after acquiring an explicit or implicit consent from each candidate included in the meeting candidate list, by the AI meeting scheduler server.

2. The computer-implemented method of claim 1, wherein the third step includes a prediction process including at least one of a similarity prediction process based on at least one of the expected agenda, the team information or the expertise; an accessibility prediction process based on the address or the current location and the expected meeting location; or a conflict prediction process for a schedule conflict probability based on the expected meeting time and the work schedule of the individual potential meeting participant.

3. The computer-implemented method of claim 2, wherein the prediction process further includes an obstacle resolution process where the AI meeting scheduler server determines whether there exists at least one obstacle ground in creating the meeting candidate list based on the similarity prediction process, the accessibility prediction process or the conflict prediction process;
judges whether the obstacle ground is negotiable; and if the obstacle is judged to be negotiable, resolves the obstacle ground pursuant to a predetermined obstacle resolution procedure.

4. The computer-implemented method of claim 3, wherein the meeting candidate list includes as many candidates as a predetermined multiple of the expected number of participants, and when judging whether the obstacle ground is negotiable, priorities allocated to the obstacle ground respectively for the candidates are compared against each during the obstacle resolution process.

5. The computer-implemented method of claim 1, further comprising:
a fifth step of accessing a meeting room management DB server that includes a schedule availability of each meeting room, an available device information in each meeting room or a location information of each meeting room, by the AI meeting scheduler server,
wherein the candidate DB server further includes a device type or a device performance information about each of the personal meeting terminals, and the meeting information DB server further includes an information on whether the potential meeting can be participated by online or not.

6. A computer system to manage meeting schedules for multiple meeting participants by using personal meeting terminals of the multiple meeting participants via a network, comprising:
a candidate DB server that includes at least one of a list of a potential meeting's group participants or personal contact, address, current location, work schedule, team information or expertise of an individual potential meeting participant;
a meeting information DB server that includes a potential meeting information including at least one of the potential meeting's expected agenda, expected number of participants, expected meeting time or expected meeting location for the potential meeting; and
an AI meeting scheduler server that calculates a match rate between a first data received from the candidate DB server and a second data received from the meeting information DB server based on at least one predetermined selection criteria, and creates a meeting candidate list based on the match rate and the predetermined selection criteria,
wherein the AI meeting scheduler server decides a meeting schedule for the potential meeting after acquiring an explicit or implicit consent from each candidate included in the meeting candidate list.

7. The computer system of claim 6, wherein, when the AI meeting scheduler server creates the meeting candidate list, the AI meeting scheduler server executes a prediction process including at least one of a similarity prediction process based on at least one of the expected agenda, the team information or the expertise; an accessibility prediction process based on the address or the current location and the expected meeting location; or a conflict prediction process for a schedule conflict probability based on the expected meeting time and the work schedule of the individual potential meeting participant.

8. The computer system of claim 7, wherein the prediction process further includes an obstacle resolution process where the AI meeting scheduler server determines whether there exists at least one obstacle ground in creating the meeting candidate list based on the similarity prediction process, the accessibility prediction process or the conflict prediction process; judges whether the obstacle ground is negotiable; and if the obstacle is judged to be negotiable, resolves the obstacle ground pursuant to a predetermined obstacle resolution procedure.

9. The computer system of claim 8, wherein the meeting candidate list includes as many candidates as a predetermined multiple of the expected number of participants, and when judging whether the obstacle ground is negotiable, priorities allocated to the obstacle ground respectively for the candidates are compared against each during the obstacle resolution process.

10. The computer system of claim 6, further comprising:
a meeting room management DB server that includes a schedule availability of each meeting room, an available device information in each meeting room or a location information of each meeting room,
wherein the candidate DB server further includes a device type or a device performance information about each of the personal meeting terminals, and the meeting information DB server further includes an information on whether the potential meeting can be participated by online or not.

11. A computer-implemented method to decide whether there exists an authority to participate in a specific meeting as for at least one meeting participant belonging to an organization having a predetermined size, comprising:
storing a facial fingerprint information and a vocal fingerprint information regarding entire members of the organization as an organization fingerprint information, acquiring a list of meeting participants having the authority, and identifying at least one of the facial fingerprint information or the vocal fingerprint information as for the acquired list to generate a participant fingerprint information, by an artificial intelligence (AI) meeting management server;
receiving facial image information and vocal audio information about at least one of the meeting participants through at least one conference camera and at least one conference microphone installed in a meeting room to be used for the specific meeting or through a smart device camera used by each of the meeting participants, respectively, for the specific meeting, by the AI meeting management server; and
deciding whether each of the meeting participants has the authority by performing an analysis on the received facial image information and the received vocal audio information based on a facial recognition algorithm and a voice recognition algorithm by the AI meeting management server,
wherein the facial recognition algorithm and the voice recognition algorithm are executed independently of each other, the analysis is performed against the entire members including the list of meeting participants having the authority, and the AI meeting management server aggregates a result of the analysis to make a final decision on whether each of the meeting participants has the authority.

12. The computer-implemented method of claim 11, wherein, when aggregating the result of the analysis, the AI meeting management server calculates a weighted average based on a first weight allocated to the facial recognition algorithm and a second weight allocated to the voice recognition algorithm to acquire an overall match rate in making the final decision on whether each of the meeting participants has the authority.

13. The computer-implemented method of claim 12, further comprising:
self-evaluating an AI performance on whether the final decision corresponds to existence or non-existence of an actual participation authority for each of the meeting participants; and
reviewing whether the first weight and the second weight should be adjusted to adjust the first weight and the second weight as necessary.

14. The computer-implemented method of claim 12, wherein the AI meeting management server selects one from a plurality of facial recognition algorithms and another one from a plurality of voice recognition algorithms to make an algorithm combination set to be used for the final decision, and self-evaluates an AI performance on a basis of each of the algorithm combination set to adjust the algorithm combination set.

15. The computer-implemented method of claim 11, wherein both the organization fingerprint information and the participant fingerprint information further include an extra fingerprint information including at least one of a name, a team, an email, a contact, or a behavioral pattern about each of the meeting participants, and the AI meeting management server executes an extra recognition algorithm that decides existence of non-existence of the authority based on the extra fingerprint information, independently of the facial recognition algorithm and the voice recognition algorithm, to acquire an extra analysis result, and reflects the extra analysis result on the final decision.

16. A computer system to decide whether there exists an authority to participate in a specific meeting as for at least one meeting participant belonging to an organization having a predetermined size, comprising:
an artificial intelligence (AI) meeting management server that makes a final decision on whether each of meeting participants has the authority,
wherein the AI meeting management server executes processes including (a) storing a facial fingerprint information and a vocal fingerprint information regarding entire members of the organization as an organization fingerprint information, acquiring a list of meeting participants having the authority, and identifying at least one of the facial fingerprint information or the vocal fingerprint information as for the acquired list to generate a participant fingerprint information; (b) receiving facial image information and vocal audio information about at least one of the meeting participants through at least one conference camera and at least one conference microphone installed in a meeting room to be used for the specific meeting or through a smart device camera used by each of the meeting participants, respectively, for the specific meeting; and (c) deciding whether each of the meeting participants has the authority by performing an analysis on the received facial image information and the received vocal audio information based on a facial recognition algorithm and a voice recognition algorithm, and
wherein the facial recognition algorithm and the voice recognition algorithm are executed independently of each other, the analysis is performed against the entire members including the list of meeting participants having the authority, and the AI meeting management server aggregates a result of the analysis to make the final decision.

17. The computer system of claim 16, wherein, when aggregating the result of the analysis, the AI meeting management server calculates a weighted average based on a first weight allocated to the facial recognition algorithm and a second weight allocated to the voice recognition algorithm to acquire an overall match rate in making the final decision on whether each of the meeting participants has the authority.

18. The computer system of claim 17, wherein the AI meeting management server further executes processes including self-evaluating an AI performance on whether the final decision corresponds to existence or non-existence of an actual participation authority for each of the meeting participants; and reviewing whether the first weight and the second weight should be adjusted to adjust the first weight and the second weight as necessary.

19. The computer system of claim 17, wherein the AI meeting management server selects one from a plurality of facial recognition algorithms and another one from a plurality of voice recognition algorithms to make an algorithm combination set to be used for the final decision, and self-evaluates an AI performance on a basis of each of the algorithm combination set to adjust the algorithm combination set.

20. The computer system of claim 16, wherein both the organization fingerprint information and the participant fingerprint information further include an extra fingerprint information including at least one of a name, a team, an email, a contact, or a behavioral pattern about each of the meeting participants, and the AI meeting management server executes an extra recognition algorithm that decides existence of non-existence of the authority based on the extra fingerprint information, independently of the facial recognition algorithm and the voice recognition algorithm, to acquire an extra analysis result, and reflects the extra analysis result on the final decision.

21. A computer-implemented method to evaluate one or more meeting participants based on a behavior analysis of an AI application based on video data obtained during a meeting, comprising:
receiving, from an evaluator's device, a plurality of weighting values corresponding to a plurality of participation scores calculated by the AI application; and
displaying, on the evaluator's device, a participation evaluation score for each of the meeting participants, on a real-time basis or after the meeting is over,
wherein the plurality of participation scores includes at least two among (a) a first participation score based on a first gaze analysis result acquired by a face-based gaze analysis module included in the AI application; (b) a second participation score based on a second gaze analysis result acquired by an eye-based gaze analysis module included in the AI application; (c) a third participation score based on a silence speech analysis result acquired by a mouth-shape-based language analysis module included in the AI application; or (d) a fourth participation score based on a body-language analysis result acquired by a body-language analysis module included in the AI application,
wherein the plurality of weighting values includes a first weighting value related to the first participation score, a second weighting value related to the second participation score, a third weighting value related to the third participation score and a fourth weighting value related to the fourth participation score, and
wherein the participation evaluation score is periodically updated on the evaluator's device based on the participation scores and the weighting values.

22. The computer-implemented method of claim 21, further comprising:
receiving at least one change value on the participation scores or the weighting values, from the evaluator's device, if an authentication as the evaluator is successfully done on the AI application,
wherein the participation evaluation score is periodically updated on the evaluator's device based on the change value and adjusted weighting values due to the change value.

23. The computer-implemented method of claim 21, further comprising:
self-evaluating an AI performance based on a confusion matrix regarding the first weighting value, the first participation score, the second weighting value, the second participation score, the third weighting value, the third participation score, the fourth weighting value and the fourth participation score, and
producing, based on the self-evaluating, at least one AI-proposed adjusting value with regard to at least one of the first weighting value, the first participation score, the second weighting value, the second participation score, the third weighting value, the third participation score, the fourth weighting value and the fourth participation score,
wherein the AI-proposed adjusting value is periodically updated on the evaluator's device.

24. The computer-implemented method of claim 21, further comprising:
creating a non-identifiable meeting participant list when the video data does not meet a quantitative threshold or a qualitative threshold required to produce the participation evaluation score for a specific meeting participant,
wherein the non-identifiable meeting participant list is periodically updated on the evaluator's device.

25. The computer-implemented method of claim 24, wherein, if the video data starts meeting the quantitative threshold or the qualitative threshold to produce the participation evaluation score for the specific meeting participant, the AI application periodically recovers and updates the participation evaluation score of the specific meeting participant on the evaluator's device.

26. A computer system to evaluate one or more meeting participants based on a behavior analysis of an artificial intelligence (AI) application based on video data obtained during a meeting, comprising:
an AI application server that can receive the video data through a wired or wireless network and is interoperable with an evaluator's device, which evaluates the one or more meeting participants by the AI application through the wired or wireless network,
wherein the AI application executes processing including receiving, from an evaluator's device, a plurality of weighting values corresponding to a plurality of participation scores calculated by the AI application; and displaying, on the evaluator's device, a participation evaluation score for each of the meeting participants, on a real-time basis or after the meeting is over,
wherein the plurality of participation scores includes at least two among (a) a first participation score based on a first gaze analysis result acquired by a face-based gaze analysis module included in the AI application; (b) a second participation score based on a second gaze analysis result acquired by an eye-based gaze analysis module included in the AI application; (c) a third participation score based on a silence speech analysis result acquired by a mouth-shape-based language analysis module included in the AI application; or (d) a fourth participation score based on a body-language analysis result acquired by a body-language analysis module included in the AI application,
wherein the plurality of weighting values includes a first weighting value related to the first participation score, a second weighting value related to the second participation score, a third weighting value related to the third participation score and a fourth weighting value related to the fourth participation score, and
wherein the participation evaluation score is periodically updated on the evaluator's device based on the participation scores and the weighting values.

27. The computer system of claim 26, wherein the AI application further executes a process of receiving at least one change value on the participation scores or the weighting values, from the evaluator's device, if an authentication as the evaluator is successfully done on the AI application, and the participation evaluation score is periodically updated on the evaluator's device based on the change value and adjusted weighting values due to the change value.

28. The computer system of claim 26, wherein the AI application further executes processes for self-evaluating an AI performance based on a confusion matrix regarding the first weighting value, the first participation score, the second weighting value, the second participation score, the third weighting value, the third participation score, the fourth weighting value and the fourth participation score; and producing, based on the self-evaluating, at least one AI-proposed adjusting value with regard to at least one of the first weighting value, the first participation score, the second weighting value, the second participation score, the third weighting value, the third participation score, the fourth weighting value and the fourth participation score, and wherein the AI-proposed adjusting value is periodically updated on the evaluator's device.

29. The computer system of claim 26, wherein the AI application further executes a process of creating a non-identifiable meeting participant list when the video data does not meet a quantitative threshold or a qualitative threshold required to produce the participation evaluation score for a specific meeting participant, and the non-identifiable meeting participant list is periodically updated on the evaluator's device.

30. The computer system of claim 29, wherein, if the video data starts meeting the quantitative threshold or the qualitative threshold to produce the participation evaluation score for the specific meeting participant, the AI application periodically recovers and updates the participation evaluation score of the specific meeting participant on the evaluator's device.
